(19) United States
(12) Patent Application Publication
(10) Pub. No.: US 2014/0303228 A1
(43) Pub. Date: Oct. 9, 2014

(54) Biomarkers for Amyotrophic Lateral Sclerosis and Methods Using the Same

(71) Applicant: METABOLON, INC., Durham, SC (US)

(72) Inventors: Kay A. Lawton, Raleigh, NC (US); Meredith V. Brown, Durham, NC (US); Bruce Neri, Cary, NC (US); Rebecca Caffrey, Richmond, VA (US); Michael V. Milburn, Cary, NC (US)

(21) Appl. No.: 14/351,959

(22) PCT Filed: Oct. 17, 2012
(86) PCT No.: PCT/US12/60492

§ 371 Date: Apr. 15, 2014

Related U.S. Application Data
(60) Provisional application No. 61/548,318, filed on Oct. 18, 2011.

(51) Int. Cl. G06F 19/18

(52) U.S. Cl. CPC G06F 19/18; G01N 2800/28; G01N 2500/04
USPC 514/419; 506/8; 435/7.92; 702/21

(57) ABSTRACT

The disclosure provides biomarkers of amyotrophic lateral sclerosis (ALS). The disclosure also provides various methods of using the biomarkers, including methods for diagnosis of ALS, methods of determining predisposition to ALS, methods of monitoring progression/regression of ALS, methods of assessing efficacy of compositions for treating ALS, methods of screening compositions for activity in modulating biomarkers of ALS, methods of treating ALS, as well as other methods based on biomarkers of ALS.

### CROSS-REFERENCE TO RELATED APPLICATIONS

This application claims the benefit of U.S. Provisional Patent Application No. 61/548,318, filed Oct. 18, 2011, the entire contents of which are hereby incorporated herein by reference.

### SEQUENCE LISTING

The instant application contains a Sequence Listing which has been submitted in ASCII format via EFS-Web and is hereby incorporated by reference in its entirety. Said ASCII copy, created on Oct. 12, 2012, is named 13778109.txt and is 2,037 bytes in size.

### FIELD

The invention generally relates to biomarkers for amyotrophic lateral sclerosis and methods based on the same biomarkers.

### BACKGROUND

Amyotrophic lateral sclerosis (ALS), also known as Lou Gehrig's disease, is a fatal neurological disease that rapidly attacks and destroys the nerve cells that are responsible for voluntary movement. The destruction of the neurons in the brain and spinal cord that control movement eventually progresses to the point that all voluntary motor control is lost. Death typically occurs from respiratory failure within 3-5 years of disease onset.

Approximately 20,000 people in the United States have ALS, and 5,000 people are diagnosed with ALS each year. ALS is common worldwide, affecting people of all races and ethnic backgrounds. The average age of onset of ALS is between 40 and 60 years of age, but ALS can strike both younger and older men and women. In 90-95% of ALS cases, the disease is apparently random (known as sporadic ALS (SALS)). In such SALS cases, there is no family history of the disease and no clearly associated risk factors. In 5-10% of ALS cases there is an inherited genetic link (known as familial ALS (FALS)).

Currently definitive diagnosis is delayed on average 15 months from symptom onset. While identification of certain of the genetic mutations underlying FALS is available, there is no single ALS screening test available for SALS. The ALS diagnosis is arrived at by evidence of clinical progression, neurological examination, electrodiagnostic testing and blood and urine tests to screen for illnesses that mimic ALS. Currently the Revised ALS Functional Rating Scale (ALSFRS-R), a self-reported functionality scale, is used in the clinic for ALS diagnosis and for monitoring progression of disability in ALS subjects. A low score is indicative of more severe disease and a high score is indicative of less severe disease. However, a major limitation of the ALSFRS-R is its subjective nature.

Metabolic biomarkers that could definitively identify the presence or absence of ALS in a symptomatic patient are urgently needed. Further, there are no known effective pharmacologic treatments. Diagnostic biomarkers would enable drug development efforts, enable enrolment of ALS subjects in clinical trials earlier and provide surrogate markers of disease progression or regression. In addition, biomarkers for drug targets, drug screens and therapeutic agents are needed.

### SUMMARY

In one embodiment, a method of diagnosing whether a subject has amyotrophic lateral sclerosis (ALS) is provided. The method comprises: analyzing a biological sample from a subject to determine the level(s) of one or more biomarkers for amyotrophic lateral sclerosis in the sample, wherein the one or more biomarkers are selected from one or more biomarkers listed in Tables 1, 5, 9, 11, 12, 13, 14, 15, 16, 17, 18 and 19, and combinations thereof; and comparing the level(s) of the one or more biomarkers in the sample to ALS-positive and/or ALS-negative reference levels of the one or more biomarkers in order to diagnose whether the subject has amyotrophic lateral sclerosis.

In yet another embodiment, a method of monitoring progression/regression of amyotrophic lateral sclerosis (ALS) in a subject is provided. The method comprises: analyzing a first biological sample from a subject to determine the level(s) of one or more biomarkers for amyotrophic lateral sclerosis in the sample, wherein the first sample is obtained from the one or more biomarkers listed in Tables 1, 5, 9, 11, 12, 13, 14, 15, 16, 17, 18 and 19, and combinations thereof and; analyzing a second biological sample from a subject to determine the level(s) of the one or more biomarkers, wherein the second sample is obtained from the subject at a second time point; and comparing the level(s) of one or more biomarkers in the first sample to the level(s) of the one or more biomarkers in the second sample in order to monitor the progression/regression of ALS in the subject.

In yet a further embodiment, a method of distinguishing whether a subject has amyotrophic lateral sclerosis (ALS) or has a neurological disorder with symptoms that mimic ALS (a symptom mimic disorder) is provided. The method comprises: analyzing a biological sample from a subject to determine the level(s) of one or more biomarkers for amyotrophic lateral sclerosis in the sample, wherein the one or more biomarkers comprise one or more biomarkers selected from Tables 5, 9, and 17; and comparing the level(s) of the one or more biomarkers in the sample to ALS-positive and/or ALS-negative reference levels of the one or more biomarkers in order to determine whether a subject has ALS or a neurodegenerative disease with symptoms that mimic ALS. Exemplary biomarkers include tryptophan betaine and indolepropionate.

In yet another embodiment, a method of distinguishing whether a subject has amyotrophic lateral sclerosis (ALS) or has a non-ALS motor neuron disorder (non-ALS MND) such as, for example, pure lower motor neuron (LMN) disease or pure upper motor neuron (UMN), disease is provided. The method comprises: analyzing a biological sample from a subject to determine the level(s) of one or more biomarkers for amyotrophic lateral sclerosis in the sample, wherein the one or more biomarkers comprise one or more biomarkers selected from Tables 11, 12 and 18; and comparing the level(s) of the one or more biomarkers in the sample to ALS-positive and/or ALS-negative reference levels of the one or more biomarkers in order to determine whether a subject has ALS or has a non-ALS motor neuron disorder (non-ALS MND).

In yet another embodiment, a method of distinguishing whether a subject has MND or has a disease with symptoms that mimic MND but is not MND, that is, neurological diseases that cause symptoms that appear clinically similar to MND (e.g., multi-focal motor neuropathy, spinal muscular atrophy, Kennedy's disease, multiple sclerosis) is provided. The method comprises: analyzing a biological sample from a subject to determine the level(s) of one or more biomarkers for MND in the sample, wherein the one or more biomarkers comprise one or more biomarkers selected from Table 13; and comparing the level(s) of the one or more biomarkers in the sample to MND-positive and/or MND-negative reference levels of the one or more biomarkers in order to determine whether a subject has MND or has a disease with symptoms that mimic MND.

In a further embodiment, a method of assessing the efficacy of a composition for treating amyotrophic lateral sclerosis (ALS) is provided. The method comprises: analyzing, from a subject having amyotrophic lateral sclerosis and currently or previously being treated with a composition, a biological sample to determine the level(s) of one or more biomarkers for ALS selected from one or more biomarkers listed in Tables 1, 5, 9, 11, 12, 13, 14, 15, 16, 17, 18 and 19 and combinations thereof; and comparing the level(s) of the one or more biomarkers in the sample to (a) levels of the one or more biomarkers in a previously-taken biological sample from the subject, wherein the previously-taken biological sample was obtained from the subject before being treated with the composition, (b) ALS-positive reference levels of the one or more biomarkers, (c) ALS-negative reference levels of the one or more biomarkers, (d) ALS-progression-positive reference levels of the one or more biomarkers, and/or (e) ALS-regression-positive reference levels of the one or more biomarkers.

In yet a further embodiment, a method for assessing the efficacy of a composition in treating amyotrophic lateral sclerosis (ALS) is provided comprising: analyzing a first biological sample from a subject to determine the level(s) of one or more biomarkers for ALS, the first sample obtained from the subject at a first time point wherein the one or more biomarkers are selected from one or more biomarkers listed in Tables 1, 5, 9, 11, 12, 13, 14, 15, 16, 17, 18 and 19 and combinations thereof; administering the composition to the subject; analyzing a second biological sample from the subject to determine the level(s) of the one or more biomarkers, the second sample obtained from the subject at a second time point after administration of the composition; comparing the level(s) of one or more biomarkers in the first sample to the level(s) of the one or more biomarkers in the second sample in order to assess the efficacy of the composition for treating amyotrophic lateral sclerosis.

In another embodiment, a method of assessing the relative efficacy of two or more compositions for treating amyotrophic lateral sclerosis (ALS) is provided. The method comprises: analyzing, from a first subject having ALS and currently or previously being treated with a first composition, a first biological sample to determine the level(s) of one or more biomarkers selected from one or more biomarkers listed in Tables 1, 5, 9, 11, 12, 13, 14, 15, 16, 17, 18 and 19 and combinations thereof; analyzing, from a second subject having ALS and currently or previously being treated with a second composition, a second biological sample to determine the level(s) of the one or more biomarkers; and comparing the level(s) of one or more biomarkers in the first sample to the level(s) of the one or more biomarkers in the second sample in order to assess the relative efficacy of the first and second compositions for treating amyotrophic lateral sclerosis.

In yet another embodiment, a method for screening a composition for activity in modulating one or more biomarkers of amyotrophic lateral sclerosis is provided comprising: contacting one or more cells with a composition; analyzing at least a portion of the one or more cells or a biological sample associated with the cells to determine the level(s) of one or more biomarkers of amyotrophic lateral sclerosis selected from one or more biomarkers listed in Tables 1, 5, 9, 11, 12, 13, 14, 15, 16, 17, 18 and 19, and combinations thereof; and comparing the level(s) of the one or more biomarkers with predetermined standard levels for the biomarkers to determine whether the composition modulated the level(s) of the one or more biomarkers.

In a further embodiment, a method for identifying a potential drug target for amyotrophic lateral sclerosis (ALS) is provided. The method comprises: identifying one or more biochemical pathways associated with one or more biomarkers for ALS, wherein the one or more biomarkers are selected from one or more biomarkers listed in Tables 1, 5, 9, 11, 12, 13, 14, 15, 16, 17, 18 and 19, and combinations thereof; and identifying a protein affecting at least one of the one or more identified biochemical pathways, the protein being a potential drug target for amyotrophic lateral sclerosis.

In another embodiment, a method for treating a subject having amyotrophic lateral sclerosis (ALS) is provided. The method comprises administering to the subject an effective amount of one or more biomarkers selected from Tables 1, 5, 9, 11, 12, 13, 14, 15, 16, 17, 18 and 19, such as indolepropionate and/or tryptophan betaine, that are decreased in subjects having ALS as compared to subjects not having ALS.

In another embodiment, a method of determining whether a subject is predisposed to developing amyotrophic lateral sclerosis (ALS) is provided, comprising:

analyzing a biological sample from a subject to determine the level(s) of one or more biomarkers for amyotrophic lateral sclerosis in the sample, wherein the one or more biomarkers are selected from one or more biomarkers listed in Tables 1, 5, 9, 11, 12, 13, 16, 17 and 18, and combinations thereof; and comparing the level(s) of the one or more biomarkers in the sample to ALS-positive and/or ALS-negative reference levels of the one or more biomarkers in order to determine whether the subject is predisposed to developing amyotrophic lateral sclerosis.

### BRIEF DESCRIPTION OF THE DRAWINGS

FIG. 1 is an importance plot of biomarkers that distinguish subjects having ALS from Healthy Subjects. The importance plot was generated using a Random Forest analysis as discussed in Example 1. Peptide “HWESASXX” disclosed as SEQ ID NO: 1.

FIG. 2 is a receiver operating characteristic (ROC) curve generated using the Random Forest analysis discussed in Example 1.

FIG. 3 is an importance plot of biomarkers that distinguish subjects having ALS from subjects having symptom mimic diseases. The importance plot was generated using a Random Forest analysis as discussed in Example 2.

FIG. 4 is a ROC curve generated using the Random Forest analysis discussed in Example 2 below.

FIG. 5 is a ROC curve generated using a Lasso analysis as discussed in Example 2.

FIG. 6 is a ROC curve generated using a LASSO/SVM predictive model to analyze the biomarkers identified in Table 9, which markers distinguish subjects having ALS from subjects having symptom mimic diseases. The LASSO/SVM analysis is discussed in Example 3.

FIG. 7 is a ROC curve generated using a Bayesian factor analysis approach. The analysis was used to aid in determining biomarkers that distinguish subjects having ALS from subjects having non-ALS motor neuron diseases, as discussed in Example 4.

FIG. 8 is a ROC curve generated using a SVM predictive model to analyze biomarkers for distinguishing subjects having an MND from subjects having a symptom mimic disease, as described in Example 5.

FIG. 9 is a ROC curve generated using a LASSO predictive model to analyze biomarkers for distinguishing subjects having MND from subjects having a symptom mimic disease, as described in Example 6.

### DETAILED DESCRIPTION

The present invention relates to biomarkers of amyotrophic lateral sclerosis, methods for diagnosis of and/or aiding in diagnosis of ALS (including distinguishing ALS from neurological disorders that mimic ALS and from non-ALS motor neuron disorders), methods of determining predisposition to ALS, methods of monitoring progression/regression of ALS, methods of assessing efficacy of compositions for treating ALS, methods of screening compositions for activity in modulating biomarkers of ALS, methods of treating ALS, as well as other methods based on biomarkers of ALS. Prior to describing this invention in further detail, however, the following terms will first be defined.

### DEFINITIONS

“Biomarker” means a compound, preferably a xenobiotic or a metabolite, that is differentially present (i.e., increased or decreased) in a biological sample from a subject or a group of subjects having a first phenotype (e.g., having a disease) as compared to a biological sample from a subject or group of subjects having a second phenotype (e.g., not having the disease). A biomarker may be differentially present at any level, but is generally present at a level that is increased by at least 5%, by at least 10%, by at least 15%, by at least 20%, by at least 25%, by at least 30%, by at least 35%, by at least 40%, by at least 45%, by at least 50%, by at least 55%, by at least 60%, by at least 65%, by at least 70%, by at least 75%, by at least 80%, by at least 85%, by at least 90%, by at least 95%, by at least 100%, by at least 110%, by at least 120%, by at least 130%, by at least 140%, by at least 150%, or more; or is generally present at a level that is decreased by at least 5%, by at least 10%, by at least 15%, by at least 20%, by at least 25%, by at least 30%, by at least 35%, by at least 40%, by at least 45%, by at least 50%, by at least 55%, by at least 60%, by at least 65%, by at least 70%, by at least 75%, by at least 80%, by at least 85%, by at least 90%, by at least 95%, or by at least 100% or more (i.e., absent). A biomarker is preferably differentially present at a level that is statistically significant (e.g., a p-value less than 0.05 and/or a false discovery rate of less than 0.2 as determined using either Welch's T-test or Wilcoxon's rank-sum Test).

The “level” of one or more biomarkers means the absolute or relative amount or concentration of the biomarker in the sample.

“Sample” or “biological sample” means biological material isolated from a subject. The biological sample may contain any biological material suitable for detecting the desired biomarkers, and may comprise cellular and/or non-cellular material from the subject. The sample can be isolated from any suitable biological tissue or fluid such as, for example, blood, blood plasma, urine, or cerebral spinal fluid (CSF). The sample may include isolated cells, such as, for example neuronal cells, motor neurons, astocytes, dendrocytes and the like as well as cell secretions.

“Subject” means any animal, but is preferably a mammal, such as, for example, a human, monkey, non-human primate, rat, mouse, cow, dog, cat, pig, horse, or rabbit.

A “reference level” of a biomarker means a level of the biomarker that is indicative of a particular disease state, phenotype, or lack thereof, as well as combinations of disease states, phenotypes, or lack thereof. A “positive” reference level of a biomarker means a level that is indicative of a particular disease state or phenotype. A “negative” reference level of a biomarker means a level that is indicative of a lack of a particular disease state or phenotype. For example, an “ALS-positive reference level” of a biomarker means a level of a biomarker that is indicative of a positive diagnosis of ALS in a subject, and an “ALS-negative reference level” of a biomarker means a level of a biomarker that is indicative of a negative diagnosis of ALS in a subject. As another example, an “ALS-progression-positive reference level” of a biomarker means a level of a biomarker that is indicative of progression of ALS in a subject, and an “ALS-regression-positive reference level” of a biomarker means a level of a biomarker that is indicative of regression of ALS in a subject. A “reference level” of a biomarker may be an absolute or relative amount or concentration of the biomarker, a presence or absence of the biomarker, a range of amount or concentration of the biomarker, a minimum and/or maximum amount or concentration of the biomarker, a mean amount or concentration of the biomarker, and/or a median amount or concentration of the biomarker; and, in addition, “reference levels” of combinations of biomarkers may also be ratios of absolute or relative amounts or concentrations of two or more biomarkers with respect to each other. Appropriate positive and negative reference levels of biomarkers for a particular disease state, phenotype, or lack thereof may be determined by measuring levels of desired biomarkers in one or more appropriate subjects, and such reference levels may be tailored to specific populations of subjects (e.g., a reference level may be age-matched so that comparisons may be made between biomarker levels in samples from subjects of a certain age and reference levels for a particular disease state, phenotype, or lack thereof in a certain age group). Such reference levels may also be tailored to specific techniques that are used to measure levels of biomarkers in biological samples (e.g., LC-MS, GC-MS, etc.), where the levels of biomarkers may differ based on the specific technique that is used.

“Metabolite”, or “small molecule”, means organic and inorganic molecules which are present in a cell. The term does not include large macromolecules, such as large proteins (e.g., proteins with molecular weights over 2,000, 3,000, 4,000, 5,000, 6,000, 7,000, 8,000, 9,000, or 10,000), large nucleic acids (e.g., nucleic acids with molecular weights of over 2,000, 3,000, 4,000, 5,000, 6,000, 7,000, 8,000, 9,000, or 10,000), or large polysaccharides (e.g., polysaccharides with a molecular weights of over 2,000, 3,000, 4,000, 5,000, 6,000, 7,000, 8,000, 9,000, or 10,000). The small molecules of the cell are generally found free in solution in the cytoplasm or in other organelles, such as the mitochondria, where they form a pool of intermediates which can be metabolized further or used to generate large molecules, called macromolecules. The term “small molecules” includes signaling molecules and intermediates in the chemical reactions that transform energy derived from food into usable forms. Examples of small molecules include sugars, fatty acids, amino acids, nucleotides, intermediates formed during cellular processes, and other small molecules found within the cell.

“Xenobiotic” means a chemical foreign to a given organism (i.e., not produced in vivo). Xenobiotics include, but are not limited to, drugs, pesticides, and carcinogens. The metabolism of xenobiotics occurs in two phases. Phase I enzymes include Cytochrome P450 enzymes and Phase II enzymes include UDP-glucuronosyltransferases and glutathione S-transferases.

“Metabolic profile”, or “small molecule profile”, means a complete or partial inventory of small molecules within a targeted cell, tissue, organ, organism, or fraction thereof (e.g., cellular compartment). The inventory may include the quantity and/or type of small molecules present. The “small molecule profile” may be determined using a single technique or multiple different techniques.

“Non-biomarker compound” means a compound that is not differentially present in a biological sample from a subject or a group of subjects having a first phenotype (e.g., having a first disease) as compared to a biological sample from a subject or group of subjects having a second phenotype (e.g., not having the first disease). Such non-biomarker compounds may, however, be biomarkers in a biological sample from a subject or a group of subjects having a third phenotype (e.g., having a second disease) as compared to the first phenotype (e.g., having the first disease) or the second phenotype (e.g., not having the first disease).

“Metabolome” means all of the small molecules present in a given organism.

“Neurological diseases or disorders” are disorders or diseases affecting the brain, spinal cord or nerves. There are more than 600 neurologic diseases. Examples include but are not limited to, for example injuries to the brain or spinal cord, infections such as meningitis, diseases with a genetic basis such as Huntington's disease or muscular dystrophy, developmental diseases such as spinal bifida, seizure disorders such as epilepsy, diseases to blood vessels supplying the brain such as stroke, and brain tumors including cancer.

“Neurodegenerative diseases” are a subset of neurological diseases that result in the loss of structure or function of neurons, including death of neurons. Neurodegenerative diseases include, but are not limited to, amyotrophic lateral sclerosis (ALS), primary lateral sclerosis (PLS), progressive muscular atrophy (PMA), pseudobulbar palsy, progressive bulbar palsy, multiple sclerosis, Huntington's Disease, Alzheimer's Disease, Parkinson's Disease, neural demyelination disorders (e.g., progressive multifocal leukoencephalopathy, PML), Motor Neuron disorders, (MND), Upper Motor Neuron (UMN) disorder, and Lower Motor Neuron (LMN) disorders. Some neurodegenerative diseases may involve motor neurons while other neurodegenerative diseases involve other types of neurons (e.g., sensory neurons). Treatment for various kinds of neurodegenerative diseases varies. Thus, identifying whether and the type of neurodegenerative disease (e.g., motor neuron disease vs. non-motor neuron disease) that a subject has is valuable in determining a course of treatment for the subject.

“Amyotrophic Lateral Sclerosis” or “ALS” is a neurodegenerative disease characterized by motor neuron loss and resulting in progressive muscle wasting and weakness.

For purposes of this application, a “symptom mimic disease” or “disease symptom mimic” refers to a neurological disease that presents with symptoms similar to ALS but is not ALS. Some symptom mimic diseases are MNDs and some symptom mimic diseases are not MNDs. Examples include cervical myelopathy, multiple sclerosis, hereditary spastic paraparesis, autoimmune motor neuropathy, spinal muscular atrophy, Kennedy's disease. Symptom mimic diseases may be treated differently from MNDs, including differently from ALS. Thus, it is valuable for a clinician to be able to distinguish between a symptom mimic disease and a motor neuron disease, whether it be ALS or another MND.

“Motor Neuron Disease (MND)” refers to a neurological disorder that affects motor neurons. The tenth International Statistical Classification of Diseases and Related Health Problems (ICD-10) published in 1992 recognized 5 subtypes of MNDs including, ALS, two pure Upper Motor Neuron (UMN) degeneration (primary lateral sclerosis, pseudobulbar palsy) and two pure Lower Motor Neuron (LMN) degeneration (progressive muscular atrophy, progressive bulbar palsy) motor neuron diseases. Thus, the universe of patients having MNDs is larger than that of just those having ALS. Further, not all MNDs are treated the same as ALS is. Thus, it is valuable for a clinician to be able to distinguish between ALS and other MNDs.

“Non-ALS motor neuron disease (non-ALS MND)” as used herein refers to a neurological disorder that affects motor neurons in a pathologically distinct way from ALS and has a different course of treatment than ALS. Non-ALS MNDs include pure Upper Motor Neuron (UMN) and pure Lower Motor Neuron (LMN) motor neuron diseases. Examples include primary lateral sclerosis, pseudobulbar palsy, progressive bulbar palsy, progressive muscular atrophy. As used herein, non-ALS MND refers to motor neuron diseases that are not ALS.

“ALS Status Score” as used herein refers to a determined value that indicates ALS severity and can be used to monitor ALS progression and/or regression in a subject. The ALS Status Score may be determined using an algorithm or mathematical model.

“ALS Probability Score” as used herein refers to a determined value that is used for diagnosis. That is, the probability that a subject has ALS and not a disease that has symptoms that mimic ALS. The ALS Probability Score may be determined using an algorithm or mathematical model.

### I. Biomarkers

The ALS biomarkers described herein were discovered using metabolomic profiling techniques. Such metabolomic profiling techniques are described in more detail in the Examples set forth below as well as in U.S. Pat. No. 7,005,255, U.S. Pat. No. 7,329,489; U.S. Pat. No. 7,550,258; U.S. Pat. No. 7,550,260; U.S. Pat. No. 7,553,616; U.S. Pat. No. 7,635,556; U.S. Pat. No. 7,682,783; U.S. Pat. No. 7,682,784; U.S. Pat. No. 7,910,301 and U.S. Pat. No. 7,947,453, the entire contents of which are hereby incorporated herein by reference.

Generally, metabolic profiles were determined for biological samples from human subjects diagnosed with ALS as well as from one or more other groups of human subjects (e.g., healthy control subjects not diagnosed with ALS, symptom mimic disease subjects, non-ALS MND subjects). The metabolic profile for ALS was compared to the metabolic profile for biological samples from the one or more other groups of subjects. Those molecules differentially present, including those molecules differentially present at a level that is statistically significant, in the metabolic profile of ALS samples as compared to another group (e.g., healthy control subjects not diagnosed with ALS, symptom mimic disease subjects, non-ALS MND subjects) were identified as biomarkers to distinguish those groups.

The biomarkers are discussed in more detail herein. The biomarkers that were discovered correspond with the following group(s):

Biomarkers for distinguishing ALS vs. healthy control subjects not diagnosed with ALS (see Tables 1 & 16);

Biomarkers for distinguishing subjects having ALS vs. subjects having neurological diseases with symptoms that mimic ALS (see Tables 5, 9, and 17);

Biomarkers for distinguishing subjects having ALS vs. subjects having non-ALS MND (see Tables 11, 12 and 18);

Biomarkers for distinguishing subjects having MND vs. subjects having non-MND (i.e., diseases with symptoms that mimic MND) (see Table 13)

Biomarkers for distinguishing early stage ALS vs. later stages of ALS (i.e., biomarkers for distinguishing progression/regression of ALS) (see Tables 14, 15 and 19);

### II. Diagnosis of ALS

The identification of biomarkers for ALS allows for the diagnosis of (or for aiding in the diagnosis of) ALS in subjects presenting with one or more symptoms of ALS. A method of diagnosing (or aiding in diagnosing) whether a subject has ALS comprises (1) analyzing a biological sample from a subject to determine the level(s) of one or more biomarkers of amyotrophic lateral sclerosis in the sample and (2) comparing the level(s) of the one or more biomarkers in the sample to ALS-positive and/or ALS-negative reference levels of the one or more biomarkers in order to diagnose (or aid in the diagnosis of) whether the subject has amyotrophic lateral sclerosis. The one or more biomarkers that are used are selected from one or more biomarkers listed in Tables 1, 5, 9, 11, 12, 13, 14, 15, 16, 17, 18 and 19, and combinations thereof. When such a method is used to aid in the diagnosis of ALS, the results of the method may be used along with other methods (or the results thereof) useful in the clinical determination of whether a subject has ALS.

Any suitable method may be used to analyze the biological sample in order to determine the level(s) of the one or more biomarkers in the sample. Suitable methods include chromatography (e.g., HPLC, gas chromatography, liquid chromatography), mass spectrometry (e.g., MS, MS-MS), enzyme-linked immunosorbent assay (ELISA), antibody linkage, other immunochemical techniques, and combinations thereof. Further, the level(s) of the one or more biomarkers may be measured indirectly, for example, by using an assay that measures the level of a compound (or compounds) that correlates with the level of the biomarker(s) that are desired to be measured.

The levels of one or more biomarkers listed in Tables 1, 5, 9, 11, 12, 13, 14, 15, 16, 17, 18 and 19, and combinations thereof may be determined in the methods of diagnosing and methods of aiding in diagnosing whether a subject has ALS. For example, one or more of the following biomarkers may be used alone or in combination to diagnose or aid in diagnosing ALS: creatine, pro-hydroxy-pro, tryptophan betaine, theophylline, cortisone, paraxantine, n1-methyladenosine, 1-palmtoleoylglycerophosphocholine, indolepropionate, caffeine, quinate, levulinate-4-oxovalerate, 1-heptadecanoylglycerophosphocholine, 1,3-7-trimethylurate, cortisol, theobromine, catechol sulfate, pseudouridine, biliverdin, bradykinin, 4-vinylphenol sulfate, 10-undecenoate (11:1n1), citrate, HWESASXX (SEQ ID NO:1), alpha-ketobutyrate, C-glycosyltryptophan, histidine, oleoylcarnitine, phosphate, creatine, iminodiacetate (IDA), palmitoyl sphingomyelin, 3-dehydrocarnitine, serine, hexadecanedioate (C16), 2-hydroxybutyrate (AHB), pyroglutamine, 3-methylxanthine, delta-tocopherol, 5,6-dihydrouracil, octadecanedioate (C18), 7-methylxanthine, urate, 1,2-propanediol, cysteine, proline, 1-methylurate, dodecanedioate (C12), cholesterol, creatinine, 1-stearoyl-GPI (18:0), arachidonate (20:4n6) and glutamine. In a further example, the biomarkers indolepropionate and tryptophan-betaine may be used alone or in combination with one another or any other biomarkers to diagnose or aid in diagnosing ALS. Additionally, for example, the level(s) of one biomarker, two or more biomarkers, three or more biomarkers, four or more biomarkers, five or more biomarkers, six or more biomarkers, seven or more biomarkers, eight or more biomarkers, nine or more biomarkers, ten or more biomarkers, etc., including a combination of all of the biomarkers selected from Tables 1, 5, 9, 11, 12, 13, 14, 15, 16, 17, 18 and 19 or any fraction thereof, may be determined and used in such methods. Determining levels of combinations of the biomarkers may allow greater sensitivity and specificity in diagnosing ALS and aiding in the diagnosis of ALS, and may allow better differentiation of ALS from other neurodegenerative diseases that may have similar or overlapping biomarkers to ALS (as compared to a subject not having a neurodegenerative disease). For example, ratios of the levels of certain biomarkers (and non-biomarker compounds) in biological samples may allow greater sensitivity and specificity in diagnosing ALS and aiding in the diagnosis of ALS, and may allow better differentiation of ALS from other neurodegenerative diseases that may have similar or overlapping biomarkers to ALS (as compared to a subject not having a neurodegenerative disease).

One or more biomarkers that are specific for diagnosing ALS (or aiding in diagnosing ALS) in a certain type of sample (e.g., CSF sample or blood plasma sample) may also be used. For example, when the biological sample is cerebral spinal fluid, one or more biomarkers listed in Tables 16, 17, and 18, or any combination thereof, may be used to diagnose (or aid in diagnosing) whether a subject has ALS. When the sample is blood plasma, one or more biomarkers selected from Tables 1, 5, 9, 11 and/or 12 may be used to diagnose (or aid in diagnosing) whether a subject has ALS.

After the level(s) of the one or more biomarkers in the sample are determined, the level(s) are compared to ALS-positive and/or ALS-negative reference levels to aid in diagnosing or to diagnose whether the subject has ALS. Levels of the one or more biomarkers in a sample corresponding to the ALS-positive reference levels (e.g., levels that are the same as the reference levels, substantially the same as the reference levels, above and/or below the minimum and/or maximum of the reference levels, and/or within the range of the reference levels) are indicative of a diagnosis of ALS in the subject. Levels of the one or more biomarkers in a sample corresponding to the ALS-negative reference levels (e.g., levels that are the same as the reference levels, substantially the same as the reference levels, above and/or below the minimum and/or maximum of the reference levels, and/or within the range of the reference levels) are indicative of a diagnosis of no ALS in the subject. In addition, levels of the one or more biomarkers that are differentially present (especially at a level that is statistically significant) in the sample as compared to ALS-negative reference levels are indicative of a diagnosis of ALS in the subject. Levels of the one or more biomarkers that are differentially present (especially at a level that is statistically significant) in the sample as compared to ALS-positive reference levels are indicative of a diagnosis of no ALS in the subject.

The level(s) of the one or more biomarkers may be compared to ALS-positive and/or ALS-negative reference levels using various techniques, including a simple comparison (e.g., a manual comparison) of the level(s) of the one or more biomarkers in the biological sample to ALS-positive and/or ALS-negative reference levels. The level(s) of the one or more biomarkers in the biological sample may also be compared to ALS-positive and/or ALS-negative reference levels using one or more statistical analyses (e.g., t-test, Welch's T-test, Wilcoxon's rank sum test, Random Forest, T-score, Z-score) and/or using a mathematical model (e.g., algorithm, statistical model).

For example, a mathematical model comprising a single algorithm or multiple algorithms may be used to determine whether a subject has a motor neuron disease, and if so, whether the MND is ALS. A mathematical model may also be used to distinguish between a symptom mimic disease and a MND (including ALS and non-ALS MNDs) in a subject presenting with symptoms. An exemplary mathematical model may use the measured levels of any number of biomarkers (for example, 2, 3, 5, 7, 9, etc.) from a subject to determine, using an algorithm or a series of algorithms based on mathematical relationships between the levels of the measured biomarkers, whether a subject has ALS, whether ALS is progressing or regressing in a subject, whether a subject has a non-ALS MND, whether a subject has a symptom mimic disease, etc.

In addition, the biological samples may be analyzed to determine the level(s) of one or more non-biomarker compounds. The level(s) of such non-biomarker compounds may also allow differentiation of ALS from other neurodegenerative diseases that may have similar or overlapping biomarkers to ALS (as compared to a subject not having a neurodegenerative disease). For example, a known non-biomarker compound present in biological samples of subjects having ALS and subjects not having ALS could be monitored to verify a diagnosis of ALS as compared to a diagnosis of another neurodegenerative disease when biological samples from subjects having the other neurodegenerative disease do not have the non-biomarker compound. For example, one or more of the following biomarkers may be used alone or in any combination to distinguish ALS from neurological diseases having symptoms that mimic ALS: hexadecanedioate, creatine, 2-hydroxybutyrate (AHB), arachidonate (20:4n6), iminodiacetate (IDA), 10-undecenoate (11:1n1), cortisone, phosphate, palmitoyl sphingomyelin, serine, glutamine, 3-dehydrocarnitine, pyroglutamine, 4-vinylphenol sulfate, and theobromine. In another example, one or more of the following biomarkers may be used alone or in any combination to distinguish ALS from non-ALS MND: 2-palmitoylglycerophosphocholine, 13-HODE+9-HODE, 2-aminobutyrate, 3-(4-hydroxyphenyl)lactate, 3-carboxy-4-methyl-5-propyl-2-furanpropanoate (CMPF), 3-hydroxyisobutyrate, 5alpha-androstan-3alpha,17beta-diol disulfate, acetoacetate, alpha-hydroxyisovalerate, arachidonate (20:4n6), asparagine, bilirubin (Z,Z), bradykinin, C-glycosyltryptophan, caproate (6:0), cysteine, cystine, erythronate, gamma-glutamylalanine, gamma-glutamylisoleucine, gamma-glutamylleucine, gamma-glutamylmethionine, gamma-glutamyiphenylalanine, gamma-glutamyltyrosine, gamma-glutamylvaline, glutamate, glutamine, glutaroyl carnitine, glycerate, histidine, HWESASXX (SEQ ID NO:1), isovalerylcarnitine, methylglutaroylcarnitine, pyroglutamine, tryptophan betaine, and urate.

After the level(s) of the one or more biomarker(s) is determined, the level(s) may be compared to disease or condition reference level(s) of the one or more biomarker(s) to determine a rating for each of the one or more biomarker(s) in the sample. The rating(s) may be aggregated using any algorithm or mathematical (statistical) model to create a score, for example, an ALS status score or an ALS probability score, for the subject. The algorithm may take into account any factors relating to ALS, including the number of biomarkers, the correlation of the biomarkers to the disease or condition, or severity of the disease or condition, clinical parameters, ALSFRS-R Score, etc.

An ALS Status Score can be used to place the subject in an ALS disease severity range from normal (i.e., no ALS) to high. An ALS Status Score can be used in multiple ways: for example, disease progression or regression can be monitored by periodic determination and monitoring of the ALS Status Score; response to therapeutic intervention can be determined by monitoring the ALS Status Score; and drug efficacy can be evaluated using the ALS Status Score.

In another example an ALS Probability Score may be used to direct therapeutic treatment or to direct clinical trial enrollment. For example if an ALS Probability Score of less than 19 is indicative of a high probability that a patient has ALS, then said patient may be treated for ALS or enrolled in a clinical trial for an ALS therapeutic. Conversely, if an ALS Probability Score of greater than 30 is indicative of a low probability of a patient having ALS, then said patient would not be treated for ALS or would not be suitable for enrollment in a clinical trial for an ALS therapeutic.

In one example, the subject's ALS Probability score may be correlated to any index indicative of motor neuron function, from normal motor neuron function to ALS. For example, a subject having a motor neuron function score of 40 may indicate that the subject has normal motor neuron function and the ALS Probability Score would be <10%; a score between 30 and 20 may indicate that the subject has impaired motor neuron function and the ALS Probability Score would be >50%; a score lower than 19 may indicate that the subject has ALS and the ALS Probability Score would be >90%.

III. Methods for Distinguishing ALS from Other Neurological Diseases

The identification of biomarkers for ALS allows for distinguishing whether a subject has amyotrophic lateral sclerosis or has another neurological disease with symptoms similar to ALS (mimic disease). A method of distinguishing whether a subject has ALS or has a mimic disease (e.g., multi-focal motor neuropathy, spinal muscular atrophy, Kennedy's disease, multiple sclerosis) comprises (1) analyzing a biological sample from a subject to determine the level(s) of one or more biomarkers of amyotrophic lateral sclerosis in the sample and (2) comparing the level(s) of the one or more biomarkers in the sample to ALS-positive and/or ALS-negative reference levels of the one or more biomarkers in order to determine whether the subject has amyotrophic lateral sclerosis or a symptom mimic disease (e.g., multi-focal motor neuropathy, spinal muscular atrophy, Kennedy's disease, multiple sclerosis). The ALS-positive and/or ALS-negative reference levels may be levels that are specific for comparison with another particular neurological disease (e.g., reference levels of biomarkers for ALS that distinguish between symptom mimic diseases).

The one or more biomarkers that are used are selected from the biomarkers listed in Tables 5, 9 and 17, and any combination thereof. For example, in another embodiment, a method of distinguishing whether a subject has amyotrophic lateral sclerosis (ALS) or has a symptom mimic disease comprises (1) analyzing a biological sample from a subject to determine the level(s) of one or more biomarkers for amyotrophic lateral sclerosis in the sample, wherein the one or more biomarkers comprise the biomarkers listed in Tables 5, 9 and 17, and any combination thereof; and (2) comparing the level(s) of the one or more biomarkers in the sample to ALS-positive and/or ALS-negative reference levels of the one or more biomarkers in order to determine whether a subject has ALS or has a symptom mimic disease.

Any suitable method may be used to analyze the biological sample in order to determine the level(s) of the one or more biomarkers in the sample. Suitable methods include chromatography (e.g., HPLC, gas chromatography, liquid chromatography), mass spectrometry (e.g., MS, MS-MS), enzyme-linked immunosorbent assay (ELISA), antibody linkage, other immunochemical techniques, and combinations thereof. Further, the level(s) of the one or more biomarkers may be measured indirectly, for example, by using an assay that measures the level of a compound (or compounds) that correlates with the level of the biomarker(s) that are desired to be measured.

After the level(s) of the one or more biomarkers in the sample are determined, the level(s) are compared to ALS-positive and/or ALS-negative reference levels to distinguish whether the subject has ALS or has another disease (e.g., multi-focal motor neuropathy, spinal muscular atrophy, Kennedy's disease, multiple sclerosis) with symptoms similar to ALS. Levels of the one or more biomarkers in a sample corresponding to the ALS-positive reference levels (e.g., levels that are the same as the reference levels, substantially the same as the reference levels, above and/or below the minimum and/or maximum of the reference levels, and/or within the range of the reference levels) are indicative of a diagnosis of ALS in the subject. Levels of the one or more biomarkers in a sample corresponding to the ALS-negative reference levels (e.g., levels that are the same as the reference levels, substantially the same as the reference levels, above and/or below the minimum and/or maximum of the reference levels, and/or within the range of the reference levels) are indicative of a diagnosis of no ALS in the subject. In addition, levels of the one or more biomarkers that are differentially present (especially at a level that is statistically significant) in the sample as compared to ALS-negative reference levels are indicative of a diagnosis of ALS in the subject. Levels of the one or more biomarkers that are differentially present (especially at a level that is statistically significant) in the sample as compared to ALS-positive reference levels are indicative of a diagnosis of no ALS in the subject.

The level(s) of the one or more biomarkers may be compared to ALS-positive and/or ALS-negative reference levels using various techniques, including a simple comparison (e.g., a manual comparison) of the level(s) of the one or more biomarkers in the biological sample to ALS-positive and/or ALS-negative reference levels. The level(s) of the one or more biomarkers in the biological sample may also be compared to ALS-positive and/or ALS-negative reference levels using one or more statistical analyses (e.g., t-test, Welch's T-test, Wilcoxon's rank sum test, Random Forest, T-score, Z-score) or using a mathematical model (e.g., algorithm, statistical model).

IV. Methods for Distinguishing ALS from Non-ALS Motor Neuron Disease (Non-ALS MND)

The identification of biomarkers for ALS allows for distinguishing whether a subject has amyotrophic lateral sclerosis or has non-ALS MND (i.e., either a pure upper motor neuron (UMN) disease or a pure lower motor neuron (LMN) disease). A method of distinguishing whether a subject has ALS or has non-ALS MND comprises (1) analyzing a biological sample from a subject to determine the level(s) of one or more biomarkers of amyotrophic lateral sclerosis in the sample and (2) comparing the level(s) of the one or more biomarkers in the sample to ALS-positive and/or ALS-negative reference levels of the one or more biomarkers in order to determine whether the subject has amyotrophic lateral sclerosis or non-ALS MND. The ALS-positive and/or ALS-negative reference levels may be levels that are specific for comparison with non-ALS MND (e.g., reference levels of biomarkers for ALS that distinguish between non-ALS MND).

The one or more biomarkers that are used are selected from the biomarkers listed in Tables 11, 12 and 18, and any combination thereof. For example, in another embodiment, a method of distinguishing whether a subject has amyotrophic lateral sclerosis (ALS) or has non-ALS MND comprises (1) analyzing a biological sample from a subject to determine the level(s) of one or more biomarkers for amyotrophic lateral sclerosis in the sample, wherein the one or more biomarkers comprise the biomarkers listed in Tables 11, 12 and 18, and any combination thereof; and (2) comparing the level(s) of the one or more biomarkers in the sample to ALS-positive and/or ALS-negative reference levels of the one or more biomarkers in order to determine whether a subject has ALS or has non-ALS MND.

Any suitable method may be used to analyze the biological sample in order to determine the level(s) of the one or more biomarkers in the sample. Suitable methods include chromatography (e.g., HPLC, gas chromatography, liquid chromatography), mass spectrometry (e.g., MS, MS-MS), enzyme-linked immunosorbent assay (ELISA), antibody linkage, other immunochemical techniques, and combinations thereof. Further, the level(s) of the one or more biomarkers may be measured indirectly, for example, by using an assay that measures the level of a compound (or compounds) that correlates with the level of the biomarker(s) that are desired to be measured.

After the level(s) of the one or more biomarkers in the sample are determined, the level(s) are compared to ALS-positive and/or ALS-negative reference levels to distinguish whether the subject has ALS or has non-ALS MND. Levels of the one or more biomarkers in a sample corresponding to the ALS-positive reference levels (e.g., levels that are the same as the reference levels, substantially the same as the reference levels, above and/or below the minimum and/or maximum of the reference levels, and/or within the range of the reference levels) are indicative of a diagnosis of ALS in the subject. Levels of the one or more biomarkers in a sample corresponding to the ALS-negative reference levels (e.g., levels that are the same as the reference levels, substantially the same as the reference levels, above and/or below the minimum and/or maximum of the reference levels, and/or within the range of the reference levels) are indicative of a diagnosis of no ALS in the subject. In addition, levels of the one or more biomarkers that are differentially present (especially at a level that is statistically significant) in the sample as compared to ALS-negative reference levels are indicative of a diagnosis of ALS in the subject. Levels of the one or more biomarkers that are differentially present (especially at a level that is statistically significant) in the sample as compared to ALS-positive reference levels are indicative of a diagnosis of no ALS in the subject. The level(s) of the one or more biomarkers may be compared to ALS-positive and/or ALS-negative reference levels using various techniques, including a simple comparison (e.g., a manual comparison) of the level(s) of the one or more biomarkers in the biological sample to ALS-positive and/or ALS-negative reference levels. The level(s) of the one or more biomarkers in the biological sample may also be compared to ALS-positive and/or ALS-negative reference levels using one or more statistical analyses (e.g., t-test, Welch's T-test, Wilcoxon's rank sum test, Random Forest, T-score, Z-score) or using a mathematical model (e.g., algorithm, statistical model).

V. Methods for Distinguishing Motor Neuron Disease (MND) from Non-MND Neurological Disorders

The identification of biomarkers for MND allows for distinguishing whether a subject has MND or has a disease with symptoms that mimic MND but is not MND, that is, neurological diseases that cause symptoms that appear clinically similar to MND (e.g., multi-focal motor neuropathy, spinal muscular atrophy, Kennedy's disease, multiple sclerosis). A method of distinguishing whether a subject has MND or has a disease with symptoms that mimic MND comprises (1) analyzing a biological sample from a subject to determine the level(s) of one or more biomarkers of MND in the sample and (2) comparing the level(s) of the one or more biomarkers in the sample to MND-positive and/or MND-negative reference levels of the one or more biomarkers in order to determine whether the subject has MND or non-MND symptom mimic disease. The MND-positive and/or MND-negative reference levels may be levels that are specific for comparison with non-MND symptom mimic disease (e.g., reference levels of biomarkers for MND that distinguish between non-MND symptom mimic disease).

The one or more biomarkers that are used are selected from the biomarkers listed in Table 13, and any combination thereof. For example, in another embodiment, a method of distinguishing whether a subject has MND comprises (1) analyzing a biological sample from a subject to determine the level(s) of one or more biomarkers for MND in the sample, wherein the one or more biomarkers comprise the biomarkers listed in Table 13 and any combination thereof; and (2) comparing the level(s) of the one or more biomarkers in the sample to MND-positive and/or MND-negative reference levels of the one or more biomarkers in order to determine whether a subject has MND.

Any suitable method may be used to analyze the biological sample in order to determine the level(s) of the one or more biomarkers in the sample. Suitable methods include chromatography (e.g., HPLC, gas chromatography, liquid chromatography), mass spectrometry (e.g., MS, MS-MS), enzyme-linked immunosorbent assay (ELISA), antibody linkage, other immunochemical techniques, and combinations thereof. Further, the level(s) of the one or more biomarkers may be measured indirectly, for example, by using an assay that measures the level of a compound (or compounds) that correlates with the level of the biomarker(s) that are desired to be measured.

After the level(s) of the one or more biomarkers in the sample are determined, the level(s) are compared to MND-positive and/or MND-negative reference levels to distinguish whether the subject has MND. Levels of the one or more biomarkers in a sample corresponding to the MND-positive reference levels (e.g., levels that are the same as the reference levels, substantially the same as the reference levels, above and/or below the minimum and/or maximum of the reference levels, and/or within the range of the reference levels) are indicative of a diagnosis of MND in the subject. Levels of the one or more biomarkers in a sample corresponding to the MND-negative reference levels (e.g., levels that are the same as the reference levels, substantially the same as the reference levels, above and/or below the minimum and/or maximum of the reference levels, and/or within the range of the reference levels) are indicative of a diagnosis of no MND in the subject. In addition, levels of the one or more biomarkers that are differentially present (especially at a level that is statistically significant) in the sample as compared to MND-negative reference levels are indicative of a diagnosis of MND in the subject. Levels of the one or more biomarkers that are differentially present (especially at a level that is statistically significant) in the sample as compared to MND-positive reference levels are indicative of a diagnosis of no MND in the subject. The level(s) of the one or more biomarkers may be compared to MND-positive and/or MND-negative reference levels using various techniques, including a simple comparison (e.g., a manual comparison) of the level(s) of the one or more biomarkers in the biological sample to MND-positive and/or MND-negative reference levels. The level(s) of the one or more biomarkers in the biological sample may also be compared to MND-positive and/or MND-negative reference levels using one or more statistical analyses (e.g., t-test, Welch's T-test, Wilcoxon's rank sum test, Random Forest, T-score, Z-score) or using a mathematical model (e.g., algorithm, statistical model).

### VI. Methods of Monitoring Progression/Regression of ALS

The identification of biomarkers for ALS also allows for monitoring progression/regression of ALS in a subject. A method of monitoring the progression/regression of amyotrophic lateral sclerosis in a subject comprises (1) analyzing a first biological sample from a subject to determine the level(s) of one or more biomarkers for ALS selected from one or more biomarkers listed in Tables 1, 5, 9, 11, 12, 13, 14, 15, 16, 17, 18 and 19 and combinations thereof, the first sample obtained from the subject at a first time point, (2) analyzing a second biological sample from a subject to determine the level(s) of the one or more biomarkers, the second sample obtained from the subject at a second time point, and (3) comparing the level(s) of one or more biomarkers in the first sample to the level(s) of the one or more biomarkers in the second sample in order to monitor the progression/regression of ALS in the subject. The results of the method are indicative of the course of ALS (i.e., progression or regression, if any change) in the subject.

The change (if any) in the level(s) of the one or more biomarkers over time may be indicative of progression or regression of ALS in the subject. In order to characterize the course of ALS in the subject, the level(s) of the one or more biomarkers in the first sample, the level(s) of the one or more biomarkers in the second sample, and/or the results of the comparison of the levels of the biomarkers in the first and second samples may be compared to ALS-positive and/or ALS-negative reference levels of the one or more biomarkers. If the comparisons indicate that the level(s) of the one or more biomarkers are increasing or decreasing over time (e.g., in the second sample as compared to the first sample) to become more similar to the ALS-positive reference levels (or less similar to the ALS-negative reference levels), then the results are indicative of ALS progression. If the comparisons indicate that the level(s) of the one or more biomarkers are increasing or decreasing over time to become more similar to the ALS-negative reference levels (or less similar to the ALS-positive reference levels), then the results are indicative of ALS regression.

The course of ALS in the subject may also be characterized by comparing the level(s) of the one or more biomarkers in the first sample, the level(s) of the one or more biomarkers in the second sample, and/or the results of the comparison of the levels of the biomarkers in the first and second samples to ALS-progression-positive and/or ALS-regression-positive reference levels (e.g., Examples 7 and 11 below describe biomarkers for distinguishing early stage ALS vs. later stage ALS indicating whether certain biomarkers increase or decrease as ALS progresses; such trends and/or levels of biomarkers at a later stage of ALS versus an earlier stage of ALS are one example of ALS-progression positive reference levels). If the comparisons indicate that the level(s) of the one or more biomarkers are increasing or decreasing with decreasing ALSFRS-R score to become more similar to the ALS-progression-positive reference levels (or less similar to the ALS-regression-positive reference levels), then the results are indicative of ALS progression. If the comparisons indicate that the level(s) of the one or more biomarkers are increasing or decreasing with decreasing ALSFRS-R scores to become more similar to the ALS-regression-positive reference levels (or less similar to the ALS-progression-positive reference levels), then the results are indicative of ALS regression.

As with the other methods described herein, the comparisons made in the methods of monitoring progression/regression of ALS in a subject may be carried out using various techniques, including simple comparisons, one or more statistical analyses, mathematical models (algorithms) and combinations thereof.

The results of the method may be used along with other methods (or the results thereof) useful in the clinical monitoring of progression/regression of ALS in a subject.

As described above in connection with methods of diagnosing (or aiding in the diagnosis of) ALS, any suitable method may be used to analyze the biological samples in order to determine the level(s) of the one or more biomarkers in the samples. In addition, the level(s) one or more biomarkers, including selected from one or more biomarkers listed in Tables 1, 5, 9, 11, 12, 13, 14, 15, 16, 17, 18 and 19 and combinations thereof may be determined and used in methods of monitoring progression/regression of ALS in a subject.

In one example, the results of the method may be based on an ALS Status Score which is indicative of the presence or severity of ALS in the subject and which can be monitored over time. By comparing the ALS Status Score from a first time point sample to the ALS Status Score from at least a second time point sample the progression or regression of ALS can be determined. Such a method of monitoring the progression/regression of ALS in a subject comprises (1) analyzing a first biological sample from a subject to determine an ALS Status Score for the first sample obtained from the subject at a first time point, (2) analyzing a second biological sample from a subject to determine a second ALS Status Score, the second sample obtained from the subject at a second time point, and (3) comparing the ALS Status Score in the first sample to the ALS Score in the second sample in order to monitor the progression/regression of ALS in the subject.

Such methods could be conducted to monitor the course of ALS in subjects having ALS or could be used in subjects not having ALS (e.g., subjects suspected of being predisposed to developing ALS) in order to monitor levels of predisposition to ALS.

### VII. Methods of Determining Predisposition to ALS

The identification of biomarkers for ALS also allows for the determination of whether a subject having no symptoms of ALS is predisposed to developing ALS. A method of determining whether a subject having no symptoms of ALS is predisposed to developing amyotrophic lateral sclerosis comprises (1) analyzing a biological sample from a subject to determine the level(s) of one or more biomarkers selected from Tables 1, 5, 9, 11, 12, 13, 16, 17 and 18 in the sample and (2) comparing the level(s) of the one or more biomarkers in the sample to ALS-positive and/or ALS-negative reference levels of the one or more biomarkers in order to determine whether the subject is predisposed to developing amyotrophic lateral sclerosis. The results of the method may be used along with other methods (or the results thereof) useful in the clinical determination of whether a subject is predisposed to developing ALS.

As described above in connection with methods of diagnosing (or aiding in the diagnosis of) ALS, any suitable method may be used to analyze the biological sample in order to determine the level(s) of the one or more biomarkers in the sample.

As with the methods of diagnosing (or aiding in the diagnosis of) ALS described above, the level(s) of one biomarker, two or more biomarkers, three or more biomarkers, four or more biomarkers, five or more biomarkers, six or more biomarkers, seven or more biomarkers, eight or more biomarkers, nine or more biomarkers, ten or more biomarkers, etc., including a combination of all of the biomarkers selected from Tables 1, 5, 9, 11, 12, 13, 16, 17 and 18 or any fraction thereof, may be determined and used in methods of determining whether a subject having no symptoms of ALS is predisposed to developing ALS.

After the level(s) of the one or more biomarkers in the sample are determined, the level(s) are compared to ALS-positive and/or ALS-negative reference levels in order to predict whether the subject is predisposed to developing amyotrophic lateral sclerosis. Levels of the one or more biomarkers in a sample corresponding to the ALS-positive reference levels (e.g., levels that are the same as the reference levels, substantially the same as the reference levels, above and/or below the minimum and/or maximum of the reference levels, and/or within the range of the reference levels) are indicative of the subject being predisposed to developing ALS. Levels of the one or more biomarkers in a sample corresponding to the ALS-negative reference levels (e.g., levels that are the same as the reference levels, substantially the same as the reference levels, above and/or below the minimum and/or maximum of the reference levels, and/or within the range of the reference levels) are indicative of the subject not being predisposed to developing ALS. In addition, levels of the one or more biomarkers that are differentially present (especially at a level that is statistically significant) in the sample as compared to ALS-negative reference levels are indicative of the subject being predisposed to developing ALS. Levels of the one or more biomarkers that are differentially present (especially at a level that is statistically significant) in the sample as compared to ALS-positive reference levels are indicative of the subject not being predisposed to developing ALS.

Furthermore, it may also be possible to determine reference levels specific to assessing whether or not a subject that does not have ALS is predisposed to developing ALS. For example, it may be possible to determine reference levels of the biomarkers for assessing different degrees of risk (e.g., low, medium, high) in a subject for developing ALS. Such reference levels could be used for comparison to the levels of the one or more biomarkers in a biological sample from a subject.

As with the methods described above, the level(s) of the one or more biomarkers may be compared to ALS-positive and/or ALS-negative reference levels using various techniques, including a simple comparison (e.g., a manual comparison) of the level(s) of the one or more biomarkers in the biological sample to ALS-positive and/or ALS-negative reference levels. The level(s) of the one or more biomarkers in the biological sample may also be compared to ALS-positive and/or ALS-negative reference levels using one or more statistical analyses (e.g., T-score, Z-score) or using a mathematical model (e.g., algorithm), and combinations thereof.

As with the methods of diagnosing (or aiding in diagnosing) whether a subject has ALS, the methods of determining whether a subject having no symptoms of ALS is predisposed to developing amyotrophic lateral sclerosis may further comprise analyzing the biological sample to determine the level(s) of one or more non-biomarker compounds.

### VIII. Methods of Assessing Efficacy of Compositions for Treating ALS

The identification of biomarkers for ALS also allows for assessment of the efficacy of a composition for treating ALS as well as the assessment of the relative efficacy of two or more compositions for treating ALS. Such assessments may be used, for example, in efficacy studies as well as in lead selection of compositions for treating ALS.

A method of assessing the efficacy of a composition for treating amyotrophic lateral sclerosis comprises (1) analyzing, from a subject (or group of subjects) having amyotrophic lateral sclerosis and currently or previously being treated with a composition, a biological sample (or group of samples) to determine the level(s) of one or more biomarkers selected from one or more biomarkers listed in Tables 1, 5, 9, 11, 12, 13, 14, 15, 16, 17, 18 and 19 and combinations thereof, and (2) comparing the level(s) of the one or more biomarkers in the sample (or group of samples) to (a) level(s) of the one or more biomarkers in a previously-taken biological sample (or group of samples) from the subject (or group of subjects), wherein the previously-taken biological sample was obtained from the subject (or group of subjects) before being treated with the composition, (b) ALS-positive reference levels of the one or more biomarkers, (c) ALS-negative reference levels of the one or more biomarkers (d) ALS-progression-positive reference levels of the one or more biomarkers, and/or (e) ALS-regression-positive reference levels of the one or more biomarkers. The results of the comparison are indicative of the efficacy of the composition for treating ALS.

Thus, in order to characterize the efficacy of the composition for treating ALS, the level(s) of the one or more biomarkers in the biological sample are compared to (1) ALS-positive reference levels, (2) ALS-negative reference levels, (3) ALS-progression-positive reference levels, (4) ALS-regression-positive reference levels, and/or (5) previous levels of the one or more biomarkers in the subject (or group of subjects) before treatment with the composition.

When comparing the level(s) of the one or more biomarkers in the biological sample (from a subject or group of subjects having amyotrophic lateral sclerosis and currently or previously being treated with a composition) to ALS-positive reference levels, ALS-negative reference levels, ALS-progression-positive reference levels, and/or ALS-regression-positive reference levels, level(s) in the sample(s) corresponding to the ALS-negative reference levels or ALS-regression-positive reference levels (e.g., levels that are the same as the reference levels, substantially the same as the reference levels, above and/or below the minimum and/or maximum of the reference levels, and/or within the range of the reference levels) are indicative of the composition having efficacy for treating ALS. Levels of the one or more biomarkers in the sample(s) corresponding to the ALS-positive reference levels or ALS-progression-positive reference levels (e.g., levels that are the same as the reference levels, substantially the same as the reference levels, above and/or below the minimum and/or maximum of the reference levels, and/or within the range of the reference levels) are indicative of the composition not having efficacy for treating ALS. The comparisons may also indicate degrees of efficacy for treating ALS based on the level(s) of the one or more biomarkers.

When the level(s) of the one or more biomarkers in the biological sample (from a subject or group of subjects having ALS and currently or previously being treated with a composition) are compared to level(s) of the one or more biomarkers in a previously-taken biological sample(s) from the subject (or group of subjects) before treatment with the composition, any changes in the level(s) of the one or more biomarkers are indicative of the efficacy of the composition for treating ALS. That is, if the comparisons indicate that the level(s) of the one or more biomarkers have increased or decreased after treatment with the composition to become more similar to the ALS-negative or ALS-regression-positive reference levels (or less similar to the ALS-positive or ALS-progression positive reference levels), then the results are indicative of the composition having efficacy for treating ALS. If the comparisons indicate that the level(s) of the one or more biomarkers have not increased or decreased after treatment with the composition to become more similar to the ALS-negative or ALS-regression-positive reference levels (or less similar to the ALS-positive or ALS-progression-positive reference levels), then the results are indicative of the composition not having efficacy for treating ALS. The comparisons may also indicate degrees of efficacy for treating ALS based on the amount of changes observed in the level(s) of the one or more biomarkers after treatment. In order to help characterize such a comparison, the changes in the level(s) of the one or more biomarkers, the level(s) of the one or more biomarkers before treatment, and/or the level(s) of the one or more biomarkers in the subject currently or previously being treated with the composition may be compared to ALS-positive, ALS-negative, ALS-progression-positive, and/or ALS-regression-positive reference levels of the one or more biomarkers.

Another method for assessing the efficacy of a composition in treating amyotrophic lateral sclerosis (ALS) comprises (1) analyzing a first biological sample (or group of samples) from a subject (or group of subjects) to determine the level(s) of one or more biomarkers selected from one or more biomarkers listed in Tables 1, 5, 9, 11, 12, 13, 14, 15, 16, 17, 18 and 19 and combinations thereof, the first sample obtained from the subject at a first time point, (2) administering the composition to the subject, (3) analyzing a second biological sample from a subject to determine the level(s) of the one or more biomarkers, the second sample obtained from the subject at a second time point after administration of the composition, and (4) comparing the level(s) of one or more biomarkers in the first sample to the level(s) of the one or more biomarkers in the second sample in order to assess the efficacy of the composition for treating amyotrophic lateral sclerosis. As indicated above, if the comparison of the samples indicates that the level(s) of the one or more biomarkers have increased or decreased after administration of the composition to become more similar to the ALS-negative or ALS-regression-positive reference levels (or less similar to the ALS-positive or ALS-progression-positive reference levels), then the results are indicative of the composition having efficacy for treating ALS. If the comparison indicates that the level(s) of the one or more biomarkers have not increased or decreased after administration of the composition to become more similar to the ALS-negative or ALS-regression-positive reference levels (or less similar to the ALS-positive or ALS-progression-positive reference levels), then the results are indicative of the composition not having efficacy for treating ALS. The comparison may also indicate a degree of efficacy for treating ALS based on the amount of changes observed in the level(s) of the one or more biomarkers after administration of the composition. In order to help characterize such a comparison, the changes in the level(s) of the one or more biomarkers, the level(s) of the one or more biomarkers before administration of the composition, and/or the level(s) of the one or more biomarkers after administration of the composition may be compared to ALS-positive, ALS-negative, ALS-progression-positive, and/or ALS-regres sion-positive reference levels of the one or more biomarkers of the two compositions.

A method of assessing the relative efficacy of two or more compositions for treating amyotrophic lateral sclerosis comprises (1) analyzing, from a first subject having ALS and currently or previously being treated with a first composition, a first biological sample to determine the level(s) of one or more biomarkers selected from one or more biomarkers listed in Tables 1, 5, 9, 11, 12, 13, 14, 15, 16, 17, 18 and 19 and combinations thereof, (2) analyzing, from a second subject having ALS and currently or previously being treated with a second composition, a second biological sample to determine the level(s) of the one or more biomarkers, and (3) comparing the level(s) of one or more biomarkers in the first sample to the level(s) of the one or more biomarkers in the second sample in order to assess the relative efficacy of the first and second compositions for treating amyotrophic lateral sclerosis. The results are indicative of the relative efficacy of the two compositions, and the results (or the levels of the one or more biomarkers in the first sample and/or the level(s) of the one or more biomarkers in the second sample) may be compared to ALS-positive, ALS-negative, ALS-progression-positive, and/or ALS-regression-positive reference levels to aid in characterizing the relative efficacy.

Each of the methods of assessing efficacy may be conducted on one or more subjects or one or more groups of subjects (e.g., a first group being treated with a first composition and a second group being treated with a second composition).

As with the other methods described herein, the comparisons made in the methods of assessing efficacy (or relative efficacy) of compositions for treating ALS may be carried out using various techniques, including simple comparisons, one or more statistical analyses, a mathematical model or algorithm, an ALS status score, and combinations thereof. Any suitable method may be used to analyze the biological samples in order to determine the level(s) of the one or more biomarkers in the samples. In addition, the level(s) of one or more biomarkers, including a combination both of the biomarkers selected from one or more biomarkers listed in Tables 1, 5, 9, 11, 12, 13, 14, 15, 16, 17, 18 and 19 and combinations thereof, may be determined and used in methods of assessing efficacy (or relative efficacy) of compositions for treating ALS.

Finally, the methods of assessing efficacy (or relative efficacy) of one or more compositions for treating ALS may further comprise analyzing the biological sample to determine the level(s) of one or more non-biomarker compounds. The non-biomarker compounds may then be compared to reference levels of non-biomarker compounds for subjects having (or not having) ALS.

IX. Methods of Screening a Composition for Activity in Modulating Biomarkers Associated with ALS

The identification of biomarkers for ALS also allows for the screening of compositions for activity in modulating biomarkers associated with ALS, which may be useful in treating ALS. Methods of screening compositions useful for treatment of ALS comprise assaying test compositions for activity in modulating the levels of one or more biomarkers selected from one or more biomarkers listed in Tables 1, 5, 9, 11, 12, 13, 14, 15, 16, 17, 18 and 19 and combinations thereof. Such screening assays may be conducted in vitro and/or in vivo, and may be in any form known in the art useful for assaying modulation of such biomarkers in the presence of a test composition such as, for example, cell culture assays, organ culture assays, and in vivo assays (e.g., assays involving animal models).

In one embodiment, a method for screening a composition for activity in modulating one or more biomarkers of amyotrophic lateral sclerosis comprises (1) contacting one or more cells with a composition, (2) analyzing at least a portion of the one or more cells or a biological sample associated with the cells to determine the level(s) of one or more biomarkers of amyotrophic lateral sclerosis selected from one or more biomarkers listed in Tables 1, 5, 9, 11, 12, 13, 14, 15, 16, 17, 18 and 19 and combinations thereof; and (3) comparing the level(s) of the one or more biomarkers with predetermined standard levels for the one or more biomarkers to determine whether the composition modulated the level(s) of the one or more biomarkers. As discussed above, the cells may be contacted with the composition in vitro and/or in vivo. The predetermined standard levels for the one or more biomarkers may be the levels of the one or more biomarkers in the one or more cells in the absence of the composition. The predetermined standard levels for the one or more biomarkers may also be the level(s) of the one or more biomarkers in control cells not contacted with the composition.

In addition, the methods may further comprise analyzing at least a portion of the one or more cells or a biological sample associated with the cells to determine the level(s) of one or more non-biomarker compounds of amyotrophic lateral sclerosis. The levels of the non-biomarker compounds may then be compared to predetermined standard levels of the one or more non-biomarker compounds.

Any suitable method may be used to analyze at least a portion of the one or more cells or a biological sample associated with the cells in order to determine the level(s) of the one or more biomarkers (or levels of non-biomarker compounds). Suitable methods include chromatography (e.g., HPLC, gas chromatograph, liquid chromatography), mass spectrometry (e.g., MS, MS-MS), ELISA, antibody linkage, other immunochemical techniques, and combinations thereof. Further, the level(s) of the one or more biomarkers (or levels of non-biomarker compounds) may be measured indirectly, for example, by using an assay that measures the level of a compound (or compounds) that correlates with the level of the biomarker(s) (or non-biomarker compounds) that are desired to be measured.

### X. Method of Identifying Potential Drug Targets

The identification of biomarkers for ALS also allows for the identification of potential drug targets for ALS. A method for identifying a potential drug target for amyotrophic lateral sclerosis (ALS) comprises (1) identifying one or more biochemical pathways associated with one or more biomarkers for ALS selected from Tables 1, 5, 9, 11, 12, 13, 14, 15, 16, 17, 18 and 19 and (2) identifying a protein (e.g., an enzyme, a transporter protein) affecting at least one of the one or more identified biochemical pathways, the protein being a potential drug target for amyotrophic lateral sclerosis.

Another method for identifying a potential drug target for amyotrophic lateral sclerosis (ALS) comprises (1) identifying one or more biochemical pathways associated with one or more biomarkers for ALS selected from Tables 1, 5, 9, 11, 12, 13, 14, 15, 16, 17, 18 and 19 and one or more non-biomarker compounds of ALS selected from Tables 1, 5, 9, 11, 12, 13, 14, 15, 16, 17, 18 and 19 and (2) identifying a protein affecting at least one of the one or more identified biochemical pathways, the protein being a potential drug target for amyotrophic lateral sclerosis.

One or more biochemical pathways (e.g., biosynthetic and/or metabolic (catabolic) pathway) are identified that are associated with one or more biomarkers (or non-biomarker compounds). After the biochemical pathways are identified, one or more proteins affecting at least one of the pathways are identified. Preferably, those proteins affecting more than one of the pathways are identified.

A build-up of one metabolite (e.g., a pathway intermediate) may indicate the presence of a ‘block’ downstream of the metabolite and the block may result in a low/absent level of a downstream metabolite (e.g. product of a biosynthetic pathway). In a similar manner, the absence of a metabolite could indicate the presence of a ‘block’ in the pathway upstream of the metabolite resulting from inactive or non-functional enzyme(s) or from unavailability of biochemical intermediates that are required substrates to produce the product. Alternatively, an increase in the level of a metabolite could indicate a genetic mutation that produces an aberrant protein which results in the over-production and/or accumulation of a metabolite which then leads to an alteration of other related biochemical pathways and result in dysregulation of the normal flux through the pathway; further, the build-up of the biochemical intermediate metabolite may be toxic or may compromise the production of a necessary intermediate for a related pathway. It is possible that the relationship between pathways is currently unknown and this data could reveal such a relationship.

For example, it has been proposed that high glutamate levels in ALS lead to hyper-excitability of the glutamate receptors, causing neurotoxicity. The drug Riluzole is thought to work by lowering glutamate levels by pre-synaptically inhibiting glutamate release in the central nervous system. This drug, however, does not lower the overall glutamate levels in the body. The identity of glutamate as a biomarker that is elevated in ALS as compared to a normal subject would suggest that potential drug targets may be in the pathways leading to glutamate production. A composition that would function by inhibiting the synthesis of glutamate may suppress the levels of glutamate. An example of such an enzyme is glutaminase 2, which converts glutamine to glutamate. Pathways leading to the production of any elevated biomarker would provide a number of potential targets for drug discovery.

The proteins identified as potential drug targets may then be used to identify compositions that may be potential candidates for treating ALS, including compositions for gene therapy.

### XI. Methods of Treating ALS

The identification of biomarkers for ALS also allows for the treatment of ALS. For example, in order to treat a subject having ALS, an effective amount of one or more ALS biomarkers that are lowered in ALS as compared to a healthy subject not having ALS may be administered to the subject. The biomarkers that may be administered may comprise one or more of the biomarkers in Tables 1, 5, 9, 11, 12, 13, 14, 15, 16, 17, 18 and 19 that are decreased in ALS as compared to subjects not having ALS. Such biomarkers could be isolated based on the identity of the biomarker compound (i.e. compound name). In some embodiments, the biomarkers that are administered are one or more biomarkers listed in Tables 1, 5, 9, 11, 12, 13, 14, 15, 16, 17, 18 and 19 that are decreased in ALS and that have a p-value less than 0.05 and/or a false discovery rate of less than 0.2. In other embodiments, the biomarkers that are administered are one or biomarkers listed in Tables 1, 5, 9, 11, 12, 13, 14, 15, 16, 17, 18 and 19 that are decreased in ALS by at least 5%, by at least 10%, by at least 15%, by at least 20%, by at least 25%, by at least 30%, by at least 35%, by at least 40%, by at least 45%, by at least 50%, by at least 55%, by at least 60%, by at least 65%, by at least 70%, by at least 75%, by at least 80%, by at least 85%, by at least 90%, by at least 95%, or by at least 100% or more (i.e., absent).

Biomarkers listed in Tables 1, 5, 9, 11, 12, 13, 14, 15, 16, 17, 18 and 19 may be useful as therapeutic agents. Exemplary markers include tryptophan betaine, indolepropionate, and homocarnosine. Such metabolites are decreased in ALS relative to Healthy participants and symptom mimic disease participants, indicating that supplementing with the metabolite may be useful to treat ALS. Tryptophan betaine and indolepropionate are both particularly interesting in the pathogenesis of ALS. Tryptophan betaine, a quaternary amine, has significantly reduced levels in the plasma of ALS patients, possibly due to uptake from the circulation. This suggests that tryptophan betaine could be at higher levels in other parts of the body such as in the brain or spinal cord. Tryptophan betaine has no known metabolic fate in humans, and its presence could contribute to energy dysregulation or axonal disruption. Tryptophan betaine is produced by plants and ectomycorrhizal fungi and has been shown to induce actin reorganization in root hairs. The actin cytoskeleton is important in motor neuron formation and reorganization. Indolepropionate, a deamination product of tryptophan formed by symbiotic bacteria in the gastrointestinal tract of mammals and birds, has known antioxidant properties and functions as a free radical scavenger. Oxidative stress is associated with motor neuron death in ALS; increasing levels of antioxidants such as indolepropionate ameliorate oxidative stress.

### XII. Other Methods

Other methods of using the biomarkers discussed herein are also contemplated. For example, the methods described in U.S. Pat. No. 7,005,255, U.S. Pat. No. 7,329,489; U.S. Pat. No. 7,550,258; U.S. Pat. No. 7,550,260; U.S. Pat. No. 7,553,616; U.S. Pat. No. 7,635,556; U.S. Pat. No. 7,682,783; U.S. Pat. No. 7,682,784; U.S. Pat. No. 7,910,301 and U.S. Pat. No. 7,947,453 may be conducted using a small molecule profile comprising one or more of the biomarkers disclosed herein and/or one or more of the non-biomarker compounds disclosed herein.

In any of the methods listed herein, the biomarkers that are used may be selected from those biomarkers in Tables 1, 5, 9, 11, 12, 13, 14, 15, 16, 17, 18 and 19 having p-values of less than 0.05 and/or those biomarkers in Tables 1, 5, 9, 11, 12, 13, 14, 15, 16, 17, 18 and 19 having q-values of less than 0.10. The biomarkers that are used in any of the methods described herein may also be selected from those biomarkers in Tables 1, 5, 9, 11, 12, 13, 14, 15, 16, 17, 18 and 19 that are decreased as compared to the control group (e.g., subjects not having ALS, subjects with a symptom mimic disease, subjects with non-ALS MND, subjects having an earlier stage of ALS, etc.) by at least 5%, by at least 10%, by at least 15%, by at least 20%, by at least 25%, by at least 30%, by at least 35%, by at least 40%, by at least 45%, by at least 50%, by at least 55%, by at least 60%, by at least 65%, by at least 70%, by at least 75%, by at least 80%, by at least 85%, by at least 90%, by at least 95%, or by at least 100% or more (i.e., absent); and/or those biomarkers in Tables 1, 5, 9, 11, 12, 13, 14, 15, 16, 17, 18 and 19 that are increased as compared to the control group by at least 5%, by at least 10%, by at least 15%, by at least 20%, by at least 25%, by at least 30%, by at least 35%, by at least 40%, by at least 45%, by at least 50%, by at least 55%, by at least 60%, by at least 65%, by at least 70%, by at least 75%, by at least 80%, by at least 85%, by at least 90%, by at least 95%, by at least 100%, by at least 110%, by at least 120%, by at least 130%, by at least 140%, by at least 150%, or more.

### EXAMPLES

The invention will be further explained by the following illustrative examples that are intended to be non-limiting.

### I. General Methods

A. Identification of Metabolic Profiles for ALS

Each sample was analyzed to determine the concentration of several hundred metabolites. Analytical techniques such as GC-MS (gas chromatography-mass spectrometry) and LC-MS (liquid chromatography-mass spectrometry) were used to analyze the metabolites. Multiple aliquots were simultaneously, and in parallel, analyzed, and, after appropriate quality control (QC), the information derived from each analysis was recombined. Every sample was characterized according to several thousand characteristics, which ultimately amount to several hundred chemical species. The techniques used were able to identify novel and chemically unnamed compounds. The methods are described in at least U.S. Pat. No. 7,884,318; Evans et al., 2009, Analytical Chemistry 81: 6656-6667; and Lawton et al., 2008, Pharmacogenomics 9: 383-397.

B. Statistical Analysis

The metabolomic data was analyzed using several statistical methods to identify molecules (either known, named metabolites or unnamed metabolites) present at differential levels in a definable population or subpopulation (e.g., biomarkers for ALS biological samples compared to healthy control biological samples; biomarkers for ALS compared to other diseases having symptoms similar to ALS; biomarkers for ALS compared to non-ALS MND; biomarkers for MND compared to other diseases having symptoms similar to ALS) useful for distinguishing between the definable populations (e.g., ALS and control; ALS and symptom mimic disease patients; ALS and non-ALS MND; MND and other diseases with symptoms that mimic ALS). Other molecules (either known, named metabolites or unnamed metabolites) in the definable population or subpopulation can also be identified.

T-test comparisons were used to test if the means of two independent groups (e.g. ALS and control; ALS and symptom mimic disease s; ALS and non-ALS MND; MND and symptom mimic diseases), were equal. Two parameters are typically evaluated when considering statistical significance, namely the p-value and the q-value. The p-value relates the probability of obtaining a result as or more extreme than the observed data; a low p-value (p≦0.05) is generally accepted as strong evidence that the two means are different. The q-value describes the false discovery rate; a low q-value (q≦0.2) is an indication of high confidence in a result (because of the multiple testing occurring in the data sets produced by metabolomic studies, data is often evaluated for false positives).

While a higher q-value indicates diminished confidence, it does not necessarily rule out the significance of a result. Other lines of evidence may be taken into consideration when determining whether a result merits further scrutiny. Such evidence may include a) significance in another dimension of the study, b) inclusion in a common pathway with a highly significant compound, or c) residing in a similar functional biochemical family with other significant compounds.

Random Forest analysis was used for classification of samples into groups (e.g. disease or healthy). Random Forests give an estimate of how well individuals in a new data set can be classified into each group, in contrast to a t-test, which tests whether the unknown means for two populations are different or not. Random Forests create a set of classification trees based on continual sampling of the experimental units and compounds. Then each observation is classified based on the majority votes from all the classification trees. The results of the analysis are presented in a table termed the Confusion Matrix.

Based on the Random Forest Confusion Matrix, the sensitivity, specificity, positive predictive value (PPV), and negative predictive value (NPV) for the classification of the samples were calculated. Sensitivity is the ability to identify positives or the proportion of subjects classified as positive among all those that are truly positive. Specificity is the ability to identify negatives or the proportion of the subjects classified as negative among all those that are truly negative. PPV is the true positive rate or the proportion of subjects that are truly positive among all those classified as positive. NPV is the true negative rate or the proportion of the subjects that are truly negative among all those classified as negative. Using these data, a receiver operating characteristic (ROC) curve was generated. The ROC curve is a plot of the sensitivity vs. false positive rate (1−specificity). The area under the curve (AUC) from this curve is the probability that a classifier will rank a randomly chosen positive instance higher than a randomly chosen negative one.

Regression analysis was performed using the Random Forest Regression method and the Univariate Correlation/Linear Regression method to build models that are useful to identify the biomarker compounds that are associated with disease or disease indicators obtained from the patient metadata (e.g. ALS-FRS score) and then to identify biomarker compounds useful to classify individuals. Biomarker compounds that are useful to predict disease or measures of disease (e.g. ALS) and that are positively or negatively correlated with disease or measures of disease (e.g. ALS) were identified in these analyses.

Least Absolute Shrinkage and Selection Operator penalized logistic regression (LASSO) and Support Vector Machine (SVM) predictions were used to classify the samples. LASSO regression, a standard approach for high dimensional data, uses L1 penalty, minimizing the residual sum of squares subject to the sum of the absolute value of the regression coefficient less than a constant. The tuning parameter is determined by cross validation using training data only within each cross validation fold. SVM is a powerful machine learning method based on the Vapnik-Chervonenkis theory; it has strong regularization properties and is applied to pattern recognition problems. With this method, the data input space is projected into feature space, and then an optimal hyperplane is constructed to maximize the separating margin of the two classification categories. Linear kernel was applied. Leave one out cross validation (LOO) was used to evaluate the predictive performance, and the area under the curve (AUC) was computed based on predictive probability.

Bayesian factor regression modeling (BFRM), a well-cited unsupervised approach for high dimensional data, was used for feature construction to uncover the underlying latent metabolomic signature which can be powerful in prediction. BFRM factorizes the data matrix X (i.e., normalized metabolomic data) as X=AΛ+Ψ where A is a factor loadings matrix, Λ is a factor scores matrix and Ψ is an error matrix. The number of factors is estimated statistically. With this approach, individual metabolites are grouped into meta metabolites (i.e., groups of metabolites) which reflect aggregate patterns associated with a pathway or network. Factor data was then used as the features for predictive models. The factor data is not high dimensional (p<n), and the correlation among factors is negligible, therefore a logistic model is used for prediction. Leave one out cross validation (LOO) was used to evaluate the predictive performance, and the area under the curve (AUC) was computed based on predictive probability.

The Wilcoxon signed-rank test and the Benjamini-Hochberg (BH) method for multiple test adjustment were used for biomarker candidate selection; metabolites with a false discovery rate <0.15 were selected as candidate biomarkers.

Recursive partitioning relates a ‘dependent’ variable (Y) to a collection of independent (‘predictor’) variables (X) in order to uncover or understand the relationship, Y=f(X). This analysis can be performed with the JMP program (SAS) to generate a decision tree. The statistical significance of the “split” of the data can be placed on a more quantitative footing by computing p-values, which discern the quality of a split relative to a random event. The significance level of each “split” of data into the nodes or branches of the tree can be computed as p-values, which discern the quality of the split relative to a random event. It is given as LogWorth, which is the negative log 10 of a raw p-value.

Bayesian factor regression modeling was performed using MATLAB and Version 2 of BFRM software. The “R” package “glmnet” was used for running LASSO. All other statistical analyses were performed with the program “R” available on the worldwide web at the website cran.r-project.org and in JMP 6.0.2 (SAS® Institute, Cary, N.C.).

C. Biomarker Identification

Various peaks identified in the analyses (e.g. GC-MS, LC-MS, MS-MS), including those identified as statistically significant, were subjected to a mass spectrometry based chemical identification process.

### Example 1

### Biomarkers that Distinguish ALS from Healthy Subjects in Plasma

In one example, biomarkers were discovered by (1) analyzing plasma samples from different groups of human subjects to determine the levels of metabolites in the samples and then (2) statistically analyzing the results to determine those metabolites that are differentially present in the two groups.

Four studies were carried out to identify biomarkers that distinguish ALS patients from Healthy Control subjects (i.e., individuals that have not been diagnosed with ALS or other neurological disorders). In study 1, plasma samples from 62 ALS subjects and 69 healthy control subjects not diagnosed with ALS were used for the analysis. In Study 2, plasma samples used for the analysis were from 172 ALS subjects and 50 healthy control subjects not diagnosed with ALS. In Study 3, the plasma samples used for the analysis were from 199 ALS subjects and 94 healthy control subjects not diagnosed with ALS. In Study 4, the plasma samples used for the analysis were from 62 ALS subjects and 62 healthy control subjects not diagnosed with ALS. After the levels of metabolites were determined, the data were analyzed using univariate T-tests (i.e., Welch's T-test) as described in the General Methods section.

### Biomarkers

As listed below in Table 1, biomarkers were discovered that were differentially present between samples from ALS subjects and Healthy Control subjects not diagnosed with ALS.

Table 1 includes, for each biomarker, an indication of the percentage difference in the ALS mean as compared to the control mean (positive values represent an increase in ALS, and negative values represent a decrease in ALS), the p-value and the q-value (expressed in scientific notation), determined in the statistical analysis of the data concerning the biomarkers, and the study in which the biomarker was identified. CompID refers to the identifier for that biomarker in the internal chemical library database.

TABLE 1
ALS Biomarkers from plasma samples-T-test Analysis of ALS vs. Healthy Controls

| | | % | | | |
|---|---|---|---|---|---|
| | Comp | Change | | | |
| Biochemical Name | ID | in ALS | p-value | q-value | Study |
| tryptophan betaine | 37097 | −92% | 2.58E−06 | 5.23E−04 | Study 2 |
| indolepropionate | 32405 | −54% | 3.70E−03 | 4.49E−02 | Study 2 |
| 4-vinylphenol sulfate | 36098 | −43% | 1.90E−03 | 3.04E−02 | Study 2 |
| pro-hydroxy-pro | 35127 | 53% | 9.25E−08 | 2.98E−06 | Study 1 |
| theophylline | 18394 | −96% | 1.11E−06 | 3.38E−04 | Study 2 |
| cortisone | 1769 | 20% | 5.93E−05 | 4.51E−03 | Study 2 |
| paraxanthine | 18254 | −69% | 4.95E−05 | 4.31E−03 | Study 2 |
| creatine | 27718 | 57% | 9.41E−07 | 3.38E−04 | Study 2 |
| N1-methyladenosine | 15650 | 8% | 7.23E−04 | 1.92E−02 | Study 2 |
| 1-palmitoyl-sn-glycero-3- | 16138 | −11% | 4.47E−01 | 6.71E−01 | Study 4 |
| phosphocholine | | | | | |
| caffeine | 569 | −89% | 2.09E−05 | 2.54E−03 | Study 2 |
| quinate | 18335 | −79% | 1.03E−03 | 2.24E−02 | Study 2 |
| levulinate (4-oxovalerate) | 22177 | −27% | 2.70E−04 | 1.10E−02 | Study 2 |
| 1- | 33957 | 38% | 1.19E−03 | 2.35E−02 | Study 2 |
| heptadecanoylglycerophosphocholine | | | | | |
| 1,3,7-trimethylurate | 34404 | −52% | 1.34E−04 | 8.17E−03 | Study 2 |
| cortisol | 1712 | 26% | 1.49E−03 | 2.60E−02 | Study 2 |
| theobromine | 18392 | −75% | 3.87E−05 | 3.92E−03 | Study 2 |
| catechol sulfate | 35320 | −43% | 2.16E−04 | 9.37E−03 | Study 2 |
| pseudouridine | 33442 | 11% | 3.10E−03 | 7.50E−03 | Study 1 |
| biliverdin | 2137 | 27% | 1.45E−02 | 1.20E−01 | Study 2 |
| creatinine | 513 | −27% | 1.58E−08 | 1.02E−06 | Study 1 |
| 2-hydroxybutyrate (AHB) | 21044 | 40% | 1.63E−05 | 0.0001 | Study 1 |
| 10-undecenoate (11:1n1) | 32497 | −25% | 2.72E−03 | 3.93E−02 | Study 2 |
| citric acid | 6359 | −40% | 2.50E−05 | 4.94E−05 | Study 3 |
| alpha-ketobutyrate | 4968 | 33% | 1.43E−03 | 2.60E−02 | Study 2 |
| C-glycosyltryptophan | 32675 | 14% | 7.26E−04 | 1.92E−02 | Study 2 |
| histidine | 59 | −8% | 4.32E−03 | 5.37E−02 | Study 2 |
| oleoylcarnitine | 35160 | 34% | 1.49E−03 | 2.60E−02 | Study 2 |
| HWESASXX (SEQ ID NO: 1) | 32836 | 3% | 2.59E−02 | 1.71E−01 | Study 2 |
| bradykinin | 22154 | −54% | 1.10E−03 | 2.31E−02 | Study 2 |
| bradykinin, des-arg(9) | 34420 | 8% | 1.94E−02 | 1.48E−01 | Study 2 |
| bradykinin, hydroxy-pro(3) | 33962 | −61% | 9.78E−02 | 1.19E−01 | Study 1 |
| glutamyl-valine | 11053 | 744% | 6.35E−24 | 3.13E−22 | Study 3 |
| 2-isopropylmalic acid | 8449 | −46% | 4.47E−20 | 7.35E−19 | Study 3 |
| 4-methyl-2-oxopentanoate | 5808 | −45% | 4.30E−18 | 6.36E−17 | Study 3 |
| margarate (17:0) | 1121 | 61% | 3.66E−07 | 9.43E−06 | Study 1 |
| deoxycarnitine | 36747 | −33% | 1.22E−06 | 2.61E−05 | Study 1 |
| TMS-pyrophosphate | 9776 | 65% | 1.49E−06 | 3.94E−06 | Study 3 |
| 10-heptadecenoate (17:1n7) | 33971 | 68% | 2.05E−06 | 3.77E−05 | Study 1 |
| hypoxanthine | 3127 | 43% | 2.52E−06 | 4.05E−05 | Study 1 |
| choline | 5702 | 47% | 5.82E−06 | 1.41E−05 | Study 3 |
| mannose | 584 | 28% | 6.65E−06 | 0.0001 | Study 1 |
| palmitate (16:0) | 1336 | 37% | 1.13E−05 | 1.00E−04 | Study 1 |
| stearoyl sphingomyelin | 19503 | 50% | 1.51E−05 | 1.00E−04 | Study 1 |
| tiglyl carnitine | 35428 | −35% | 2.16E−05 | 2.00E−04 | Study 1 |
| uric acid | 7925 | −9% | 3.20E−05 | 5.98E−05 | Study 3 |
| L-alpha-glycerophosphorylcholine | 5563 | 20% | 3.82E−05 | 7.07E−05 | Study 3 |
| stearate (18:0) | 1358 | 34% | 4.06E−05 | 3.00E−04 | Study 1 |
| pyroglutamine | 32672 | −43% | 1.00E−04 | 5.00E−04 | Study 1 |
| myristate (14:0) | 1365 | 34% | 1.00E−04 | 5.00E−04 | Study 1 |
| oleate (18:1n9) | 1359 | 42% | 1.00E−04 | 5.00E−04 | Study 1 |
| docosapentaenoate (n3 DPA; 22:5n3) | 32504 | 62% | 1.00E−04 | 5.00E−04 | Study 1 |
| linoleate (18:2n6) | 1105 | 38% | 3.00E−04 | 1.60E−03 | Study 1 |
| EDTA | 32511 | 39% | 3.00E−04 | 1.50E−03 | Study 1 |
| eicosenoate (20:1n9 or 11) | 33587 | 49% | 3.00E−04 | 1.40E−03 | Study 1 |
| n-acetyl-L-aspartic acid | 7359 | −44% | 3.04E−04 | 4.78E−04 | Study 3 |
| HXGXA (SEQ ID NO: 2) | 6112 | 1236% | 3.23E−04 | 5.02E−04 | Study 3 |
| 3-hydroxybutyrate (BHBA) | 542 | 70% | 4.00E−04 | 1.60E−03 | Study 1 |
| myristoleate (14:1n5) | 32418 | 40% | 6.00E−04 | 2.50E−03 | Study 1 |
| 1-stearoylglycerol (1-monostearin) | 21188 | 48% | 6.00E−04 | 2.50E−03 | Study 1 |
| dihomo-linoleate (20:2n6) | 17805 | 48% | 6.00E−04 | 2.40E−03 | Study 1 |
| palmitoyl sphingomyelin | 37506 | 22% | 7.00E−04 | 2.60E−03 | Study 1 |
| adrenate (22:4n6) | 32980 | 40% | 7.00E−04 | 2.60E−03 | Study 1 |
| 1-palmitoleoylglycerophosphocholine | 33230 | 26% | 7.94E−04 | 1.94E−02 | Study 2 |
| 1-palmitoylglycerol (1-monopalmitin) | 21127 | 29% | 8.00E−04 | 2.70E−03 | Study 1 |
| 1-pentadecanoylglycerophosphocholine | 37418 | 40% | 8.00E−04 | 2.70E−03 | Study 1 |
| piperine | 33935 | −64% | 8.29E−04 | 1.94E−02 | Study 2 |
| pyruvate | 599 | 34% | 0.001 | 0.0032 | Study 1 |
| cyclo(leu-pro) | 37104 | −33% | 1.19E−03 | 2.35E−02 | Study 2 |
| linolenate [alpha or gamma; (18:3n3 | 34035 | 43% | 1.70E−03 | 4.90E−03 | Study 1 |
| or 6)] | | | | | |
| hydroquinone sulfate | 35322 | −30% | 2.20E−03 | 5.90E−03 | Study 1 |
| carnitine | 15500 | 8% | 0.0022 | 0.0059 | Study 1 |
| eicosapentaenoate (EPA; 20:5n3) | 18467 | 50% | 2.60E−03 | 6.60E−03 | Study 1 |
| butyrylcarnitine | 32412 | 24% | 2.80E−03 | 7.10E−03 | Study 1 |
| threonine | 12666 | −20% | 3.10E−03 | 1.34E−01 | Study 4 |
| 3-dehydrocarnitine | 32654 | −19% | 3.23E−03 | 4.19E−02 | Study 2 |
| 15-methylpalmitate | 38295 | 23% | 3.30E−03 | 7.80E−03 | Study 1 |
| 1,7-dimethylurate | 34400 | −23% | 3.46E−03 | 4.39E−02 | Study 2 |
| isovaleryl-, valeryl- and/or 2- | 9491 | −16% | 4.00E−03 | 5.19E−03 | Study 3 |
| methylbutytl-carnitine | | | | | |
| N-acetylornithine | 15630 | −61% | 4.20E−03 | 9.50E−03 | Study 1 |
| 3-phenylpropionate (hydrocinnamate) | 15749 | −28% | 4.81E−03 | 5.74E−02 | Study 2 |
| 4-hydroxyhippurate | 35527 | −35% | 5.40E−03 | 1.18E−02 | Study 1 |
| propionylcarnitine | 9130 | 30% | 5.90E−03 | 1.54E−01 | Study 4 |
| 5alpha-pregnan-3beta,20alpha-diol | 37198 | −82% | 6.39E−03 | 6.95E−02 | Study 2 |
| disulfate | | | | | |
| kynurenine | 15140 | 17% | 7.10E−03 | 1.48E−02 | Study 1 |
| 3-methoxytyrosine | 12017 | 44% | 7.52E−03 | 7.64E−02 | Study 2 |
| 1- | 33871 | 21% | 7.53E−03 | 7.64E−02 | Study 2 |
| eicosadienoylglycerophosphocholine | | | | | |
| 1-docosapentaenoylglycerophospho | 37231 | 24% | 9.10E−03 | 1.80E−02 | Study 1 |
| choline | | | | | |
| 1-methylxanthine | 34389 | −22% | 9.14E−03 | 8.70E−02 | Study 2 |
| 3-carboxy-4-methyl-5-propyl-2- | 31787 | −54% | 1.10E−02 | 9.72E−02 | Study 2 |
| furanpropanoate (CMPF) | | | | | |
| stearidonate (18:4n3) | 33969 | 56% | 1.11E−02 | 2.14E−02 | Study 1 |
| DSGEGDFLAEGGGVR (SEQ ID | 6208 | 776% | 1.14E−02 | 1.30E−02 | Study 3 |
| NO: 3) | | | | | |
| 2-hydroxypalmitate | 35675 | 13% | 1.22E−02 | 2.31E−02 | Study 1 |
| serine | 12663 | −15% | 1.34E−02 | 2.16E−01 | Study 4 |
| pyridoxic acid | 6486 | 241% | 1.44E−02 | 1.54E−02 | Study 3 |
| 2-stearoylglycerophosphocholine | 35255 | 26% | 1.47E−02 | 1.20E−01 | Study 2 |
| 1-oleoylglycerophosphocholine | 33960 | 14% | 1.48E−02 | 1.20E−01 | Study 2 |
| 2-palmitoylglycerophosphocholine | 35253 | 17% | 1.51E−02 | 1.21E−01 | Study 2 |
| dihomo-linolenate (20:3n3 or n6) | 35718 | 23% | 1.51E−02 | 2.79E−02 | Study 1 |
| oxalic acid | 7639 | −18% | 1.60E−02 | 1.67E−02 | Study 3 |
| nicotinamide | 594 | 17% | 1.75E−02 | 3.13E−02 | Study 1 |
| methionine | 12726 | −24% | 1.76E−02 | 2.32E−01 | Study 4 |
| 3-methylxanthine | 32445 | −41% | 1.79E−02 | 3.16E−02 | Study 1 |
| azelate | 15328 | −29% | 1.88E−02 | 2.37E−01 | Study 4 |
| fumarate | 1643 | 18% | 1.95E−02 | 1.48E−01 | Study 2 |
| thymol sulfate | 36095 | −85% | 2.00E−02 | 1.49E−01 | Study 2 |
| 7-methylxanthine | 34390 | −20% | 2.24E−02 | 1.55E−01 | Study 2 |
| lathosterol | 33488 | 26% | 2.30E−02 | 3.91E−02 | Study 1 |
| betaine | 3141 | −10% | 2.61E−02 | 4.24E−02 | Study 1 |
| glycerol 3-phosphate (G3P) | 15365 | 10% | 2.61E−02 | 4.24E−02 | Study 1 |
| 5-dodecenoate (12:1n7) | 33968 | 17% | 2.65E−02 | 4.24E−02 | Study 1 |
| pantothenate | 1508 | 30% | 0.0266 | 0.0424 | Study 1 |
| docosadienoate (22:2n6) | 32415 | 18% | 2.78E−02 | 1.77E−01 | Study 2 |
| 1-stearoylglycerophosphocholine | 33961 | 20% | 3.27E−02 | 1.96E−01 | Study 2 |
| 3-methyl-2-oxobutyrate | 21047 | 11% | 3.27E−02 | 4.97E−02 | Study 1 |
| tetradecanedioate | 35669 | 29% | 3.28E−02 | 1.96E−01 | Study 2 |
| heptanoate (7:0) | 1644 | −22% | 3.31E−02 | 4.97E−02 | Study 1 |
| N-(2-furoyl)glycine | 31536 | −79% | 3.46E−02 | 5.12E−02 | Study 1 |
| phenyllactate (PLA) | 22130 | −25% | 3.59E−02 | 5.20E−02 | Study 1 |
| bilirubin (E, Z or Z, E) | 34106 | 31% | 3.72E−02 | 2.14E−01 | Study 2 |
| glutamate | 12751 | 26% | 3.81E−02 | 3.08E−01 | Study 4 |
| hexadecanedioate | 35678 | 27% | 3.95E−02 | 5.66E−02 | Study 1 |
| 2-hydroxystearate | 17945 | 17% | 4.15E−02 | 5.88E−02 | Study 1 |
| undecanoate (11:0) | 12067 | −8% | 4.68E−02 | 2.52E−01 | Study 2 |
| glycoursodeoxycholate | 39379 | 51% | 5.10E−02 | 2.70E−01 | Study 2 |
| ethylenediaminotetraacetate | 12790 | −15% | 5.36E−02 | 3.81E−01 | Study 4 |
| 2-oleoylglycerophosphocholine | 35254 | 10% | 5.46E−02 | 7.49E−02 | Study 1 |
| acetylcarnitine | 5697 | −11% | 5.86E−02 | 4.93E−02 | Study 3 |
| laurate (12:0) | 1645 | −61% | 5.98E−02 | 2.96E−01 | Study 2 |
| 10-nonadecenoate (19:1n9) | 33972 | 25% | 6.13E−02 | 2.96E−01 | Study 2 |
| homostachydrine | 33009 | −18% | 6.17E−02 | 2.96E−01 | Study 2 |
| arachidonate (20:4n6) | 1110 | 12% | 6.22E−02 | 2.96E−01 | Study 2 |
| 4-acetominophen sulfate | 10240 | 571% | 6.37E−02 | 4.03E−01 | Study 4 |
| glutaroyl carnitine | 35439 | −9% | 6.47E−02 | 3.03E−01 | Study 2 |
| L-Norleucine | 1968 | −12% | 6.62E−02 | 5.41E−02 | Study 3 |
| uridine | 606 | −11% | 7.13E−02 | 3.24E−01 | Study 2 |
| N2,N2-dimethylguanosine | 35137 | 7% | 7.49E−02 | 3.28E−01 | Study 2 |
| succinylcarnitine | 37058 | −12% | 8.20E−02 | 3.51E−01 | Study 2 |
| 2-methylbutyroylcarnitine | 35431 | 6% | 8.31E−02 | 1.07E−01 | Study 1 |
| isovalerate | 34732 | 15% | 8.31E−02 | 3.51E−01 | Study 2 |
| alpha-hydroxyisovalerate | 33937 | −49% | 8.60E−02 | 1.08E−01 | Study 1 |
| p-acetamidophenyl-beta-D- | 11082 | −8% | 8.87E−02 | 4.46E−01 | Study 4 |
| Glucuronide | | | | | |
| gamma-glutamylglutamate | 36738 | 16% | 9.13E−02 | 3.66E−01 | Study 2 |
| phenol sulfate | 32553 | −25% | 9.59E−02 | 3.77E−01 | Study 2 |
| 2,3-dihydroxybenzoic acid | 7447 | −37% | 9.75E−02 | 7.35E−02 | Study 3 |
| gamma-glutamylphenylalanine | 13214 | −14% | 9.91E−02 | 4.70E−01 | Study 4 |
| 1,3-dihydroxyacetone | 35981 | 18% | 1.01E−01 | 3.85E−01 | Study 2 |
| 1- | 34214 | 10% | 1.03E−01 | 1.22E−01 | Study 1 |
| arachidonoylglycerophosphoinositol | | | | | |
| 2-octenoyl carnitine | 35440 | −11% | 1.04E−01 | 3.92E−01 | Study 2 |
| erythronate | 33477 | 8% | 1.05E−01 | 1.22E−01 | Study 1 |
| trans-hydroxyproline | 12673 | 26% | 1.07E−01 | 4.77E−01 | Study 4 |
| erythritol | 20699 | −355% | 1.09E−01 | 3.97E−01 | Study 2 |
| heme | 32593 | 33% | 1.11E−01 | 1.28E−01 | Study 1 |
| 1- | 35186 | 10% | 1.15E−01 | 1.31E−01 | Study 1 |
| arachidonoylglycerophosphoethanol | | | | | |
| amine | | | | | |
| 4-Guanidinobutanoic acid | 7670 | 18% | 1.16E−01 | 8.32E−02 | Study 3 |
| caproate (6:0) | 32489 | −15% | 1.21E−01 | 1.34E−01 | Study 1 |
| 1- | 32635 | −10% | 1.22E−01 | 4.15E−01 | Study 2 |
| linoleoylglycerophosphoethanolamine | | | | | |
| tyrosine | 12780 | −13% | 1.25E−01 | 4.94E−01 | Study 4 |
| glutamine | 12757 | −9% | 1.29E−01 | 4.94E−01 | Study 4 |
| cis-vaccenate (18:1n7) | 33970 | 38% | 1.34E−01 | 4.42E−01 | Study 2 |
| ethanolamine | 34285 | −25% | 1.36E−01 | 4.42E−01 | Study 2 |
| 2-hydroxyoctanoate | 22036 | −12% | 1.37E−01 | 4.42E−01 | Study 2 |
| 2-hydroxy butanoate | 12543 | 21% | 1.39E−01 | 4.94E−01 | Study 4 |
| ornithine | 16511 | 14% | 1.39E−01 | 4.94E−01 | Study 4 |
| docosapentaenoate (n6 DPA; 22:5n6) | 37478 | 26% | 1.39E−01 | 4.42E−01 | Study 2 |
| ergothioneine | 37459 | −18% | 1.44E−01 | 1.47E−01 | Study 1 |
| citrulline | 2132 | −10% | 1.44E−01 | 1.47E−01 | Study 1 |
| octadecanedioate | 36754 | 15% | 1.46E−01 | 4.46E−01 | Study 2 |
| N-acetylglycine | 27710 | 22% | 1.49E−01 | 4.53E−01 | Study 2 |
| proline | 12650 | −11% | 1.50E−01 | 4.94E−01 | Study 4 |
| DSGEGDFXAEGGGVR (SEQ ID | 31548 | 206% | 1.54E−01 | 4.63E−01 | Study 2 |
| NO: 4) | | | | | |
| phenylacetate | 15958 | 14% | 1.56E−01 | 4.66E−01 | Study 2 |
| laurylcarnitine | 34534 | −23% | 1.59E−01 | 4.68E−01 | Study 2 |
| 3-(4-hydroxyphenyl)-1-(2,4,6- | 38153 | 1495% | 1.62E−01 | 4.69E−01 | Study 2 |
| trihydroxyphenyl)-1-propanone | | | | | |
| 3-methyl-2-oxovalerate | 15676 | 7% | 1.62E−01 | 1.58E−01 | Study 1 |
| 17-methylstearate | 38296 | 13% | 1.64E−01 | 4.72E−01 | Study 2 |
| phenylacetylglutamine | 35126 | 7% | 1.67E−01 | 4.72E−01 | Study 2 |
| delta-tocopherol | 33418 | −28% | 1.67E−01 | 4.72E−01 | Study 2 |
| chiro-inositol | 37112 | 83% | 1.69E−01 | 4.74E−01 | Study 2 |
| palmitoylcarnitine | 22189 | 14% | 1.70E−01 | 4.74E−01 | Study 2 |
| dimethylglycine | 5086 | 23% | 1.71E−01 | 1.63E−01 | Study 1 |
| glycolate (hydroxyacetate) | 15737 | −5% | 1.74E−01 | 4.82E−01 | Study 2 |
| 3-methylhistidine | 15677 | −41% | 1.83E−01 | 1.69E−01 | Study 1 |
| andro steroid monosulfate 2 | 32792 | 31% | 1.83E−01 | 4.88E−01 | Study 2 |
| 1-docosahexaenoylglycerophospho | 33822 | 16% | 1.87E−01 | 1.70E−01 | Study 1 |
| choline | | | | | |
| phenylalanine | 12756 | −7% | 1.90E−01 | 5.33E−01 | Study 4 |
| 1-myristoylglycerophosphocholine | 35626 | 27% | 1.91E−01 | 1.72E−01 | Study 1 |
| 1-oleoylglycerophosphoethanolamine | 35628 | −9% | 1.91E−01 | 4.96E−01 | Study 2 |
| cis-4-decenoyl carnitine | 38178 | −19% | 1.92E−01 | 4.96E−01 | Study 2 |
| pelargonate (9:0) | 12035 | −8% | 1.93E−01 | 4.96E−01 | Study 2 |
| 3-indoxyl sulfate | 5809 | −10% | 1.98E−01 | 1.22E−01 | Study 3 |
| 3-(3-hydroxyphenyl)propionate | 35635 | −10% | 1.99E−01 | 5.04E−01 | Study 2 |
| glucuronate | 15443 | 7% | 1.99E−01 | 1.76E−01 | Study 1 |
| 2-hydroxyhippurate (salicylurate) | 18281 | 25% | 2.04E−01 | 5.10E−01 | Study 2 |
| 1- | 33228 | 6% | 2.05E−01 | 5.10E−01 | Study 2 |
| arachidonoylglycerophosphocholine | | | | | |
| 2- | 36593 | −9% | 2.06E−01 | 5.10E−01 | Study 2 |
| linoleoylglycerophosphoethanolamine | | | | | |
| 5alpha-androstan-3alpha,17beta-diol | 37184 | 5% | 2.07E−01 | 5.10E−01 | Study 2 |
| disulfate | | | | | |
| gamma-CEHC | 37462 | −10% | 2.10E−01 | 5.16E−01 | Study 2 |
| sebacate (decanedioate) | 32398 | 8% | 2.11E−01 | 5.16E−01 | Study 2 |
| cinnamoylglycine | 38637 | −10% | 2.13E−01 | 5.19E−01 | Study 2 |
| gamma-glutamyltyrosine | 2734 | −6% | 2.24E−01 | 5.38E−01 | Study 2 |
| 2- | 32815 | 12% | 2.26E−01 | 1.90E−01 | Study 1 |
| arachidonoylglycerophosphoethanol | | | | | |
| amine | | | | | |
| lysine | 16107 | 15% | 2.32E−01 | 5.80E−01 | Study 4 |
| 3-(4-hydroxyphenyl)lactate | 32197 | −15% | 2.39E−01 | 1.99E−01 | Study 1 |
| nonadecanoate (19:0) | 1356 | 10% | 2.39E−01 | 5.59E−01 | Study 2 |
| erythrose | 8677 | 7% | 2.40E−01 | 1.42E−01 | Study 3 |
| urobilinogen | 32426 | 13% | 2.41E−01 | 5.59E−01 | Study 2 |
| 1- | 33821 | 8% | 2.43E−01 | 2.00E−01 | Study 1 |
| eicosatrienoylglycerophosphocholine | | | | | |
| 3-indolepropionate | 8300 | −37% | 2.46E−01 | 5.89E−01 | Study 4 |
| carnitine-1 | 6401 | 8% | 2.48E−01 | 1.46E−01 | Study 3 |
| deoxycholate | 1114 | 35% | 2.57E−01 | 5.84E−01 | Study 2 |
| octanoate(caprylate (8:0)) | 12609 | 28% | 2.61E−01 | 5.89E−01 | Study 4 |
| stachydrine | 34384 | 48% | 2.61E−01 | 5.90E−01 | Study 2 |
| 4-acetamidobutanoate | 1558 | 5% | 2.63E−01 | 2.11E−01 | Study 1 |
| taurocholate | 18497 | −75% | 2.67E−01 | 2.11E−01 | Study 1 |
| arginine | 12659 | −8% | 2.67E−01 | 5.94E−01 | Study 4 |
| hydroxyisovaleroyl carnitine | 35433 | −11% | 2.69E−01 | 5.97E−01 | Study 2 |
| cholate | 22842 | 88% | 2.69E−01 | 5.97E−01 | Study 2 |
| gamma-glutamylmethionine | 37539 | −10% | 2.73E−01 | 2.13E−01 | Study 1 |
| cysteine-glutathione disulfide | 35159 | 8% | 2.74E−01 | 2.13E−01 | Study 1 |
| 1,6-anhydroglucose | 21049 | 27% | 2.81E−01 | 6.16E−01 | Study 2 |
| hydroxyproline form of bradykinin | 10143 | −35% | 2.82E−01 | 6.06E−01 | Study 4 |
| decanoylcarnitine | 33941 | −35% | 2.85E−01 | 6.21E−01 | Study 2 |
| saccharin | 10644 | 63% | 2.87E−01 | 6.06E−01 | Study 4 |
| gamma-tocopherol | 16518 | −18% | 2.91E−01 | 6.06E−01 | Study 4 |
| 1,5-anhydroglucitol (1,5-AG) | 20675 | 8% | 2.93E−01 | 6.28E−01 | Study 2 |
| glycocholate | 8091 | 39% | 2.95E−01 | 6.11E−01 | Study 4 |
| ribitol | 15772 | −10% | 2.96E−01 | 6.28E−01 | Study 2 |
| N-acetylserine | 37076 | 10% | 2.96E−01 | 6.28E−01 | Study 2 |
| taurochenodeoxycholate | 18494 | 21% | 2.96E−01 | 6.28E−01 | Study 2 |
| 1-methylurate | 34395 | −5% | 3.00E−01 | 6.33E−01 | Study 2 |
| 3-hydroxyoctanoate | 22001 | −14% | 3.08E−01 | 6.47E−01 | Study 2 |
| asparagine | 16665 | −9% | 3.08E−01 | 6.22E−01 | Study 4 |
| cotinine | 553 | 81% | 3.13E−01 | 6.55E−01 | Study 2 |
| gamma-glu-leu | 10438 | 6% | 3.27E−01 | 6.31E−01 | Study 4 |
| pregnen-diol disulfate | 32562 | 13% | 3.30E−01 | 6.76E−01 | Study 2 |
| glycochenodeoxycholate | 32346 | −12% | 3.40E−01 | 2.46E−01 | Study 1 |
| myo-inositol | 19934 | −6% | 3.42E−01 | 2.46E−01 | Study 1 |
| caprate (10:0) | 1642 | 9% | 3.58E−01 | 2.52E−01 | Study 1 |
| dehydroisoandrosterone sulfate | 32425 | −9% | 3.61E−01 | 7.18E−01 | Study 2 |
| (DHEA-S) | | | | | |
| 4-androsten-3beta,17beta-diol | 37202 | 7% | 3.67E−01 | 7.24E−01 | Study 2 |
| disulfate 1 | | | | | |
| 2-hydroxyglutarate | 37253 | 7% | 3.69E−01 | 7.24E−01 | Study 2 |
| indoleacetate | 27513 | −6% | 3.69E−01 | 7.24E−01 | Study 2 |
| 2-oleoylglycerophosphoethanolamine | 35687 | −6% | 3.70E−01 | 7.24E−01 | Study 2 |
| 4-ethylphenylsulfate | 36099 | −15% | 3.72E−01 | 7.24E−01 | Study 2 |
| 2-hydroxyisobutyrate | 22030 | 13% | 3.74E−01 | 7.24E−01 | Study 2 |
| sorbitol plus a 204 ion | 12753 | −27% | 3.74E−01 | 6.47E−01 | Study 4 |
| octanoylcarnitine | 33936 | −33% | 3.74E−01 | 7.24E−01 | Study 2 |
| N-acetylthreonine | 33939 | 7% | 3.82E−01 | 2.68E−01 | Study 1 |
| gamma-glutamylvaline | 32393 | 26% | 3.95E−01 | 7.45E−01 | Study 2 |
| methylglutaroylcarnitine | 37060 | 6% | 3.98E−01 | 7.46E−01 | Study 2 |
| xylonate | 35638 | 52% | 4.02E−01 | 7.49E−01 | Study 2 |
| erythro-sphingosine-1-phosphate | 34445 | 10% | 4.10E−01 | 7.58E−01 | Study 2 |
| 2-linoleoylglycerophosphocholine | 35257 | −9% | 4.31E−01 | 7.74E−01 | Study 2 |
| iminodiacetate | 16653 | −22% | 4.33E−01 | 6.71E−01 | Study 4 |
| trans-2,3,4-trimethoxycinnamic acid | 7957 | 12% | 4.34E−01 | 2.20E−01 | Study 3 |
| androsterone sulfate | 5647 | −11% | 4.35E−01 | 2.20E−01 | Study 3 |
| 2-amino butyrate | 12645 | −8% | 4.39E−01 | 6.71E−01 | Study 4 |
| hippuric acid | 6513 | −8% | 4.44E−01 | 2.23E−01 | Study 3 |
| lysine-3TMS | 16092 | −16% | 4.49E−01 | 6.71E−01 | Study 4 |
| 4-androsten-3beta,17beta-diol | 37203 | 5% | 4.50E−01 | 7.81E−01 | Study 2 |
| disulfate 2 | | | | | |
| epiandrosterone sulfate | 33973 | −9% | 4.54E−01 | 7.83E−01 | Study 2 |
| taurolithocholate 3-sulfate | 38782 | 17% | 4.65E−01 | 7.94E−01 | Study 2 |
| 5alpha-androstan-3beta,17alpha-diol | 37187 | 9% | 4.66E−01 | 2.96E−01 | Study 1 |
| disulfate | | | | | |
| glycodeoxycholate | 18477 | −32% | 4.70E−01 | 2.96E−01 | Study 1 |
| 1,2-propanediol | 38002 | 38% | 4.70E−01 | 7.98E−01 | Study 2 |
| pregnenolone sulfate | 38170 | −10% | 4.71E−01 | 2.96E−01 | Study 1 |
| p-hydroxybenzaldehyde | 7446 | 12% | 4.74E−01 | 6.78E−01 | Study 4 |
| taurodeoxycholate | 12261 | −32% | 4.78E−01 | 8.06E−01 | Study 2 |
| sucrose | 15336 | 30% | 4.79E−01 | 2.98E−01 | Study 1 |
| azelate (nonanedioate) | 18362 | 6% | 4.85E−01 | 8.06E−01 | Study 2 |
| beta-hydroxyisovalerate | 12129 | 5% | 4.88E−01 | 8.06E−01 | Study 2 |
| taurocholenate sulfate | 32807 | 7% | 4.99E−01 | 8.09E−01 | Study 2 |
| N6-acetyllysine | 36752 | −6% | 5.00E−01 | 8.09E−01 | Study 2 |
| (s)-2-hydroxybutyrate | 5711 | 15% | 5.04E−01 | 6.90E−01 | Study 4 |
| cysteine | 16071 | 6% | 5.08E−01 | 6.90E−01 | Study 4 |
| ADSGEGDFXAEGGGVR (SEQ ID | 33084 | 79% | 5.09E−01 | 8.12E−01 | Study 2 |
| NO: 5) | | | | | |
| glucose | 16655 | 10% | 5.10E−01 | 6.90E−01 | Study 4 |
| p-cresol sulfate | 6362 | 16% | 5.14E−01 | 6.91E−01 | Study 4 |
| gamma-glutamylisoleucine | 34456 | 19% | 5.15E−01 | 8.15E−01 | Study 2 |
| oxalacetate | 16650 | −14% | 5.20E−01 | 6.93E−01 | Study 4 |
| leucine | 12656 | −5% | 5.52E−01 | 7.06E−01 | Study 4 |
| methyl palmitate (15 or 2) | 38768 | 6% | 5.60E−01 | 8.45E−01 | Study 2 |
| 3-carboxy-4-Methyl-5-propyl-2 | 14837 | 20% | 5.60E−01 | 7.06E−01 | Study 4 |
| furanpropanoate | | | | | |
| pregn steroid monosulfate | 32619 | 6% | 5.62E−01 | 3.31E−01 | Study 1 |
| glycocholenate sulfate | 32599 | 7% | 5.63E−01 | 8.45E−01 | Study 2 |
| 1,5-anhydro-D-glucitol | 12739 | 10% | 5.76E−01 | 7.14E−01 | Study 4 |
| bilirubin (E,E) | 32586 | 18% | 5.76E−01 | 8.58E−01 | Study 2 |
| isobutyrylcarnitine | 33441 | −8% | 5.90E−01 | 3.39E−01 | Study 1 |
| xylose | 15835 | −11% | 6.19E−01 | 8.88E−01 | Study 2 |
| iminodiacetate (IDA) | 35837 | 12% | 6.21E−01 | 8.88E−01 | Study 2 |
| pro-leu | 13018 | 11% | 6.28E−01 | 7.31E−01 | Study 4 |
| salicyluric acid | 6493 | 35% | 6.30E−01 | 2.86E−01 | Study 3 |
| campesterol | 39511 | −5% | 6.67E−01 | 9.15E−01 | Study 2 |
| docosahexaenoate (DHA; 22:6n3) | 19323 | −5% | 6.90E−01 | 9.20E−01 | Study 2 |
| 5alpha-androstan-3beta,17beta-diol | 37190 | 16% | 7.48E−01 | 9.58E−01 | Study 2 |
| disulfate | | | | | |
| 3-hydroxydecanoate | 22053 | −10% | 7.65E−01 | 9.67E−01 | Study 2 |
| beta-tocopherol | 35702 | −6% | 7.87E−01 | 9.84E−01 | Study 2 |
| bilirubin (Z,Z) | 27716 | 10% | 7.90E−01 | 9.84E−01 | Study 2 |
| pentadecanoate (15:0) | 1361 | 6% | 8.35E−01 | 1.00E+00 | Study 2 |
| riluzole glucuronide | 10872 | 13% | 8.62E−01 | 3.47E−01 | Study 3 |
| serotonin (5HT) | 2342 | 5% | 9.55E−01 | 1.00E+00 | Study 2 |
| caprylate (8:0) | 32492 | 22% | 9.77E−01 | 1.00E+00 | Study 2 |
| N-methyl proline | 37431 | 32% | 9.98E−01 | 1.00E+00 | Study 2 |
| [H]HWESASLLR[OH] (SEQ ID | 33964 | 151% | 1.31E−01 | 4.42E−01 | Study 2 |
| NO: 6) | | | | | |
| XHWESASXXR (SEQ ID NO: 7) | 31538 | 127% | 2.95E−01 | 6.28E−01 | Study 2 |

The biomarkers were evaluated using Random Forest analysis to classify subjects into ALS or Healthy control groups. Plasma samples from 172 ALS subjects and 50 healthy control subjects not diagnosed with ALS were used in this analysis.

Random Forest results show that the samples can be classified with 77% prediction accuracy. The Confusion Matrix presented in Table 2 shows the number of samples predicted for each classification and the actual in each group (ALS or Healthy). The “Out-of-Bag” (OOB) Error rate gives an estimate of how accurately new observations can be predicted using the Random Forest model (e.g., whether a sample is from an ALS subject or a healthy control subject). The OOB error from this Random Forest was approximately 23%, and the model estimated that, when used on a new set of subjects, the identity of healthy control subjects could be predicted correctly 78% of the time and ALS subjects could be predicted 76% of the time. The results are summarized in Table 3.

TABLE 2
Results of Random Forest, Plasma: ALS vs. Healthy control

Predicted Group

| | | ALS | Healthy | class. error |
|---|---|---|---|---|
| Actual | ALS | 131 | 41 | 0.238372 |
| Group | Healthy | 11 | 39 | 0.22 |

TABLE 3
Results of Metabolomic Predictions

| | Random Forest Analysis |
|---|---|
| Overall | 77% |
| Healthy Control | 78% |
| ALS | 76% |

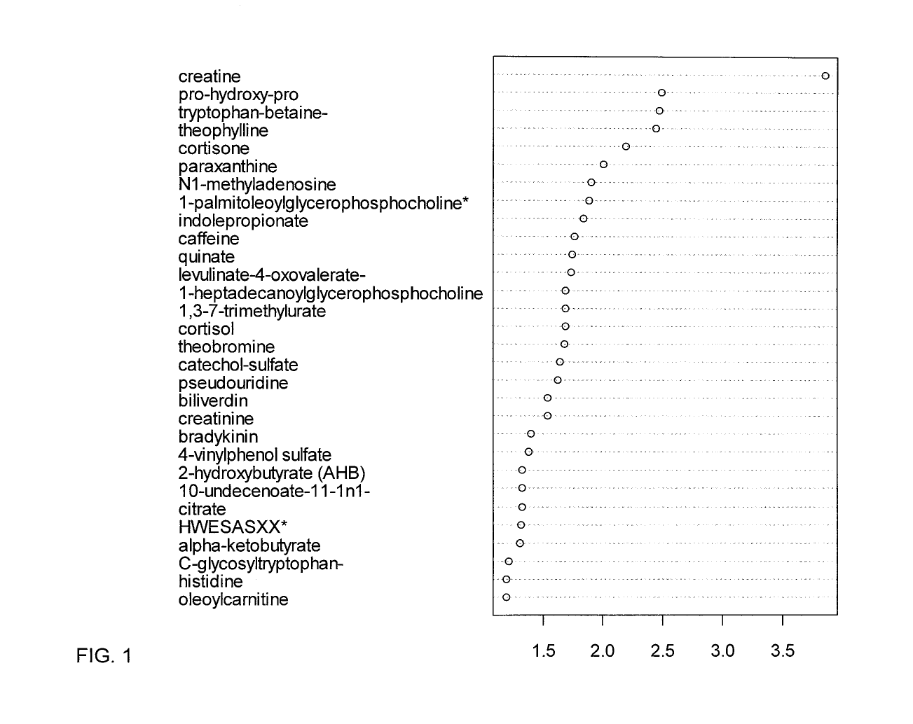

Based on the OOB Error rate of 23%, the Random Forest model that was created predicted whether a sample was from an individual with ALS with about 77% accuracy from analysis of the levels of the biomarkers in samples from the subject. Exemplary biomarkers for distinguishing the groups are creatine, pro-hydroxy-pro, tryptophan betaine, theophylline, cortisone, paraxanthine, n1-methyladenosine, 1-palmtoleoylglycerophosphocholine, indolepropionate, caffeine, quinate, levulinate-4-oxovalerate, 1-heptadecanoylglycerophosphocholine, 1,3-7-trimethlurate, cortisol, Theobromine, catechol sulfate, pseudouridine, biliverdin, creatine, bradykinin, 4-vinylphenol sulfate, 2-hydroxybutyrate, 10-undecenoante (11:1n1), citrate, HWESASXX (SEQ ID NO:1), alpha-ketobutyrate, C-glycosyltryptophan, histidine and oleoylcarnitine. The biomarkers were ranked based on their importance for the predictions and are shown in the Importance Plot in FIG. 1.

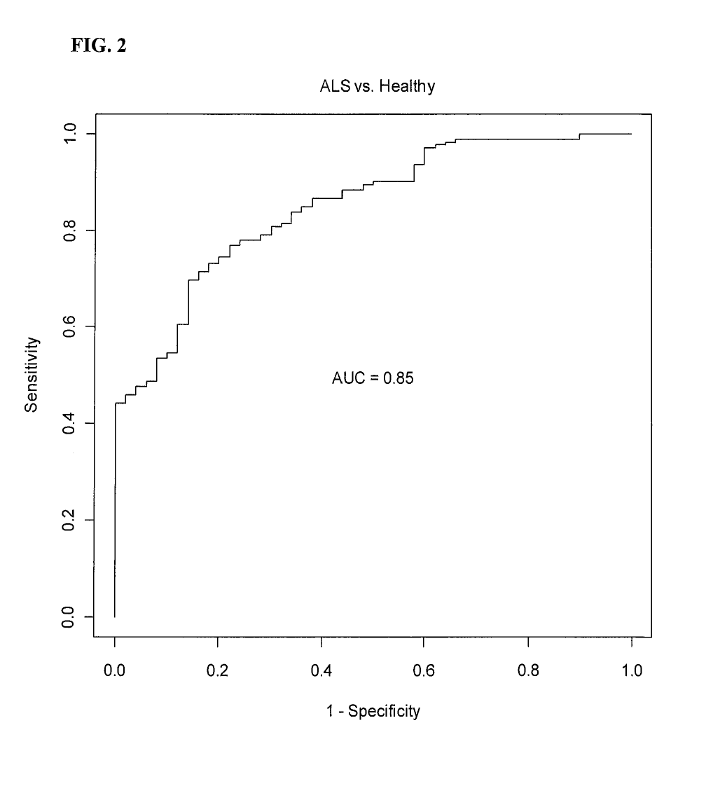

The Random Forest results demonstrated that by using the biomarkers, ALS subjects were distinguished from healthy subjects with 76% sensitivity, 78% specificity, 92% Positive Predictive Value (PPV), and 49% Negative Predictive Value (NPV). These results are summarized in Table 4. The area under the curve (AUC) for the receiver operating characteristic (ROC) curve was 0.85 and the plot is graphically presented in FIG. 2.

TABLE 4
Diagnostic parameters for ALS vs. Healthy Control classification

| | Sensitivity | Specificity | PPV | NPV | AUC |
|---|---|---|---|---|---|
| ALS vs. Healthy | 76% | 78% | 92% | 49% | 0.85 |

### Example 2

### Biomarkers for Differentiating ALS from Symptom Mimic Diseases in Plasma

Metabolomic analysis was carried out on blood plasma samples to identify biomarkers that were useful to distinguish ALS patients from patients with symptom mimic diseases, that is, neurological diseases that cause symptoms that appear clinically similar to ALS (e.g., multi-focal motor neuropathy, spinal muscular atrophy, Kennedy's disease, multiple sclerosis). The plasma samples used for the analysis were from 172 ALS subjects, and 73 symptom mimic disease subjects (subjects with diseases that cause symptoms that appear clinically similar to ALS). After the levels of metabolites were determined, the data were analyzed using T-tests to identify biomarkers that differed between the ALS patients and the symptom mimic disease patients. The biomarkers are listed in Table 5.

Table 5 includes, for each biomarker, an indication of the percentage difference in the ALS mean as compared to the symptom mimic disease mean (positive values represent an increase in ALS, and negative values represent a decrease in ALS), and the p-value and the q-value, determined in the statistical analysis of the data concerning the biomarkers. The heading “Comp ID” refers to the identifier for that biomarker in the internal chemical library database.

TABLE 5
ALS Biomarkers from blood plasma samples that
distinguish ALS from symptom mimic Diseases

| | | % | | |
|---|---|---|---|---|
| | Comp | Change | | |
| Biochemical Name | ID | in ALS | p-value | q-value |
| 4-vinylphenol sulfate | 36098 | −29% | 0.006 | 0.117 |
| iminodiacetate (IDA) | 35837 | 16% | 0.002 | 0.093 |
| delta-tocopherol | 33418 | −98% | <0.001 | 0.021 |
| palmitoyl sphingomyelin | 37506 | 11% | 0.003 | 0.103 |
| phosphate | 11438 | 11% | <0.001 | <0.001 |
| cortisone | 1769 | 14% | 0.001 | 0.057 |
| 3-methylxanthine | 32445 | −58% | <0.001 | 0.02 |
| creatine | 27718 | 22% | 0.012 | 0.141 |
| 5,6-dihydrouracil | 1559 | 27% | 0.029 | 0.249 |
| theobromine | 18392 | −43% | 0.001 | 0.061 |
| 10-undecenoate (11:1n1) | 32497 | 16% | 0.003 | 0.103 |
| octadecanedioate | 36754 | 25% | 0.025 | 0.237 |
| 7-methylxanthine | 34390 | −45% | 0.001 | 0.061 |
| 3-dehydrocarnitine | 32654 | −22% | 0.003 | 0.103 |
| urate | 1604 | −7.41% | 0.02767 | 0.2442 |
| 1,2-propanediol | 38002 | 47% | 0.255 | 0.618 |
| serine | 32315 | 11% | 0.039 | 0.281 |
| cysteine | 31453 | −10% | 0.042 | 0.293 |
| proline | 1898 | −10.00% | 0.032397 | 0.274025 |
| hexadecanedioate | 35678 | 27% | 0.004 | 0.103 |
| 2-hydroxybutyrate (AHB) | 21044 | 19% | 0.007 | 0.117 |
| alpha-ketobutyrate | 4968 | 20% | 0.005 | 0.103 |
| 1-methylurate | 34395 | −15% | 0.011 | 0.141 |
| pyroglutamine | 32672 | −25% | 0.019 | 0.19 |
| dodecanedioate | 32388 | 8% | 0.069 | 0.355 |
| cholesterol | 63 | 5% | 0.086 | 0.398 |
| paraxanthine | 18254 | −17.36% | 0.014531 | 0.166972 |
| pro-hydroxy-pro | 35127 | 11% | 0.118 | 0.431 |
| creatinine | 513 | −9.09% | 0.019427 | 0.190417 |
| 1-stearoylglycerophosphoinositol | 19324 | 14% | 0.009 | 0.132 |
| arachidonate (20:4n6) | 1110 | 18% | 0.002 | 0.078 |
| glutamine | 53 | −2% | 0.4971 | 0.8261 |
| 2-arachidonoylglycerophosphoethanolamine | 32815 | 18% | 0.003 | 0.103 |
| erythronate | 33477 | −17% | 0.005 | 0.103 |
| glycocholenate sulfate | 32599 | 20% | 0.005 | 0.103 |
| pregnen-diol disulfate | 32562 | 27% | 0.006 | 0.117 |
| 1-arachidonoylglycerophosphoinositol | 34214 | 12% | 0.007 | 0.124 |
| eicosenoate (20:1n9 or 11) | 33587 | 28% | 0.008 | 0.125 |
| theophylline | 18394 | −30% | 0.009 | 0.132 |
| sarcosine (N-Methylglycine) | 1516 | 30% | 0.009 | 0.132 |
| caprylate (8:0) | 32492 | 47% | 0.009 | 0.132 |
| 2-hydroxystearate | 17945 | 9% | 0.01 | 0.132 |
| caprate (10:0) | 1642 | 25% | 0.01 | 0.133 |
| 10-nonadecenoate (19:1n9) | 33972 | 19% | 0.011 | 0.137 |
| dihomo-linolenate (20:3n3 or n6) | 35718 | 14% | 0.012 | 0.141 |
| adrenate (22:4n6) | 32980 | 15% | 0.015 | 0.17 |
| 13-HODE + 9-HODE | 37752 | 15% | 0.016 | 0.171 |
| oleate (18:1n9) | 1359 | 22% | 0.018 | 0.19 |
| 2-hydroxypalmitate | 35675 | 6% | 0.019 | 0.19 |
| 3-methoxytyrosine | 12017 | 35% | 0.019 | 0.19 |
| 1,7-dimethylurate | 34400 | −20% | 0.02 | 0.19 |
| cis-vaccenate (18:1n7) | 33970 | 15% | 0.025 | 0.234 |
| indolelactate | 18349 | −16% | 0.026 | 0.241 |
| hippurate | 15753 | −33% | 0.027 | 0.244 |
| deoxycarnitine | 36747 | −10% | 0.027 | 0.244 |
| catechol sulfate | 35320 | −30% | 0.032 | 0.271 |
| isobutyrylcarnitine | 33441 | −14% | 0.033 | 0.275 |
| carnitine | 15500 | 4% | 0.034 | 0.275 |
| dihomo-linoleate (20:2n6) | 17805 | 20% | 0.034 | 0.275 |
| threitol | 35854 | −18% | 0.035 | 0.277 |
| butyrylcarnitine | 32412 | −19% | 0.036 | 0.277 |
| 1-stearoylglycerophosphocholine | 33961 | 18% | 0.037 | 0.277 |
| mannitol | 15335 | −136% | 0.039 | 0.281 |
| fumarate | 1643 | 6% | 0.039 | 0.281 |
| 1-arachidonoylglycerophosphoethanolamine | 35186 | 10% | 0.039 | 0.281 |
| nonadecanoate (19:0) | 1356 | 11% | 0.043 | 0.294 |
| methylphosphate | 37070 | 6% | 0.046 | 0.309 |
| docosadienoate (22:2n6) | 32415 | 15% | 0.047 | 0.309 |
| tetradecanedioate | 35669 | 15% | 0.047 | 0.309 |
| cortisol | 1712 | 8% | 0.053 | 0.33 |
| [H]HWESASLLR[OH] (SEQ ID NO: 6) | 33964 | 233% | 0.053 | 0.33 |
| linolenate [alpha or gamma; (18:3n3 or 6)] | 34035 | 14% | 0.056 | 0.335 |
| 4-androsten-3beta,17beta-diol disulfate 2 | 37203 | 15% | 0.056 | 0.335 |
| xylitol | 4966 | −14% | 0.057 | 0.335 |
| 1,3,7-trimethylurate | 34404 | −20% | 0.058 | 0.335 |
| stearoyl sphingomyelin | 19503 | 10% | 0.058 | 0.335 |
| taurocholenate sulfate | 32807 | 15% | 0.058 | 0.335 |
| dimethylglycine | 5086 | 10% | 0.06 | 0.335 |
| docosapentaenoate (n3 DPA; 22:5n3) | 32504 | 19% | 0.062 | 0.338 |
| linoleate (18:2n6) | 1105 | 10% | 0.066 | 0.355 |
| saccharin | 21151 | −75% | 0.067 | 0.355 |
| 3-carboxy-4-methyl-5-propyl-2-furanpropanoate | 31787 | −95% | 0.069 | 0.355 |
| (CMPF) | | | | |
| propionylcarnitine | 32452 | −6% | 0.07 | 0.355 |
| asparagine | 34283 | −8% | 0.072 | 0.363 |
| margarate (17:0) | 1121 | 11% | 0.073 | 0.363 |
| 3-(3-hydroxyphenyl)propionate | 35635 | −30% | 0.078 | 0.382 |
| 2-oleoylglycerophosphocholine | 35254 | 9% | 0.079 | 0.384 |
| palmitate (16:0) | 1336 | 8% | 0.081 | 0.386 |
| 10-heptadecenoate (17:1n7) | 33971 | 10% | 0.082 | 0.388 |
| glycerol | 15122 | 9% | 0.083 | 0.393 |
| bilirubin (E,Z or Z,E) | 34106 | 15% | 0.089 | 0.402 |
| 3-hydroxybutyrate (BHBA) | 542 | 27% | 0.089 | 0.402 |
| 2-hydroxyhippurate (salicylurate) | 18281 | −62% | 0.093 | 0.404 |
| indolepropionate | 32405 | −15% | 0.093 | 0.404 |
| mannose | 584 | 10% | 0.093 | 0.404 |
| 1-arachidonoylglycerophosphocholine | 33228 | 8% | 0.095 | 0.404 |
| phenylacetylglutamine | 35126 | −22% | 0.097 | 0.404 |
| 3-methylhistidine | 15677 | −30% | 0.098 | 0.404 |
| 17-methylstearate | 38296 | 10% | 0.099 | 0.405 |
| caproate (6:0) | 32489 | 5% | 0.103 | 0.417 |
| arabinose | 575 | 16% | 0.106 | 0.423 |
| isovalerylcarnitine | 34407 | −8% | 0.11 | 0.423 |
| 2-palmitoylglycerophosphocholine | 35253 | 9% | 0.111 | 0.423 |
| trans-4-hydroxyproline | 32319 | −14% | 0.115 | 0.43 |
| hydroxyisovaleroyl carnitine | 35433 | −12% | 0.116 | 0.43 |
| 1-oleoylglycerophosphocholine | 33960 | 6% | 0.124 | 0.44 |
| XHWESASXXR (SEQ ID NO: 7) | 31538 | 138% | 0.128 | 0.444 |
| erythritol | 20699 | −207% | 0.135 | 0.456 |
| pregn steroid monosulfate | 32619 | 10% | 0.135 | 0.456 |
| stearate (18:0) | 1358 | 6% | 0.138 | 0.456 |
| glycoursodeoxycholate | 39379 | 8% | 0.141 | 0.456 |
| hexanoylcarnitine | 32328 | 8% | 0.144 | 0.462 |
| 1-eicosadienoylglycerophosphocholine | 33871 | 10% | 0.149 | 0.471 |
| cotinine | 553 | 92% | 0.155 | 0.48 |
| 2-stearoylglycerophosphocholine | 35255 | 14% | 0.16 | 0.494 |
| biliverdin | 2137 | 9% | 0.163 | 0.497 |
| tryptophan betaine | 37097 | −18% | 0.173 | 0.513 |
| xylonate | 35638 | 14% | 0.173 | 0.513 |
| 2-hydroxyoctanoate | 22036 | −7% | 0.175 | 0.514 |
| gamma-glutamylalanine | 37063 | −6% | 0.185 | 0.53 |
| taurolithocholate 3-sulfate | 38782 | 12% | 0.19 | 0.535 |
| phenyllactate (PLA) | 22130 | −15% | 0.192 | 0.535 |
| N6-acetyllysine | 36752 | −8% | 0.193 | 0.535 |
| glutaroyl carnitine | 35439 | −8% | 0.194 | 0.535 |
| 2-aminobutyrate | 32348 | 6% | 0.195 | 0.535 |
| myristate (14:0) | 1365 | 6% | 0.198 | 0.537 |
| 1-oleoylglycerophosphoethanolamine | 35628 | 11% | 0.199 | 0.537 |
| arabitol | 15964 | −7% | 0.211 | 0.553 |
| 1-palmitoylplasmenylethanolamine | 39270 | 11% | 0.215 | 0.563 |
| bilirubin (E,E) | 32586 | 14% | 0.218 | 0.564 |
| gamma-glutamylvaline | 32393 | 28% | 0.219 | 0.564 |
| pentadecanoate (15:0) | 1361 | 12% | 0.235 | 0.592 |
| isovalerate | 34732 | 6% | 0.242 | 0.598 |
| glycerol 3-phosphate (G3P) | 15365 | 6% | 0.243 | 0.598 |
| succinylcarnitine | 37058 | −8% | 0.245 | 0.598 |
| sebacate (decanedioate) | 32398 | 8% | 0.257 | 0.621 |
| andro steroid monosulfate 2 | 32792 | 11% | 0.263 | 0.621 |
| HWESASXX (SEQ ID NO: 1) | 32836 | 22% | 0.263 | 0.621 |
| 2-methylbutyroylcarnitine | 35431 | −7% | 0.267 | 0.621 |
| 1-heptadecanoylglycerophosphocholine | 33957 | 12% | 0.267 | 0.621 |
| gamma-CEHC | 37462 | −10% | 0.27 | 0.624 |
| 1-methylxanthine | 34389 | −16% | 0.276 | 0.63 |
| 1,3-dihydroxyacetone | 35981 | 5% | 0.281 | 0.632 |
| 3-hydroxyisobutyrate | 1549 | −7% | 0.283 | 0.632 |
| glycolithocholate sulfate | 32620 | 11% | 0.283 | 0.632 |
| 3-indoxyl sulfate | 27672 | −14% | 0.287 | 0.634 |
| N-(2-furoyl)glycine | 31536 | −22% | 0.293 | 0.643 |
| stearidonate (18:4n3) | 33969 | 10% | 0.293 | 0.643 |
| tiglyl carnitine | 35428 | −7% | 0.306 | 0.66 |
| xylose | 15835 | −17% | 0.311 | 0.668 |
| lactate | 527 | −5% | 0.317 | 0.674 |
| 1-palmitoleoylglycerophosphocholine | 33230 | 5% | 0.319 | 0.675 |
| fructose | 31266 | −31% | 0.322 | 0.675 |
| 21-hydroxypregnenolone disulfate | 37173 | 5% | 0.324 | 0.675 |
| 4-hydroxyphenylacetate | 541 | −13% | 0.338 | 0.693 |
| docosapentaenoate (n6 DPA; 22:5n6) | 37478 | 11% | 0.344 | 0.697 |
| 3-(cystein-S-yl)acetaminophen | 34365 | −37% | 0.351 | 0.699 |
| urobilinogen | 32426 | −25% | 0.359 | 0.71 |
| 4-ethylphenylsulfate | 36099 | 32% | 0.366 | 0.72 |
| 2-oleoylglycerophosphoethanolamine | 35687 | 10% | 0.371 | 0.72 |
| N-acetylglycine | 27710 | 10% | 0.372 | 0.72 |
| bradykinin, des-arg(9) | 34420 | 150% | 0.389 | 0.743 |
| taurodeoxycholate | 12261 | −25% | 0.394 | 0.747 |
| DSGEGDFXAEGGGVR (SEQ ID NO: 4) | 31548 | 33% | 0.398 | 0.75 |
| oleoylcarnitine | 35160 | 8% | 0.405 | 0.755 |
| erythrulose | 37427 | 10% | 0.405 | 0.755 |
| bradykinin, hydroxy-pro(3) | 33962 | 117% | 0.406 | 0.755 |
| lathosterol | 33488 | 14% | 0.434 | 0.775 |
| 2-hydroxyglutarate | 37253 | 10% | 0.454 | 0.793 |
| N-methyl proline | 37431 | −8% | 0.456 | 0.794 |
| indoleacetate | 27513 | −16% | 0.472 | 0.805 |
| alpha-tocopherol | 1561 | 5% | 0.498 | 0.826 |
| gamma-tocopherol | 33420 | −17% | 0.499 | 0.826 |
| 3-hydroxyoctanoate | 22001 | −5% | 0.514 | 0.84 |
| 1-pentadecanoylglycerophosphocholine | 37418 | 5% | 0.522 | 0.84 |
| heme | 32593 | −5% | 0.531 | 0.848 |
| erythro-sphingosine-1-phosphate | 34445 | −6% | 0.541 | 0.854 |
| bradykinin | 22154 | 194% | 0.541 | 0.854 |
| campesterol | 39511 | 11% | 0.547 | 0.856 |
| 5alpha-pregnan-3beta,20alpha-diol disulfate | 37198 | −26% | 0.562 | 0.866 |
| pipecolate | 1444 | −13% | 0.577 | 0.874 |
| bilirubin (Z,Z) | 27716 | −10% | 0.585 | 0.874 |
| quinate | 18335 | −22% | 0.596 | 0.882 |
| 2-hydroxyisobutyrate | 22030 | 8% | 0.602 | 0.885 |
| 4-hydroxyhippurate | 35527 | 15% | 0.604 | 0.886 |
| thymol sulfate | 36095 | −17% | 0.611 | 0.89 |
| glucuronate | 15443 | 8% | 0.642 | 0.917 |
| laurylcarnitine | 34534 | −6% | 0.646 | 0.917 |
| gamma-glutamylleucine | 18369 | 14% | 0.646 | 0.917 |
| 1,5-anhydroglucitol (1,5-AG) | 20675 | 6% | 0.661 | 0.93 |
| N-acetylornithine | 15630 | −11% | 0.663 | 0.93 |
| p-cresol sulfate | 36103 | −26% | 0.671 | 0.933 |
| glycine | 32338 | 6% | 0.68 | 0.935 |
| pyridoxate | 31555 | −62% | 0.684 | 0.938 |
| acetoacetate | 33963 | 9% | 0.693 | 0.94 |
| cholate | 22842 | 14% | 0.708 | 0.946 |
| methyl palmitate (15 or 2) | 38768 | 5% | 0.711 | 0.948 |
| gamma-glutamylmethionine | 37539 | 5% | 0.741 | 0.959 |
| cyclo(leu-pro) | 37104 | 8% | 0.741 | 0.959 |
| 3-(4-hydroxyphenyl)-1-(2,4,6-trihydroxyphenyl)- | 38153 | 456% | 0.756 | 0.959 |
| 1-propanone | | | | |
| decanoylcarnitine | 33941 | −8% | 0.761 | 0.959 |
| deoxycholate | 1114 | 8% | 0.821 | 0.986 |
| 1,6-anhydroglucose | 21049 | 9% | 0.834 | 0.996 |
| alpha-ketoglutarate | 33453 | 6% | 0.841 | 0.998 |
| octanoylcarnitine | 33936 | −9% | 0.855 | 1 |
| methylglutaroylcarnitine | 37060 | −6% | 0.862 | 1 |
| phenol sulfate | 32553 | 9% | 0.889 | 1 |
| gamma-glutamylisoleucine | 34456 | 19% | 0.9 | 1 |
| tartarate | 15336 | 25% | 0.909 | 1 |
| laurate (12:0) | 1645 | −8% | 0.949 | 1 |
| glycodeoxycholate | 18477 | −22% | 0.965 | 1 |
| oxalate (ethanedioate) | 20694 | −6% | 0.969 | 1 |
| glycocholate | 18476 | −30% | 0.974 | 1 |

In further statistical analysis, Random Forest analysis was used to classify samples into ALS or symptom mimic Disease groups. The Random Forest results show that the samples were classified with 63% prediction accuracy. The confusion matrix presented in Table 6 shows the number of samples predicted for each classification and the actual in each group (ALS or symptom mimic Diseases). The “Out-of-Bag” (OOB) Error rate gives an estimate of how accurately new observations can be predicted using the Random Forest model (e.g., whether a sample is from an ALS patient or a symptom mimic disease patient). The OOB error was approximately 37%, and the model estimated that, when used on a new set of subjects, the identity of symptom mimic disease subjects could be predicted correctly 66% of the time and ALS subjects could be predicted 62% of the time as presented in Table 7.

TABLE 6
Results of Random Forest, Plasma:
ALS vs. symptom mimic Diseases

Predicted Group

| | | ALS | Mimic | class. error |
|---|---|---|---|---|
| Actual | ALS | 107 | 65 | 0.377907 |
| Group | Mimic | 25 | 48 | 0.342466 |

TABLE 7
Results of metabolomic predictions, Plasma:
ALS vs. symptom mimic Diseases

| | Random Forest Analysis |
|---|---|
| Overall | 63% |
| Symptom mimic diseases | 66% |
| ALS | 62% |

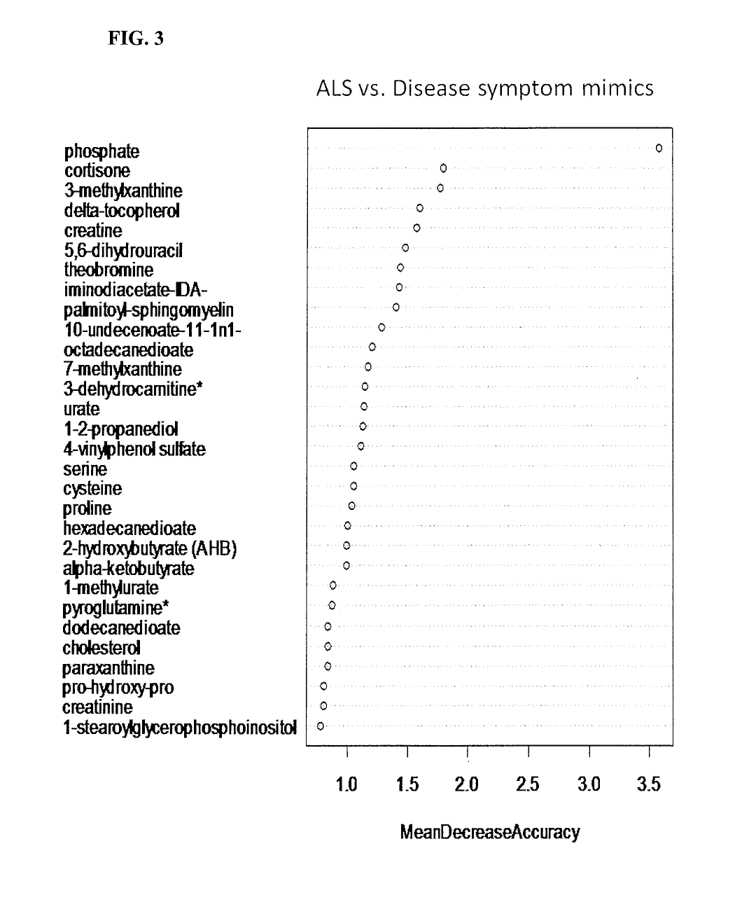

Based on the OOB Error rate of 37%, the Random Forest model that was created predicted whether a sample was from an individual with ALS with about 63% accuracy by measuring the levels of the biomarkers in samples from the subject. Examplary biomarkers for distinguishing the groups are phosphate, cortisone, 3-mthylxanthine, delta-tocopherol, creatine, 5,6-dihydrouracil, theobromine, iminodiacetate (IDA), palmitoyl-sphingomyelin, 10-undecenoate (11:1n1), octadecanedioate,7-methylxanthine, 3-dehydrocarnitine, urate, 1-2-propanediol, 4-vinylphenol sulfate, serine, cysteine, proline, hexadecanedioate, 2-hydroxybutyrate, alpha-ketobutyrate, 1-methylurate, pyroglutamine, dodecanedioate, cholesterol, paraxanthine, pro-hydroxy-pro, creatinine, 1-stearoylglycerophosphoinositol. These biomarkers were ranked based on their importance for the predictions and are shown in Table 9 below and in the Importance Plot in FIG. 3.

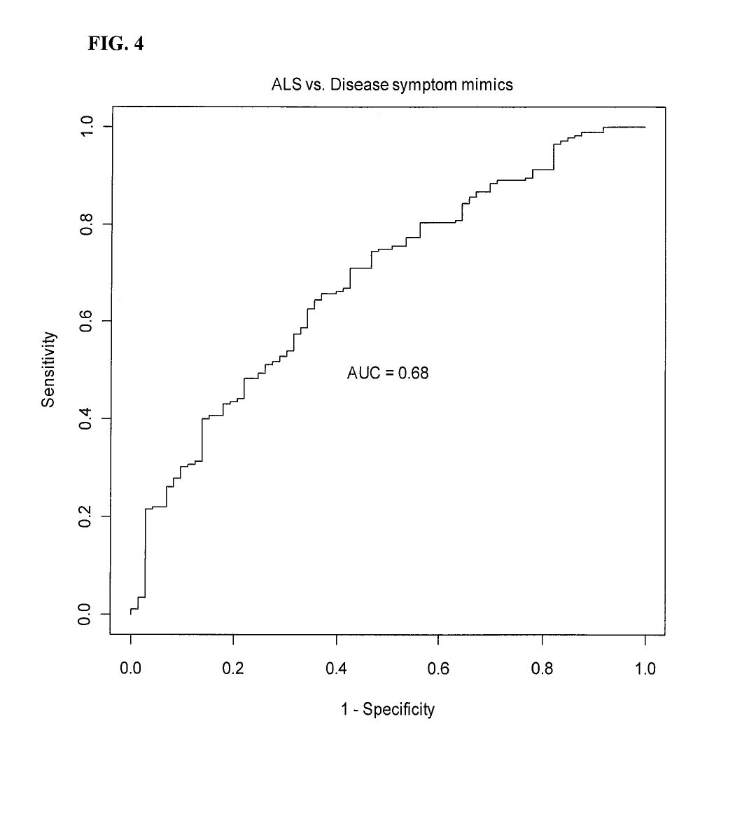

The Random Forest results demonstrated that by using the biomarkers, ALS subjects were distinguished from symptom mimic disease subjects with 62% sensitivity, 66% specificity, 81% PPV, 42% NPV. The results are summarized in Table 8. The area under the curve (AUC) for the receiver operating characteristic (ROC) curve was 0.68 and is graphically illustrated in FIG. 4.

TABLE 8
Random Forest diagnostic parameters for
ALS vs. symptom mimic Diseases (plasma)

| | Sensitivity | Specificity | PPV | NPV | AUC |
|---|---|---|---|---|---|
| ALS vs. Symp. | 62% | 66% | 81% | 42% | 0.68 |
| Mimic Diseases | | | | | |

Wilcoxon analysis was used as another statistical method to identify biomarkers that distinguish ALS subjects from symptom mimic disease subjects. Biomarkers with a false discovery rate (FDR) of less than 0.15 by Wilcoxon were identified and are shown in Table 9 below. Also in Table 9 are 30 exemplary biomarkers for distinguishing ALS subjects from symptom mimic disease subjects by Random Forest. Table 9 includes, for each biomarker, the direction of change in ALS patients relative to symptom mimic disease patients and the test used to identify the biomarker. The heading “Comp ID” refers to the identifier for that biomarker in the internal chemical library database.

TABLE 9
Biomarkers that distinguish ALS subjects
from symptom mimic disease subjects.

| | Direction | | |
|---|---|---|---|
| Biochemical | of change | | |
| Name | in ALS | Test | CompID |
| iminodiacetate (IDA) | Higher | RF, Wilcoxon | 35837 |
| 10-undecenoate (11:1n1) | Higher | RF, Wilcoxon | 32497 |
| 3-dehydrocarnitine | Lower | RF, Wilcoxon | 32654 |
| 4-vinylphenol sulfate | Lower | RF, Wilcoxon | 36098 |
| phosphate | Higher | RF, Wilcoxon | 11438 |
| cortisone | Higher | RF, Wilcoxon | 1769 |
| creatine | Higher | RF, Wilcoxon | 27718 |
| theobromine | Lower | RF, Wilcoxon | 18392 |
| palmitoyl sphingomyelin | Higher | RF, Wilcoxon | 37506 |
| serine | Higher | RF, Wilcoxon | 32315 |
| hexadecanedioate (C16) | Higher | RF, Wilcoxon | 35678 |
| 2-hydroxybutyrate (AHB) | Higher | RF, Wilcoxon | 21044 |
| pyroglutamine | Lower | RF, Wilcoxon | 32672 |
| 3-methylxanthine | Lower | RF | 32445 |
| delta-tocopherol | Lower | RF | 33418 |
| 5,6-dihydrouracil | Higher | RF | 1559 |
| octadecanedioate (C18) | Higher | RF | 36754 |
| 7-methylxanthine | Lower | RF | 34390 |
| urate | Lower | RF | 1604 |
| 1,2-propanediol | Higher | RF | 38002 |
| cysteine | Lower | RF | 16071 |
| proline | Lower | RF | 12650 |
| alpha-ketobutyrate | Higher | RF | 4968 |
| 1-methylurate | Lower | RF | 34395 |
| dodecanedioate (C12) | Higher | RF | 32388 |
| cholesterol | Higher | RF | 63 |
| paraxanthine | Lower | RF | 18254 |
| prolylhydroxyproline | Higher | RF | 35127 |
| creatinine | Lower | RF | 513 |
| 1-stearoyl-GPI (18:0) | Higher | RF | 19324 |
| arachidonate (20:4n6) | Higher | Wilcoxon | 1110 |
| glutamine | Lower | Wilcoxon | 53 |

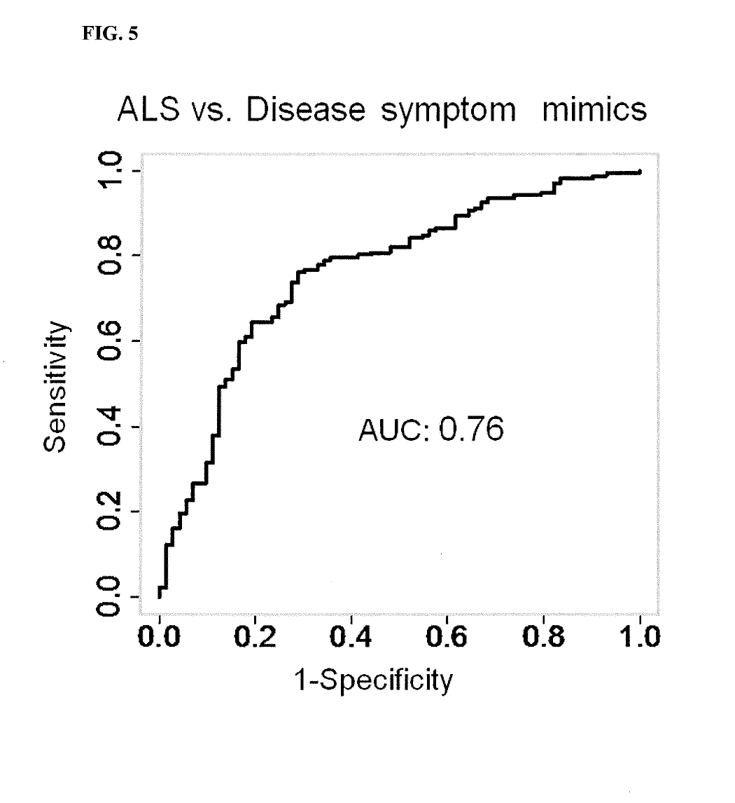

In further statistical analysis, a LASSO prediction model was used to classify samples into ALS or symptom mimic Disease groups. The LASSO prediction model predicted whether a sample was from an individual with ALS with a sensitivity of 65% and a specificity of 81% from analysis of the levels of the biomarkers in samples from the subject. The results are summarized in Table 10. The area under the curve (AUC) for the receiver operating characteristic (ROC) curve was 0.76 and is graphically illustrated in FIG. 5.

TABLE 10
LASSO diagnostic parameters for ALS
vs. symptom mimic Diseases (plasma)

| | AUC | Sensitivity | Specificity |
|---|---|---|---|
| ALS vs. | 0.76 | 0.65 | 0.81 |
| Symptom mimic | | | |
| Diseases | | | |

### Example 3

### Predictive Performance of a Panel of Biomarkers to Distinguish ALS Subjects from Symptom Mimic Disease Subjects

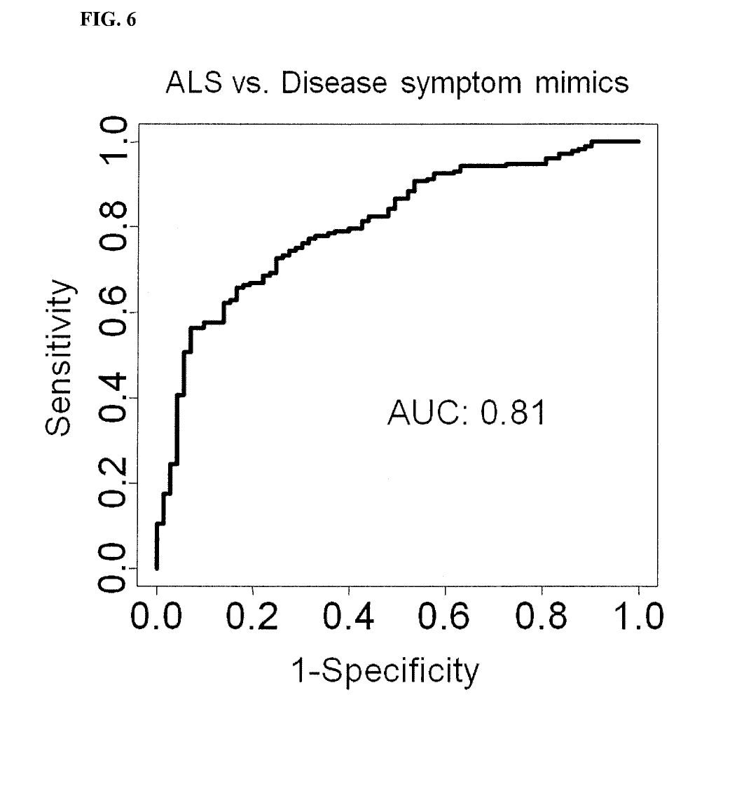

In one example, the biomarkers identified in Table 9 that distinguish ALS patients from symptom mimic disease subjects were statistically analyzed using a LASSO prediction model to estimate their predictive performance to classify a subject as having ALS or having a disease with symptoms that mimic ALS. The resulting model estimated that, if used on a new set of subjects, the biomarkers identified in Table 9 could predict the identity of ALS subjects with a specificity of 90% and a sensitivity of 58%. The area under the curve (AUC) for the receiver operating characteristic (ROC) curve was 0.81 and is graphically illustrated in FIG. 6.

To further demonstrate the effectiveness of the biomarkers in Table 9 to distinguish ALS patients from symptom mimic disease subjects, we constructed a scenario using the null hypothesis (i.e., random permutations). We compared the predictive performance of the random permutations to that using the biomarkers in Table 9. A random permutation was performed 1000 times to construct the null hypothesis. For each random permutation, the top 32 metabolites that distinguished ALS from symptom mimic disease subjects were selected, and the LOO permuted AUC was computed. Less than 0.1% of the 1000 AUCs from the null hypothesis were as good as the AUC of 0.81 obtained using the 32 biomarkers identified in Table 9 for separating ALS from symptom mimic disease subjects.

### Example 4

### ALS Biomarkers that Distinguish ALS from Non-ALS Motor Neuron Disease (Non-ALS MND) in Plasma

In another example, biomarkers were discovered by (1) analyzing plasma samples from different groups of human subjects to determine the levels of metabolites in the samples and then (2) statistically analyzing the results to determine those metabolites that are differentially present in the two groups.

Metabolomic analysis was carried out on blood plasma samples to identify biomarkers that were useful to distinguish ALS patients from patients with non-ALS motor neuron disease (non-ALS MND) (i.e., patients diagnosed with either pure upper motor neuron disease (UMD) or pure lower motor neuron disease (LMD)). The plasma samples used for the analysis were from 172 patients with ALS and 28 patients with non-ALS MND. After the levels of metabolites were determined, the data were analyzed using univariate T-tests (i.e., Welch's T-test) as described in the General Methods section (Table 11).

### Biomarkers

As listed below in Table 11, biomarkers were discovered that were differentially present between samples from ALS patients and non-ALS MND patients.

Table 11 includes, for each biomarker, an indication of the percentage difference in the ALS mean as compared to the non-ALS MND mean (positive values represent an increase in ALS, and negative values represent a decrease in ALS) and the p-value and the q-value, determined in the statistical analysis of the data concerning the biomarkers. CompID refers to the identifier for that biomarker in the internal chemical library database.

TABLE 11
ALS Biomarkers from plasma samples that distinguish ALS from non-ALS MND.

| | | ALS/MND | | |
|---|---|---|---|---|
| | | % | | |
| | | Change | | |
| BIOCHEMICAL NAME | CompID | in ALS | p-value | q-value |
| tryptophan betaine | 37097 | −40% | 0.035 | 0.6655 |
| bilirubin (Z,Z) | 27716 | −80% | 0.0018 | 0.2133 |
| 2-aminobutyrate | 32348 | −23% | 0.0036 | 0.3161 |
| 3-carboxy-4-methyl-5-propyl-2-furanpropanoate | 31787 | −53% | 0.0046 | 0.3498 |
| (CMPF) | | | | |
| 3-hydroxyisobutyrate | 1549 | −29% | 0.0103 | 0.5144 |
| cysteine | 31453 | −18% | 0.0108 | 0.5144 |
| bradykinin | 22154 | 285% | 0.0153 | 0.5172 |
| isovalerylcarnitine | 34407 | −30% | 0.0176 | 0.5627 |
| cystine | 31454 | −16% | 0.02 | 0.5627 |
| methylglutaroylcarnitine | 37060 | 54% | 0.0208 | 0.5627 |
| alpha-hydroxyisovalerate | 33937 | −149% | 0.0209 | 0.5627 |
| glutaroyl carnitine | 35439 | −18% | 0.0305 | 0.6642 |
| urate | 1604 | −11% | 0.0346 | 0.6655 |
| caproate (6:0) | 32489 | 11% | 0.0416 | 0.6778 |
| glutamine | 53 | −7% | 0.0462 | 0.6778 |
| histidine | 59 | −7% | 0.0488 | 0.6778 |
| 3-(4-hydroxyphenyl)lactate | 32197 | −19% | 0.0573 | 0.6778 |
| pyroglutamine | 32672 | −16% | 0.076 | 0.7231 |
| asparagine | 34283 | −14% | 0.0892 | 0.7442 |
| acetoacetate | 33963 | −16% | 0.1125 | 0.7794 |
| 2-palmitoylglycerophosphocholine | 35253 | 16% | 0.166 | 0.7815 |
| gamma-glutamylphenylalanine | 33422 | −7% | 0.1789 | 0.7815 |
| glycerate | 1572 | 16% | 0.1837 | 0.7815 |
| 5alpha-androstan-3alpha,17beta-diol disulfate | 37184 | 5% | 0.1898 | 0.7919 |
| arachidonate (20:4n6) | 1110 | 5% | 0.2598 | 0.8782 |
| gamma-glutamylvaline | 32393 | 30% | 0.3009 | 0.8924 |
| gamma-glutamylalanine | 37063 | 11% | 0.3523 | 0.9008 |
| gamma-glutamylisoleucine | 34456 | 22% | 0.4139 | 0.9285 |
| erythronate | 33477 | 6% | 0.6173 | 0.9894 |
| gamma-glutamyltyrosine | 2734 | −3% | 0.8022 | 1 |
| gamma-glutamylleucine | 18369 | 4% | 0.8336 | 1 |
| C-glycosyltryptophan | 32675 | 1% | 0.8932 | 1 |
| 13-HODE + 9-HODE | 37752 | 1% | 0.9357 | 1 |
| gamma-glutamylmethionine | 37539 | 2% | 0.9877 | 1 |
| glutamate | 32322 | 18% | 0.4223 | 0.9285 |
| pipecolate | 1444 | −97% | 0.1122 | 0.7794 |
| N-methyl proline | 37431 | −65% | 0.5104 | 0.9431 |
| chiro-inositol | 37112 | −64% | 0.1455 | 0.7794 |
| xylitol | 4966 | −54% | 0.9431 | 1 |
| 2-hydroxyisobutyrate | 22030 | −51% | 0.2421 | 0.8489 |
| mannitol | 15335 | −37% | 0.224 | 0.8213 |
| 5alpha-androstan-3beta,17beta-diol disulfate | 37190 | −35% | 0.0478 | 0.6778 |
| octanoylcarnitine | 33936 | −35% | 0.2178 | 0.8118 |
| 7-alpha-hydroxy-3-oxo-4-cholestenoate (7- | 36776 | −29% | 0.2136 | 0.8118 |
| Hoca) | | | | |
| decanoylcarnitine | 33941 | −29% | 0.2672 | 0.8782 |
| stearidonate (18:4n3) | 33969 | −27% | 0.0626 | 0.6778 |
| 2-hydroxybutyrate (AHB) | 21044 | −27% | 0.107 | 0.7794 |
| 4-androsten-3beta,17beta-diol disulfate 1 | 37202 | −27% | 0.1398 | 0.7794 |
| saccharin | 21151 | −27% | 0.7113 | 1 |
| cholate | 22842 | −26% | 0.0602 | 0.6778 |
| campesterol | 39511 | −26% | 0.0886 | 0.7442 |
| alpha-ketobutyrate | 4968 | −26% | 0.1511 | 0.7815 |
| glycocholenate sulfate | 32599 | −25% | 0.2038 | 0.8058 |
| ribitol | 15772 | −25% | 0.3369 | 0.9008 |
| 3-methylhistidine | 15677 | −25% | 0.8734 | 1 |
| gamma-CEHC | 37462 | −23% | 0.1489 | 0.7815 |
| androsterone sulfate | 31591 | −23% | 0.3022 | 0.8924 |
| tartarate | 15336 | −23% | 0.8689 | 1 |
| beta-hydroxyisovalerate | 12129 | −21% | 0.0331 | 0.6655 |
| docosadienoate (22:2n6) | 32415 | −21% | 0.0799 | 0.7357 |
| hydroxyisovaleroyl carnitine | 35433 | −21% | 0.3077 | 0.8924 |
| epiandrosterone sulfate | 33973 | −20% | 0.1789 | 0.7815 |
| pregnen-diol disulfate | 32562 | −20% | 0.2397 | 0.8489 |
| stachydrine | 34384 | −20% | 0.3708 | 0.9008 |
| N-acetylornithine | 15630 | −19% | 0.2474 | 0.856 |
| N-acetylserine | 37076 | −18% | 0.1328 | 0.7794 |
| 4-vinylphenol sulfate | 36098 | −18% | 0.1616 | 0.7815 |
| 4-androsten-3beta,17beta-diol disulfate 2 | 37203 | −18% | 0.379 | 0.9016 |
| cis-4-decenoyl carnitine | 38178 | −18% | 0.3979 | 0.9136 |
| 4-hydroxyphenylacetate | 541 | −18% | 0.8583 | 1 |
| 1-stearoylglycerophosphoinositol | 19324 | −17% | 0.1459 | 0.7794 |
| 2-methylbutyroylcarnitine | 35431 | −17% | 0.3177 | 0.8972 |
| indoleacetate | 27513 | −17% | 0.4963 | 0.9431 |
| 5alpha-pregnan-3beta,20alpha-diol disulfate | 37198 | −16% | 0.1152 | 0.7794 |
| 3-hydroxybutyrate (BHBA) | 542 | −16% | 0.3122 | 0.8972 |
| pregn steroid monosulfate | 32619 | −15% | 0.1254 | 0.7794 |
| 10-undecenoate (11:1n1) | 32497 | −15% | 0.1781 | 0.7815 |
| threonine | 1284 | −15% | 0.1931 | 0.793 |
| palmitoleate (16:1n7) | 33447 | −15% | 0.2915 | 0.8924 |
| taurocholenate sulfate | 32807 | −15% | 0.3703 | 0.9008 |
| tiglyl carnitine | 35428 | −15% | 0.3813 | 0.9016 |
| 2-oleoylglycerophosphoethanolamine | 35687 | −15% | 0.3849 | 0.9016 |
| andro steroid monosulfate 1 | 32827 | −15% | 0.574 | 0.9711 |
| trans-4-hydroxyproline | 32319 | −14% | 0.2498 | 0.8595 |
| 3-dehydrocarnitine | 32654 | −14% | 0.3401 | 0.9008 |
| myristoleate (14:1n5) | 32418 | −14% | 0.4522 | 0.9369 |
| methionine | 1302 | −13% | 0.0229 | 0.5627 |
| 2-octenoyl carnitine | 35440 | −13% | 0.07 | 0.6991 |
| linolenate [alpha or gamma; (18:3n3 or 6)] | 34035 | −13% | 0.1458 | 0.7794 |
| cis-vaccenate (18:1n7) | 33970 | −13% | 0.5413 | 0.9496 |
| hexanoylcarnitine | 32328 | −13% | 0.5853 | 0.9763 |
| pregnenolone sulfate | 38170 | −13% | 0.6586 | 1 |
| 3-methyl-2-oxovalerate | 15676 | −12% | 0.0654 | 0.6784 |
| 4-methyl-2-oxopentanoate | 22116 | −12% | 0.0852 | 0.7369 |
| stearate (18:0) | 1358 | −12% | 0.0972 | 0.7794 |
| uridine | 606 | −12% | 0.1688 | 0.7815 |
| 17-methylstearate | 38296 | −12% | 0.2346 | 0.8454 |
| docosahexaenoate (DHA; 22:6n3) | 19323 | −12% | 0.2377 | 0.8489 |
| 10-heptadecenoate (17:1n7) | 33971 | −12% | 0.3617 | 0.9008 |
| dihomo-linoleate (20:2n6) | 17805 | −12% | 0.3749 | 0.9016 |
| isovalerate | 34732 | −12% | 0.6937 | 1 |
| 5alpha-androstan-3beta,17alpha-diol disulfate | 37187 | −11% | 0.0125 | 0.5144 |
| palmitate (16:0) | 1336 | −11% | 0.172 | 0.7815 |
| linoleate (18:2n6) | 1105 | −11% | 0.1973 | 0.7959 |
| 21-hydroxypregnenolone disulfate | 37173 | −11% | 0.2711 | 0.8782 |
| 5-dodecenoate (12:1n7) | 33968 | −11% | 0.5452 | 0.9496 |
| glycoursodeoxycholate | 39379 | −11% | 0.6343 | 0.9985 |
| andro steroid monosulfate 2 | 32792 | −11% | 0.702 | 1 |
| delta-tocopherol | 33418 | −11% | 0.8354 | 1 |
| creatinine | 513 | −10% | 0.0634 | 0.6778 |
| pentadecanoate (15:0) | 1361 | −10% | 0.2026 | 0.8058 |
| ornithine | 35832 | −10% | 0.2252 | 0.8213 |
| eicosenoate (20:1n9 or 11) | 33587 | −10% | 0.3534 | 0.9008 |
| phenyllactate (PLA) | 22130 | −10% | 0.4063 | 0.9198 |
| leucine | 60 | −9% | 0.06 | 0.6778 |
| 3-methyl-2-oxobutyrate | 21047 | −9% | 0.0785 | 0.7357 |
| glycolate (hydroxyacetate) | 15737 | −9% | 0.1412 | 0.7794 |
| isoleucine | 1125 | −9% | 0.1533 | 0.7815 |
| acetylcarnitine | 32198 | −9% | 0.163 | 0.7815 |
| N6-acetyllysine | 36752 | −9% | 0.2067 | 0.8118 |
| beta-alanine | 35838 | −9% | 0.2656 | 0.8782 |
| 1-oleoylglycerophosphoethanolamine | 35628 | −9% | 0.5113 | 0.9431 |
| valine | 1649 | −8% | 0.0551 | 0.6778 |
| betaine | 3141 | −8% | 0.1215 | 0.7794 |
| myo-inositol | 19934 | −8% | 0.321 | 0.8972 |
| myristate (14:0) | 1365 | −8% | 0.3571 | 0.9008 |
| dimethylglycine | 5086 | −8% | 0.414 | 0.9285 |
| 10-nonadecenoate (19:1n9) | 33972 | −8% | 0.4518 | 0.9369 |
| 1-methylurate | 34395 | −8% | 0.496 | 0.9431 |
| ethanolamine | 34285 | −8% | 0.5046 | 0.9431 |
| docosapentaenoate (n3 DPA; 22:5n3) | 32504 | −8% | 0.5811 | 0.9763 |
| glycocholate | 18476 | −8% | 0.7538 | 1 |
| serotonin (5HT) | 2342 | −8% | 0.7664 | 1 |
| laurylcarnitine | 34534 | −8% | 0.8019 | 1 |
| threonate | 27738 | −7% | 0.1752 | 0.7815 |
| kynurenine | 15140 | −7% | 0.184 | 0.7815 |
| nonadecanoate (19:0) | 1356 | −7% | 0.2948 | 0.8924 |
| arabitol | 15964 | −7% | 0.4439 | 0.9369 |
| eicosapentaenoate (EPA; 20:5n3) | 18467 | −7% | 0.6103 | 0.9888 |
| adrenate (22:4n6) | 32980 | −7% | 0.8405 | 1 |
| deoxycarnitine | 36747 | −6% | 0.1941 | 0.793 |
| tyrosine | 1299 | −6% | 0.2684 | 0.8782 |
| proline | 1898 | −6% | 0.2895 | 0.8924 |
| 1,5-anhydroglucitol (1,5-AG) | 20675 | −6% | 0.3012 | 0.8924 |
| margarate (17:0) | 1121 | −6% | 0.4688 | 0.9431 |
| 1-arachidonoylglycerophosphoinositol | 34214 | −6% | 0.5345 | 0.9496 |
| theophylline | 18394 | −6% | 0.8331 | 1 |
| 2-hydroxypalmitate | 35675 | −5% | 0.2553 | 0.8707 |
| octadecanedioate | 36754 | −5% | 0.2797 | 0.8924 |
| choline | 15506 | −5% | 0.3647 | 0.9008 |
| 3-hydroxydecanoate | 22053 | −5% | 0.422 | 0.9285 |
| urea | 1670 | −5% | 0.4284 | 0.932 |
| alanine | 32339 | −5% | 0.5072 | 0.9431 |
| palmitoylcarnitine | 22189 | −5% | 0.5295 | 0.9496 |
| biliverdin | 2137 | −5% | 0.9552 | 1 |
| docosapentaenoate (n6 DPA; 22:5n6) | 37478 | −5% | 0.9993 | 1 |
| phosphate | 11438 | 5% | 0.0518 | 0.6778 |
| succinylcarnitine | 37058 | 5% | 0.3002 | 0.8924 |
| acetylphosphate | 15488 | 5% | 0.3165 | 0.8972 |
| 1-linoleoylglycerophosphocholine | 34419 | 5% | 0.4524 | 0.9369 |
| 1-stearoylglycerophosphoethanolamine | 34416 | 5% | 0.5013 | 0.9431 |
| glucose | 20489 | 5% | 0.5453 | 0.9496 |
| 2-palmitoylglycerophosphoethanolamine | 35688 | 5% | 0.6309 | 0.9985 |
| bilirubin (E,E) | 32586 | 5% | 0.8112 | 1 |
| bilirubin (E,Z or Z,E) | 34106 | 5% | 0.8463 | 1 |
| cholesterol | 63 | 6% | 0.1677 | 0.7815 |
| palmitoyl sphingomyelin | 37506 | 6% | 0.2832 | 0.8924 |
| 1-eicosatrienoylglycerophosphocholine | 33821 | 6% | 0.4427 | 0.9369 |
| sebacate (decanedioate) | 32398 | 6% | 0.4639 | 0.9417 |
| 1-docosahexaenoylglycerophosphocholine | 33822 | 6% | 0.4755 | 0.9431 |
| 3-hydroxy-2-ethylpropionate | 32397 | 6% | 0.7022 | 1 |
| oxalate (ethanedioate) | 20694 | 6% | 0.8394 | 1 |
| glycerol | 15122 | 8% | 0.1418 | 0.7794 |
| taurolithocholate 3-sulfate | 38782 | 8% | 0.3532 | 0.9008 |
| 1-arachidonoylglycerophosphocholine | 33228 | 8% | 0.3592 | 0.9008 |
| arabinose | 575 | 8% | 0.4178 | 0.9285 |
| 1,3-dihydroxyacetone | 35981 | 8% | 0.5241 | 0.9496 |
| pyruvate | 599 | 8% | 0.5564 | 0.9552 |
| heme | 32593 | 8% | 0.7335 | 1 |
| pyrophosphate (PPi) | 2078 | 8% | 0.8887 | 1 |
| glycerol 3-phosphate (G3P) | 15365 | 9% | 0.0453 | 0.6778 |
| phenylacetate | 15958 | 9% | 0.2635 | 0.8782 |
| 1,3,7-trimethylurate | 34404 | 9% | 0.3991 | 0.9136 |
| 1-eicosadienoylglycerophosphocholine | 33871 | 9% | 0.4339 | 0.9369 |
| hexadecanedioate | 35678 | 9% | 0.6301 | 0.9985 |
| 1,6-anhydroglucose | 21049 | 9% | 0.8726 | 1 |
| glucuronate | 15443 | 9% | 0.9613 | 1 |
| 1-palmitoleoylglycerophosphocholine | 33230 | 10% | 0.1167 | 0.7794 |
| hippurate | 15753 | 10% | 0.3077 | 0.8924 |
| glycine | 32338 | 10% | 0.3321 | 0.9008 |
| succinate | 1437 | 11% | 0.3408 | 0.9008 |
| pro-hydroxy-pro | 35127 | 11% | 0.5126 | 0.9431 |
| caffeine | 569 | 11% | 0.6036 | 0.9882 |
| threitol | 35854 | 11% | 0.6084 | 0.9888 |
| theobromine | 18392 | 11% | 0.7367 | 1 |
| 1-palmitoylglycerophosphocholine | 33955 | 12% | 0.0231 | 0.5627 |
| pelargonate (9:0) | 12035 | 12% | 0.1017 | 0.7794 |
| heptanoate (7:0) | 1644 | 12% | 0.1097 | 0.7794 |
| butyrylcarnitine | 32412 | 12% | 0.6137 | 0.9888 |
| catechol sulfate | 35320 | 12% | 0.8471 | 1 |
| taurochenodeoxycholate | 18494 | 12% | 0.9789 | 1 |
| 1-oleoylglycerophosphocholine | 33960 | 14% | 0.1109 | 0.7794 |
| stearoyl sphingomyelin | 19503 | 14% | 0.1272 | 0.7794 |
| sarcosine (N-Methylglycine) | 1516 | 14% | 0.2141 | 0.8118 |
| fructose | 31266 | 14% | 0.2199 | 0.8118 |
| deoxycholate | 1114 | 14% | 0.2559 | 0.8707 |
| 7-methylxanthine | 34390 | 14% | 0.4737 | 0.9431 |
| homostachydrine | 33009 | 14% | 0.6468 | 1 |
| 1-docosapentaenoylglycerophosphocholine | 37231 | 15% | 0.1518 | 0.7815 |
| adenoslne 5′-monophosphate (AMP) | 32342 | 15% | 0.2818 | 0.8924 |
| glycolithocholate sulfate | 32620 | 15% | 0.316 | 0.8972 |
| pantothenate | 1508 | 15% | 0.452 | 0.9369 |
| 1-pentadecanoylglycerophosphocholine | 37418 | 16% | 0.0545 | 0.6778 |
| 2-oleoylglycerophosphocholine | 35254 | 16% | 0.1829 | 0.7815 |
| 1-methylxanthine | 34389 | 16% | 0.3795 | 0.9016 |
| 3-phenylpropionate (hydrocinnamate) | 15749 | 16% | 0.4432 | 0.9369 |
| lathosterol | 33488 | 16% | 0.5457 | 0.9496 |
| thymol sulfate | 36095 | 16% | 0.5544 | 0.9552 |
| 3-methylxanthine | 32445 | 16% | 0.6354 | 0.9985 |
| creatine | 27718 | 19% | 0.0657 | 0.6784 |
| phenylacetylglutamine | 35126 | 19% | 0.161 | 0.7815 |
| quinate | 18335 | 19% | 0.9575 | 1 |
| 1-stearoylglycerophosphocholine | 33961 | 20% | 0.055 | 0.6778 |
| tetradecanedioate | 35669 | 20% | 0.1632 | 0.7815 |
| 3-indoxyl sulfate | 27672 | 22% | 0.105 | 0.7794 |
| erythro-sphingosine-1-phosphate | 34445 | 22% | 0.1848 | 0.7815 |
| erythrulose | 37427 | 22% | 0.5855 | 0.9763 |
| 3-methoxytyrosine | 12017 | 22% | 0.6477 | 1 |
| p-cresol sulfate | 36103 | 23% | 0.2662 | 0.8782 |
| 4-hydroxyhippurate | 35527 | 23% | 0.3586 | 0.9008 |
| 2-hydroxyglutarate | 37253 | 23% | 0.4984 | 0.9431 |
| 12,13-hydroxyoctadec-9(Z)-enoate | 38395 | 25% | 0.1953 | 0.793 |
| caprate (10:0) | 1642 | 27% | 0.1318 | 0.7794 |
| pyridoxate | 31555 | 27% | 0.4984 | 0.9431 |
| 2-stearoylglycerophosphocholine | 35255 | 28% | 0.0611 | 0.6778 |
| phenol sulfate | 32553 | 30% | 0.2952 | 0.8924 |
| taurodeoxycholate | 12261 | 30% | 0.3202 | 0.8972 |
| 1-heptadecanoylglycerophosphocholine | 33957 | 32% | 0.0251 | 0.5871 |
| glycodeoxycholate | 18477 | 45% | 0.1395 | 0.7794 |
| N-(2-furoyl)glycine | 31536 | 52% | 0.3385 | 0.9008 |
| caprylate (8:0) | 32492 | 54% | 0.0746 | 0.7215 |
| bradykinin, des-arg(9) | 34420 | 56% | 0.3675 | 0.9008 |
| erythritol | 20699 | 56% | 0.8436 | 1 |
| taurocholate | 18497 | 59% | 0.4999 | 0.9431 |
| xylonate | 35638 | 75% | 0.2343 | 0.8454 |
| cotinine | 553 | 79% | 0.4252 | 0.9314 |
| 1,2-propanediol | 38002 | 82% | 0.5069 | 0.9431 |
| xylose | 15835 | 96% | 0.0493 | 0.6778 |
| bradykinin, hydroxy-pro(3) | 33962 | 96% | 0.2415 | 0.8489 |
| DSGEGDFXAEGGGVR (SEQ ID NO: 4) | 31548 | −342% | 0.6378 | 0.9985 |
| ADSGEGDFXAEGGGVR (SEQ ID NO: 5) | 33084 | −204% | 0.7426 | 1 |
| 2-hydroxyhippurate (salicylurate) | 18281 | 170% | 0.8503 | 1 |
| HWESASXX (SEQ ID NO: 1) | 32836 | 257% | <0.001 | 0.0278 |
| [H]HWESASLLR[OH] (SEQ ID NO: 6) | 33964 | 809% | <0.001 | 0.0127 |
| XHWESASXXR (SEQ ID NO: 7) | 31538 | 178% | 0.0599 | 0.6778 |
| 4-ethylphenylsulfate | 36099 | 186% | 0.3713 | 0.9008 |
| 3-(4-hydroxyphenyl)-1-(2,4,6- | 38153 | 1567% | 0.2697 | 0.8782 |
| trihydroxyphenyl)-1-propanone | | | | |

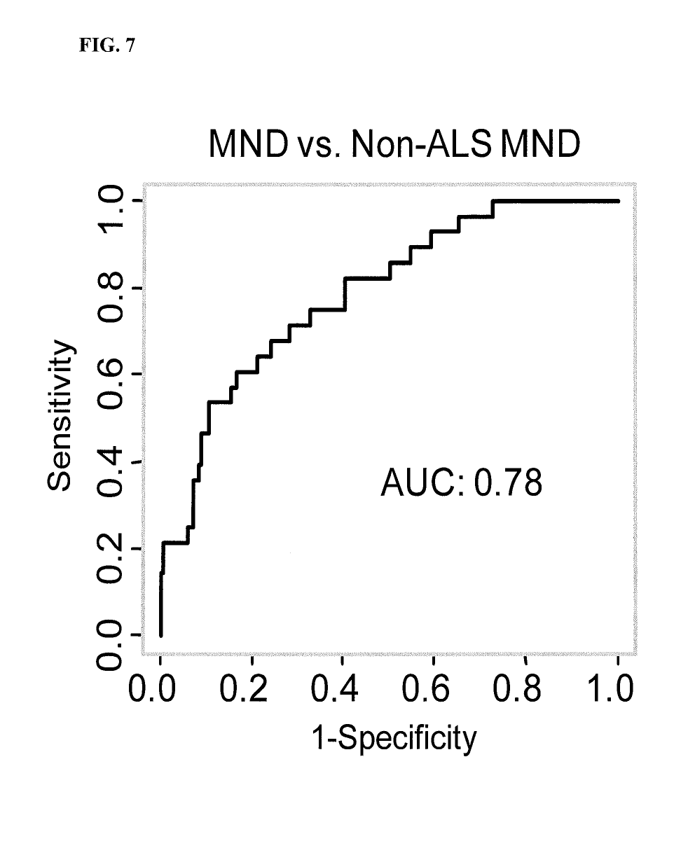

In further statistical analysis, a Bayesian factor analysis approach was used to classify samples into ALS or non-ALS MND groups. The area under the curve (AUC) for the receiver operating characteristic (ROC) curve was 0.79 and is graphically illustrated in FIG. 7. Exemplary biomarkers for distinguishing the groups are listed in Table 12.

TABLE 12
Biomarkers that distinguish ALS from non-ALS MND

| Biochemical Name | CompID |
|---|---|
| 2-palmitoylglycerophosphocholine | 35253 |
| 13-HODE + 9-HODE | 37752 |
| 2-aminobutyrate | 32348 |
| 3-(4-hydroxyphenyl)lactate | 32197 |
| 3-carboxy-4-methyl-5-propyl-2-furanpropanoate | 31787 |
| (CMPF) | |
| 3-hydroxyisobutyrate | 1549 |
| 5alpha-androstan-3alpha,17beta-diol disulfate | 37184 |
| acetoacetate | 33963 |
| alpha-hydroxyisovalerate | 33937 |
| arachidonate (20:4n6) | 1110 |
| asparagine | 34283 |
| bilirubin (Z,Z) | 27716 |
| bradykinin | 22154 |
| C-glycosyltryptophan | 32675 |
| caproate (6:0) | 32489 |
| cysteine | 31453 |
| cystine | 31454 |
| erythronate | 33477 |
| gamma-glutamylalanine | 37063 |
| gamma-glutamylisoleucine | 34456 |
| gamma-glutamylleucine | 18369 |
| gamma-glutamylmethionine | 37539 |
| gamma-glutamylphenylalanine | 33422 |
| gamma-glutamyltyrosine | 2734 |
| gamma-glutamylvaline | 32393 |
| glutamate | 32322 |
| glutamine | 53 |
| glutaroyl carnitine | 35439 |
| glycerate | 1572 |
| histidine | 59 |
| HWESASXX (SEQ ID NO: 1) | 32836 |
| isovalerylcarnitine | 34407 |
| methylglutaroylcarnitine | 37060 |
| pyroglutamine | 32672 |
| tryptophan betaine | 37097 |
| urate | 1604 |
| [H]HWESASLLR[OH] (SEQ ID NO: 6) | 33964 |

### Example 5

### Biomarkers that Distinguish MND from Symptom Mimic Disease Subjects

Metabolomic analysis was carried out on blood plasma samples to identify biomarkers that were useful to distinguish MND patients from patients with symptom mimic diseases that are not MND, that is, neurodegenerative diseases that cause symptoms that appear clinically similar to MND (e.g., multi-focal motor neuropathy, spinal muscular atrophy, Kennedy's disease, multiple sclerosis). The plasma samples used for the analysis were from 200 MND subjects, and 73 symptom mimic disease patients. After the levels of metabolites were determined, the data were analyzed using Wilcoxon test to identify biomarkers that differed between the MND patients and the symptom mimic disease patients. The biomarkers with a FDR of less than 0.15 are listed in Table 13.

TABLE 13
Biomarkers that distinguish MND from non-MND symptom mimic
disease subjects

| | Direction of | |
|---|---|---|
| Biochemical Name | change in MND | CompID |
| 10-undecenoate (11:1n1) | Higher | 32497 |
| 2-hydroxybutyrate (AHB) | Higher | 21044 |
| 3-dehydrocarnitine | Lower | 32654 |
| 3-methylxanthine | Lower | 32445 |
| cortisone | Higher | 1769 |
| creatine | Higher | 27718 |
| hexadecanedioate | Higher | 35678 |
| iminodiacetate (IDA) | Higher | 35837 |
| octadecanedioate | Higher | 36754 |
| palmitoyl sphingomyelin | Higher | 37506 |
| phosphate | Higher | 11438 |
| theobromine | Lower | 18392 |

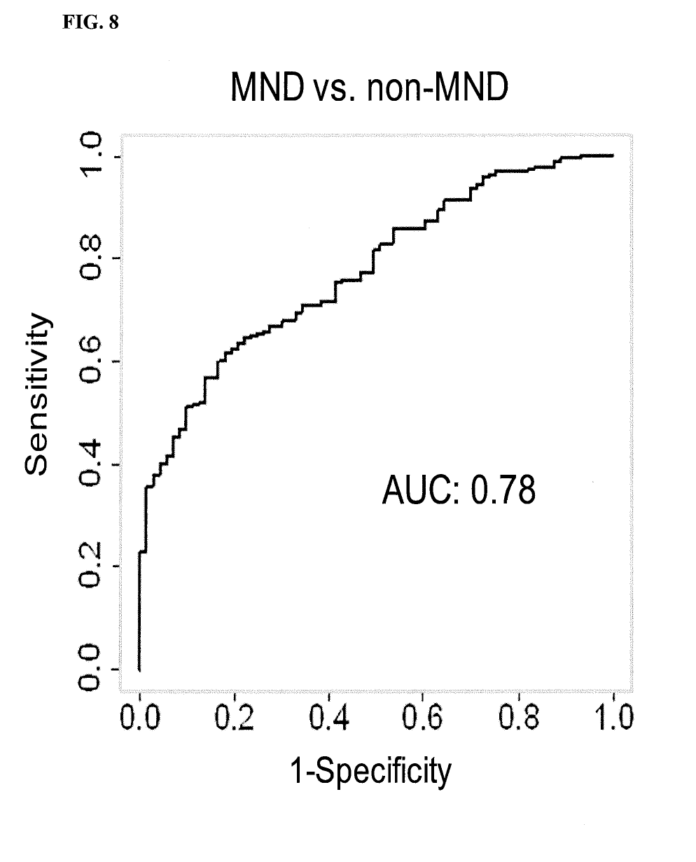

In further statistical analysis, a SVM prediction model was used to classify samples into MND or symptom mimic Disease groups. The SVM prediction model predicted whether a sample was from an individual with MND with a specificity of 90% and a sensitivity of 51% for analysis of the levels of the biomarkers in samples from the subject. Alternatively, if the model was adjusted to be 100% specific for predicting MND, then the sensitivity was 23%. The area under the curve (AUC) for the receiver operating characteristic (ROC) curve was 0.78 and is graphically illustrated in FIG. 8.

### Example 6

### Predictive Performance of a Panel of Biomarkers to Distinguish MND Subjects from Symptom Mimic Disease Subjects

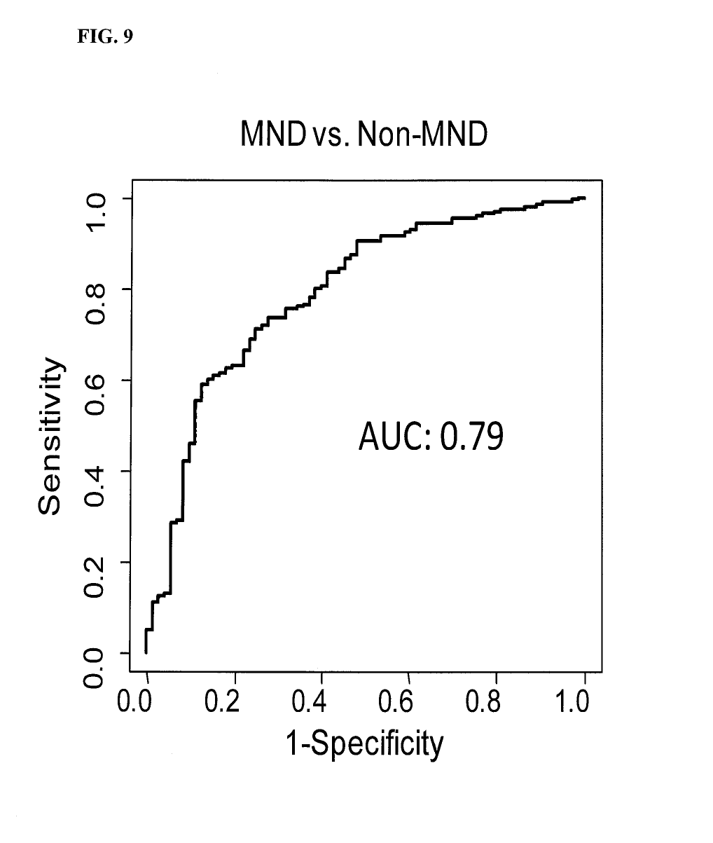

In one example, the biomarkers identified in Table 13 to distinguish MND from symptom mimic disease subjects were statistically analyzed to estimate their predictive performance. A LASSO prediction model was used. The resulting model estimated that, if used on a new set of subjects, the biomarkers identified in Table 13 could predict the identity of MND subjects with a specificity of 88% and a sensitivity of 60%. The area under the curve (AUC) for the receiver operating characteristic (ROC) curve was 0.79 and is graphically illustrated in FIG. 9.

To further demonstrate the effectiveness of the biomarkers in Table 13 to distinguish MND from symptom mimic disease patients, we constructed a scenario using the null hypothesis (i.e., random permutations). We compared the predictive performance of the random permutations to that using the biomarkers in Table 13. A random permutation was performed 1000 times to construct the null hypothesis. For each permutation, the top 12 metabolites that distinguished MND from symptom mimic disease subjects were selected and the LOO permuted AUC was computed. Less than 0.1% of the 1000 AUCs from the null hypothesis were as good as the AUC of 0.79 obtained using the 12 biomarkers identified in Table 13 for separating MND from symptom mimic disease subjects.

### Example 7

### Plasma Biomarkers for Disease Progression

Currently, one measure of ALS disease severity is the ALS Functional Rating Scale (ALSFRS). This subjective rating scale is used clinically for monitoring the progression of disability in patients with ALS. The scale has been revised (ALSFRS-R) and correlates with patient quality of life. A high score indicates less severe disability and a lower score indicates more severe disability.

To identify biomarkers of disease progression, plasma samples collected from 172 ALS subjects with ALSFRS-R scores ranging from 8 (most severe) to 48 (least severe) were analyzed metabolomically. After the levels of metabolites were determined, biomarkers of disease progression were identified using correlation analysis. The correlation analysis was performed between ALSFRS-R score, which had values ranging from 8 to 48, and the log transformed value of the metabolite intensity. Since higher ALSFRS-R scores indicate less severe disease and lower ALSFRS-R scores indicate increased disease severity, a positive correlation indicates higher biomarker levels were associated with higher scores and less severe disease while a negative correlation indicates higher biomarker levels were associated with lower scores and more severe disease. That is, as disease severity increases (i.e., disease progresses), the levels of biomarkers that are positively correlated will decrease and the levels of biomarkers that are negatively correlated will increase. The biomarkers identified are listed in Table 14.

Table 14 includes, for each listed biomarker and non-biomarker compound, the correlation value, the p-value and the q-value determined in the statistical analysis of the data concerning the biomarkers. In the table, the column “CompID” refers to the identifier for that biomarker in the internal chemical library database.

TABLE 14
Biomarkers in plasma of ALS progression: correlation with ALSFRS-
R scores.

| | | Correlation | Correlation | Correlation |
|---|---|---|---|---|
| Biochemical Name | CompID | Value | P-value | Q-value |
| tryptophan betaine | 37097 | 0.251 | 0.001 | 0.0213 |
| indolepropionate | 32405 | 0.176 | 0.0224 | 0.0986 |
| 4-vinylphenol sulfate | 36098 | 0.152 | 0.0497 | 0.1497 |
| prolylhydroxyproline | 35127 | −0.382 | <0.0001 | 0.0001 |
| creatinine | 513 | 0.355 | <0.0001 | 0.0004 |
| gamma-glutamylvaline | 32393 | −0.298 | 0.0001 | 0.0063 |
| glutamate | 32322 | −0.281 | 0.0002 | 0.0105 |
| catechol sulfate | 35320 | 0.255 | 0.0008 | 0.0192 |
| erythronate | 33477 | −0.255 | 0.0009 | 0.0192 |
| deoxycarnitine | 36747 | 0.242 | 0.0016 | 0.0289 |
| theophylline | 18394 | 0.241 | 0.0016 | 0.0289 |
| cortisol | 1712 | −0.24 | 0.0017 | 0.0289 |
| creatine | 27718 | −0.24 | 0.0018 | 0.0289 |
| C-glycosyltryptophan | 32675 | −0.237 | 0.002 | 0.0292 |
| hexanoylcarnitine (C6) | 32328 | −0.237 | 0.002 | 0.0292 |
| gamma-glutamylisoleucine | 34456 | −0.231 | 0.0026 | 0.033 |
| caffeine | 569 | 0.231 | 0.0026 | 0.033 |
| methyl palmitate (15 or 2) | 38768 | 0.219 | 0.0043 | 0.0469 |
| 1-methylxanthine | 34389 | 0.217 | 0.0047 | 0.0501 |
| paraxanthine | 18254 | 0.215 | 0.0052 | 0.0521 |
| 3-methoxytyrosine | 12017 | −0.21 | 0.0064 | 0.0557 |
| mannose | 584 | −0.203 | 0.0084 | 0.0672 |
| histidine | 59 | 0.201 | 0.009 | 0.0699 |
| 2-palmitoyl-GPE (16:0) | 35688 | 0.192 | 0.0126 | 0.0899 |
| glycerol | 15122 | −0.189 | 0.014 | 0.0899 |
| tiglyl carnitine (C5) | 35428 | 0.189 | 0.0141 | 0.0899 |
| 1,6-anhydroglucose | 21049 | −0.187 | 0.0154 | 0.0932 |
| 2-octenoylcarnitine (C8) | 35440 | 0.186 | 0.0158 | 0.0932 |
| 1,3,7-trimethylurate | 34404 | 0.186 | 0.0159 | 0.0932 |
| carnitine | 15500 | −0.184 | 0.0171 | 0.0939 |
| alpha-hydroxyisovalerate | 33937 | 0.184 | 0.0172 | 0.0939 |
| 4-ethylphenyl sulfate | 36099 | −0.184 | 0.0172 | 0.0939 |
| phosphate | 11438 | −0.182 | 0.018 | 0.0939 |
| ethanolamine | 34285 | −0.181 | 0.019 | 0.0963 |
| quinate | 18335 | 0.179 | 0.0202 | 0.0986 |
| lactate | 527 | −0.178 | 0.021 | 0.0986 |
| 2-hydroxyisobutyrate | 22030 | −0.177 | 0.0217 | 0.0986 |
| gamma-tocopherol | 33420 | 0.176 | 0.0226 | 0.0986 |
| (Hyp-3)-Bradykinin | 33962 | −0.176 | 0.0227 | 0.0986 |
| gamma-glutamylmethionine | 37539 | −0.176 | 0.0228 | 0.0986 |
| 1,7-dimethylurate | 34400 | 0.175 | 0.0233 | 0.0998 |
| glutamine | 53 | 0.174 | 0.0243 | 0.1025 |
| phenyllactate (PLA) | 22130 | 0.173 | 0.0246 | 0.1027 |
| hippurate | 15753 | 0.172 | 0.026 | 0.1051 |
| gamma-glutamylleucine | 18369 | −0.171 | 0.0263 | 0.1051 |
| theobromine | 18392 | 0.171 | 0.0263 | 0.1051 |
| levulinate (4-oxovalerate) | 22177 | 0.171 | 0.0265 | 0.1051 |
| 1-palmitoyl-GPE (16:0) | 35631 | 0.169 | 0.0289 | 0.1118 |
| pyroglutamine | 32672 | 0.168 | 0.0292 | 0.1118 |
| 2-ethylhexanoic acid | 1554 | 0.166 | 0.0317 | 0.1198 |
| sphingomyelin | 19503 | −0.165 | 0.0326 | 0.1218 |
| 1-linoleoyl-GPC (18:2) | 34419 | 0.165 | 0.0329 | 0.1218 |
| cinnamoylglycine | 38637 | 0.164 | 0.0337 | 0.1234 |
| glutaroylcarnitine (C5) | 35439 | 0.163 | 0.0345 | 0.1248 |
| N-(2-furoyl)glycine | 31536 | 0.162 | 0.0358 | 0.1276 |
| 3-carboxy-4-methyl-5-propyl-2- | 31787 | 0.161 | 0.0368 | 0.1276 |
| furanpropanoate (CMPF) | | | | |
| pseudouridine | 33442 | −0.161 | 0.0368 | 0.1276 |
| benzoate | 15778 | 0.161 | 0.0368 | 0.1276 |
| pantothenate (Vitamin B5) | 1508 | −0.161 | 0.0374 | 0.1281 |
| epiandrosterone sulfate | 33973 | 0.156 | 0.0432 | 0.141 |
| 1,2-propanediol | 38002 | −0.156 | 0.0432 | 0.141 |
| 2-hydroxybutyrate (AHB) | 21044 | −0.152 | 0.0486 | 0.1497 |
| 4-methyl-2-oxopentanoate | 22116 | 0.152 | 0.0488 | 0.1497 |
| 1-stearoyl-GPE (18:0) | 34416 | 0.152 | 0.0494 | 0.1497 |
| glycerate | 1572 | −0.152 | 0.0496 | 0.1497 |
| cortisone | 1769 | −0.151 | 0.0514 | 0.151 |
| lathosterol | 33488 | −0.15 | 0.0523 | 0.1524 |
| andro steroid monosulfate 2 | 32792 | −0.15 | 0.0531 | 0.1535 |
| 10-undecenoate (11:1n1) | 32497 | 0.148 | 0.0551 | 0.1565 |
| propionylcarnitine (C3) | 32452 | −0.147 | 0.0576 | 0.1607 |
| 3-phenylpropionate (hydrocinnamate) | 15749 | 0.146 | 0.0588 | 0.1616 |
| 3-(4-hydroxyphenyl)lactate (HPLA) | 32197 | 0.146 | 0.0589 | 0.1616 |
| 1-stearoyl-GPI (18:0) | 19324 | −0.145 | 0.0606 | 0.165 |
| 1-linoleoyl-GPE (18:2) | 32635 | 0.145 | 0.0616 | 0.166 |
| 1-eicosatrienoyl-GPC (20:3) | 33821 | 0.141 | 0.0692 | 0.1775 |
| alpha-tocopherol | 1561 | −0.14 | 0.0701 | 0.1775 |
| beta-hydroxyisovalerate | 12129 | 0.138 | 0.0747 | 0.1854 |
| 2-linoleoyl-GPE (18:2) | 36593 | 0.138 | 0.0749 | 0.1854 |
| 1-arachidonoyl-GPE (20:4) | 35186 | 0.137 | 0.0762 | 0.1862 |
| sarcosine (N-Methylglycine) | 1516 | −0.137 | 0.0764 | 0.1862 |
| hypoxanthine | 3127 | −0.135 | 0.0802 | 0.1899 |
| thymol sulfate | 36095 | −0.135 | 0.0813 | 0.1911 |
| 2-arachidonoyl-GPE (20:4) | 32815 | 0.133 | 0.0865 | 0.1999 |
| 1-methyladenosine | 15650 | −0.132 | 0.0886 | 0.2018 |
| 2-oleoyl-GPE (18:1) | 35687 | 0.131 | 0.0895 | 0.2019 |
| tyrosine | 1299 | −0.131 | 0.0916 | 0.2048 |
| dihydroxyacetone | 35981 | −0.13 | 0.0921 | 0.2048 |
| choline | 15506 | −0.13 | 0.0937 | 0.2071 |
| oleoylcarnitine (C18) | 35160 | −0.129 | 0.0946 | 0.2071 |
| 1-eicosadienoyl-GPC (20:2) | 33871 | 0.129 | 0.095 | 0.2071 |
| cyclo(leu-pro) | 37104 | 0.128 | 0.0972 | 0.2072 |
| N2,N2-dimethylguanosine | 35137 | −0.128 | 0.0976 | 0.2072 |
| butyrylcarnitine (C4) | 32412 | −0.127 | 0.101 | 0.2095 |
| arginine | 1638 | 0.127 | 0.1012 | 0.2095 |
| stachydrine | 34384 | 0.126 | 0.1025 | 0.2109 |
| palmitoyl sphingomyelin | 37506 | −0.126 | 0.1051 | 0.2149 |
| 1-palmitoylplasmenylethanolamine | 39270 | 0.122 | 0.1157 | 0.2298 |
| hydroxyproline | 32319 | −0.122 | 0.1162 | 0.2298 |
| ornithine | 35832 | −0.121 | 0.1174 | 0.2298 |
| succinate | 1437 | −0.121 | 0.1194 | 0.2298 |
| acetylphosphate | 15488 | −0.12 | 0.12 | 0.2298 |
| gamma-glutamyltyrosine | 2734 | −0.12 | 0.1208 | 0.2298 |
| fumarate | 1643 | −0.119 | 0.1251 | 0.2298 |
| acetylcarnitine (C2) | 32198 | −0.119 | 0.126 | 0.2298 |
| 3-dehydrocarnitine | 32654 | 0.118 | 0.1277 | 0.2298 |
| oleate (18:1n9) | 1359 | −0.118 | 0.1277 | 0.2298 |
| glucose | 20489 | −0.118 | 0.1279 | 0.2298 |
| proline | 1898 | −0.118 | 0.128 | 0.2298 |
| erythro-sphingosine-1-phosphate | 34445 | −0.117 | 0.1313 | 0.2324 |
| phenylacetylglutamine | 35126 | −0.116 | 0.1347 | 0.2347 |
| piperine | 33935 | 0.116 | 0.1353 | 0.2347 |
| campesterol | 39511 | 0.114 | 0.1409 | 0.2391 |
| asparagine | 34283 | 0.114 | 0.1428 | 0.2411 |
| 1-myristoyl-GPC (14:0) | 35626 | 0.111 | 0.1504 | 0.2497 |
| chiro-inositol | 37112 | 0.111 | 0.1518 | 0.2499 |
| pentadecanoate (15:0) | 1361 | −0.11 | 0.1577 | 0.2571 |
| taurocholate | 18497 | −0.109 | 0.1612 | 0.2615 |
| 1-docosapentaenoyl-GPC (22:5) | 37231 | 0.107 | 0.1658 | 0.265 |
| bilirubin (E,Z or Z,E) | 34106 | −0.106 | 0.1706 | 0.2687 |
| docosapentaenoate (n6 DPA; 22:5n6) | 37478 | 0.106 | 0.1715 | 0.2687 |
| pyruvate | 599 | −0.106 | 0.1724 | 0.2687 |
| pelargonate (9:0) | 12035 | 0.105 | 0.1738 | 0.2687 |
| aspartylphenylalanine | 22175 | 0.105 | 0.1747 | 0.2687 |
| bradykinin | 22154 | −0.104 | 0.1798 | 0.2731 |
| 1-stearoyl-GPC (18:0) | 33961 | 0.104 | 0.18 | 0.2731 |
| 1,5-anhydroglucitol (1,5-AG) | 20675 | 0.102 | 0.1871 | 0.28 |
| 1-arachidonoyl-GPC (20:4) | 33228 | 0.102 | 0.1901 | 0.2819 |
| 3-hydroxyoctanoate | 22001 | 0.101 | 0.1914 | 0.2826 |
| acetoacetate | 33963 | 0.099 | 0.2005 | 0.2934 |
| 1-docosahexaenoyl-GPC (22:6) | 33822 | 0.098 | 0.2047 | 0.2981 |
| N-acetylalanine | 1585 | 0.097 | 0.2089 | 0.3002 |
| 3-methylxanthine | 32445 | 0.097 | 0.2097 | 0.3002 |
| caprylate (8:0) | 32492 | −0.096 | 0.2136 | 0.3013 |
| bradykinin, des-arg(9) | 34420 | −0.096 | 0.2139 | 0.3013 |
| 3-indoxyl sulfate | 27672 | −0.096 | 0.2158 | 0.3023 |
| arabitol | 15964 | 0.095 | 0.2224 | 0.3058 |
| pregnen-diol disulfate | 32562 | −0.094 | 0.2274 | 0.3068 |
| heptanoate (7:0) | 1644 | 0.093 | 0.2333 | 0.3109 |
| biliverdin | 2137 | 0.092 | 0.2356 | 0.3128 |
| glucuronate | 15443 | −0.092 | 0.2368 | 0.3131 |
| xylitol | 4966 | −0.09 | 0.2451 | 0.3218 |
| 1-methylurate | 34395 | 0.088 | 0.255 | 0.3332 |
| eicosenoate (20:1n9 or 1n11) | 33587 | −0.088 | 0.2562 | 0.3334 |
| uridine | 606 | 0.087 | 0.2647 | 0.3417 |
| docosadienoate (22:2n6) | 32415 | −0.086 | 0.2682 | 0.3422 |
| urate | 1604 | 0.085 | 0.2719 | 0.3443 |
| threonine | 1284 | 0.085 | 0.2759 | 0.3467 |
| taurocholenate sulfate | 32807 | −0.084 | 0.278 | 0.3478 |
| 2-linoleoyl-GPC (18:2) | 35257 | 0.084 | 0.2789 | 0.3478 |
| 5alpha-pregnan-3alpha,20beta-diol | 37201 | 0.084 | 0.2807 | 0.3478 |
| disulfate 1 | | | | |
| linoleate (18:2n6) | 1105 | −0.083 | 0.2858 | 0.3524 |
| cystine | 31454 | 0.082 | 0.2884 | 0.3543 |
| cysteine | 31453 | 0.082 | 0.2927 | 0.3583 |
| 1-oleoyl-GPE (18:1) | 35628 | 0.081 | 0.2975 | 0.36 |
| alpha-ketoglutarate | 33453 | −0.081 | 0.2976 | 0.36 |
| taurolithocholate 3-sulfate | 38782 | −0.081 | 0.2992 | 0.36 |
| 7-methylxanthine | 34390 | 0.08 | 0.3034 | 0.3632 |
| androsterone sulfate | 31591 | 0.079 | 0.308 | 0.366 |
| phenylalanine | 64 | −0.078 | 0.3152 | 0.3725 |
| alanine | 32339 | 0.078 | 0.3174 | 0.3725 |
| 4-hydroxyhippurate | 35527 | 0.077 | 0.3193 | 0.3725 |
| 5alpha-androstan-3beta,17beta-diol | 37190 | 0.077 | 0.3208 | 0.3725 |
| disulfate | | | | |
| isobutyrylcarnitine (C4) | 33441 | −0.077 | 0.3213 | 0.3725 |
| gamma-glutamylglutamate | 36738 | 0.077 | 0.3245 | 0.3732 |
| isovalerate (C5) | 34732 | −0.076 | 0.3255 | 0.3732 |
| linolenate (18:3n3 or 3n6) | 34035 | −0.076 | 0.3275 | 0.3732 |
| dihomolinoleate (20:2n6) | 17805 | −0.074 | 0.339 | 0.381 |
| 12,13-hydroxyoctadec-9(Z)-enoate | 38395 | 0.073 | 0.3443 | 0.3842 |
| beta-hydroxypyruvate | 15686 | −0.073 | 0.3482 | 0.3844 |
| caprate (10:0) | 1642 | −0.073 | 0.3496 | 0.3844 |
| threonate | 27738 | −0.072 | 0.3514 | 0.3844 |
| 3-hydroxydecanoate | 22053 | 0.072 | 0.3514 | 0.3844 |
| dehydroisoandrosterone sulfate (DHEA- | 32425 | 0.072 | 0.3562 | 0.385 |
| S) | | | | |
| indolelactate | 18349 | 0.071 | 0.3591 | 0.3864 |
| 3-hydroxybutyrate (BHBA) | 542 | −0.07 | 0.3646 | 0.3886 |
| tetradecanedioate (C14) | 35669 | 0.07 | 0.3651 | 0.3886 |
| glycine | 32338 | 0.07 | 0.3703 | 0.389 |
| cholesterol | 63 | −0.068 | 0.3804 | 0.3961 |
| gamma-glutamylalanine | 37063 | −0.068 | 0.3828 | 0.3961 |
| 3-(3-hydroxyphenyl)propionate | 35635 | 0.067 | 0.3899 | 0.3967 |
| valine | 1649 | −0.067 | 0.3899 | 0.3967 |
| 2-hydroxyglutarate | 37253 | 0.065 | 0.4005 | 0.4026 |
| 2-aminobutyrate | 32348 | −0.065 | 0.4011 | 0.4026 |
| arabinose | 575 | −0.065 | 0.4061 | 0.4064 |
| fructose | 31266 | −0.064 | 0.4075 | 0.4065 |
| vaccenate (18:1n7) | 33970 | −0.064 | 0.4101 | 0.408 |
| adrenate (22:4n6) | 32980 | −0.063 | 0.4183 | 0.4124 |
| threitol | 35854 | 0.063 | 0.4198 | 0.4126 |
| glycocholate | 18476 | −0.062 | 0.4218 | 0.4133 |
| 2-methylbutyroylcarnitine (C5) | 35431 | −0.062 | 0.4263 | 0.4139 |
| glycoursodeoxycholate | 39379 | −0.061 | 0.4298 | 0.4139 |
| 13-HODE + 9-HODE | 37752 | −0.061 | 0.4331 | 0.4139 |
| betaine | 3141 | −0.061 | 0.4342 | 0.4139 |
| 2-hydroxyhippurate (salicylurate) | 18281 | −0.061 | 0.4358 | 0.4139 |
| pyrophosphate (PPi) | 2078 | −0.06 | 0.4371 | 0.4139 |
| bilirubin | 27716 | 0.06 | 0.4387 | 0.4139 |
| phenylacetate | 15958 | −0.06 | 0.44 | 0.4139 |
| docosahexaenoate (DHA; 22:6n3) | 19323 | 0.06 | 0.442 | 0.4146 |
| homostachydrine | 33009 | 0.059 | 0.4453 | 0.4164 |
| palmitoylcarnitine (C16) | 22189 | −0.059 | 0.4465 | 0.4164 |
| pyridoxate | 31555 | −0.059 | 0.45 | 0.4173 |
| glycochenodeoxycholate | 32346 | −0.057 | 0.467 | 0.4263 |
| 1-oleoyl-GPC (18:1) | 33960 | 0.056 | 0.469 | 0.4265 |
| 10-nonadecenoate (19:1n9) | 33972 | −0.055 | 0.4787 | 0.4325 |
| citrate | 1564 | −0.055 | 0.4812 | 0.4328 |
| 10-heptadecenoate (17:1n7) | 33971 | −0.054 | 0.4857 | 0.4345 |
| nonadecanoate (19:0) | 1356 | 0.054 | 0.4873 | 0.4348 |
| pipecolate | 1444 | −0.053 | 0.4936 | 0.4376 |
| N-acetylornithine | 15630 | 0.053 | 0.4944 | 0.4376 |
| sebacate (decanedioate) | 32398 | −0.053 | 0.4978 | 0.4394 |
| palmitoleate (16:1n7) | 33447 | −0.052 | 0.4997 | 0.4399 |
| 5,6-dihydrouracil | 1559 | −0.052 | 0.5049 | 0.4433 |
| 4-hydroxyphenylpyruvate | 1669 | 0.051 | 0.5119 | 0.4459 |
| gamma-CEHC | 37462 | 0.051 | 0.5139 | 0.4459 |
| N-methyl proline | 37431 | 0.051 | 0.5145 | 0.4459 |
| 2-hydroxyoctanoate | 22036 | 0.051 | 0.5159 | 0.4459 |
| 3-methyl-2-oxobutyrate | 21047 | −0.05 | 0.5162 | 0.4459 |
| AMP | 32342 | −0.05 | 0.5202 | 0.4459 |
| beta-alanine | 35838 | 0.05 | 0.5223 | 0.4459 |
| iminodiacetate (IDA) | 35837 | −0.05 | 0.5228 | 0.4459 |
| 17-methylstearate | 38296 | 0.049 | 0.5251 | 0.4467 |
| glycolate (hydroxyacetate) | 15737 | −0.049 | 0.5269 | 0.4471 |
| gamma-glutamylphenylalanine | 33422 | −0.049 | 0.529 | 0.4478 |
| succinylcarnitine (C4) | 37058 | −0.048 | 0.5347 | 0.4503 |
| delta-tocopherol | 33418 | 0.048 | 0.5362 | 0.4504 |
| urea | 1670 | 0.047 | 0.5486 | 0.4559 |
| isovalerylcarnitine (C5) | 34407 | −0.046 | 0.5577 | 0.4614 |
| undecanoate (11:0) | 12067 | 0.045 | 0.5593 | 0.4615 |
| N6-acetyllysine | 36752 | 0.045 | 0.561 | 0.4618 |
| 4-androsten-3beta,17beta-diol disulfate 1 | 37202 | 0.045 | 0.5661 | 0.4631 |
| laurylcarnitine (C12) | 34534 | −0.045 | 0.5669 | 0.4631 |
| methylphosphate | 37070 | −0.044 | 0.5726 | 0.4667 |
| kynurenine | 15140 | 0.041 | 0.6012 | 0.4799 |
| myo-inositol | 19934 | 0.041 | 0.6016 | 0.4799 |
| stearidonate (18:4n3) | 33969 | −0.04 | 0.6053 | 0.4799 |
| EDTA | 32511 | −0.04 | 0.6074 | 0.4799 |
| 4-hydroxyphenylacetate | 541 | −0.04 | 0.6075 | 0.4799 |
| 1-arachidonoyl-GPI (20:4) | 34214 | −0.04 | 0.608 | 0.4799 |
| 5-oxoproline | 1494 | 0.04 | 0.6087 | 0.4799 |
| erythritol | 20699 | 0.04 | 0.6098 | 0.4799 |
| malate | 1303 | −0.04 | 0.6104 | 0.4799 |
| decanoylcarnitine (C10) | 33941 | 0.04 | 0.6108 | 0.4799 |
| 3-(4-hydroxyphenyl)-1-(2,4,6- | 38153 | 0.039 | 0.619 | 0.4844 |
| trihydroxyphenyl)-1-propanone | | | | |
| 1-pentadecanoylglycerophosphocholine | 37418 | 0.039 | 0.6194 | 0.4844 |
| lysine | 1301 | −0.038 | 0.6222 | 0.4854 |
| 3-methylglutaroylcarnitine (C6) | 37060 | 0.038 | 0.6271 | 0.4878 |
| p-cresol sulfate | 36103 | −0.038 | 0.6282 | 0.4878 |
| cis-4-decenoyl carnitine | 38178 | −0.037 | 0.6312 | 0.4879 |
| cholate | 22842 | −0.037 | 0.6384 | 0.4911 |
| 3-hydroxyisobutyrate | 1549 | −0.036 | 0.6441 | 0.492 |
| glycodeoxycholate | 18477 | −0.035 | 0.65 | 0.4954 |
| 3-methylhistidine | 15677 | 0.035 | 0.6529 | 0.4955 |
| oxalate (ethanedioate) | 20694 | −0.035 | 0.6533 | 0.4955 |
| 7-HOCA | 36776 | −0.035 | 0.6547 | 0.4955 |
| serine | 32315 | −0.034 | 0.6654 | 0.4965 |
| glycerol 3-phosphate (G3P) | 15365 | 0.033 | 0.669 | 0.4965 |
| octanoylcarnitine (C8) | 33936 | −0.032 | 0.6775 | 0.4977 |
| tartarate | 15336 | 0.032 | 0.6786 | 0.4977 |
| cinnamate | 12115 | 0.032 | 0.6788 | 0.4977 |
| allantoin | 1107 | −0.031 | 0.6898 | 0.5035 |
| docosapentaenoate (DPA; 22:5n3) | 32504 | −0.03 | 0.6965 | 0.5073 |
| laurate (12:0) | 1645 | 0.03 | 0.6983 | 0.5075 |
| myristoleate (14:1n5) | 32418 | −0.029 | 0.7048 | 0.51 |
| dimethylglycine | 5086 | −0.029 | 0.7085 | 0.5104 |
| 2-stearoyl-GPC (18:0) | 35255 | 0.029 | 0.7118 | 0.5117 |
| xylonate | 35638 | 0.028 | 0.7164 | 0.5128 |
| 5-dodecenoate (12:1n7) | 33968 | 0.027 | 0.7315 | 0.5186 |
| heme | 32593 | −0.027 | 0.7325 | 0.5186 |
| dihomolinolenate (20:3n3 or 3n6) | 35718 | −0.026 | 0.7403 | 0.5225 |
| 21-hydroxypregnenolone disulfate | 37173 | −0.026 | 0.7411 | 0.5225 |
| 3-methyl-2-oxovalerate | 15676 | 0.025 | 0.7448 | 0.5236 |
| azelate (nonanedioate; C9) | 18362 | 0.025 | 0.7459 | 0.5236 |
| 4-androsten-3beta,17beta-diol disulfate 2 | 37203 | −0.025 | 0.749 | 0.5241 |
| stearate (18:0) | 1358 | 0.025 | 0.7498 | 0.5241 |
| bilirubin (E,E) | 32586 | 0.023 | 0.7693 | 0.532 |
| 2-hydroxypalmitate | 35675 | −0.023 | 0.77 | 0.532 |
| octadecanedioate (C18) | 36754 | −0.023 | 0.7703 | 0.532 |
| hydroxyisovaleroylcarnitine (C5) | 35433 | −0.023 | 0.7707 | 0.532 |
| 1-heptadecanoyl-GPC (17:0) | 33957 | 0.022 | 0.7761 | 0.5338 |
| 5alpha-androstan-3alpha,17beta-diol | 37184 | −0.022 | 0.7811 | 0.5338 |
| disulfate | | | | |
| methionine | 1302 | −0.021 | 0.7847 | 0.5338 |
| glycocholenate sulfate | 32599 | 0.021 | 0.7847 | 0.5338 |
| isoleucine | 1125 | −0.021 | 0.7887 | 0.5338 |
| sucralose | 36649 | −0.021 | 0.7902 | 0.5338 |
| 1-palmitoyl-GPC (16:0) | 33955 | 0.021 | 0.7924 | 0.5338 |
| indoleacetate | 27513 | −0.02 | 0.7929 | 0.5338 |
| eicosapentaenoate (EPA; 20:5n3) | 18467 | −0.02 | 0.7956 | 0.5345 |
| margarate (17:0) | 1121 | −0.02 | 0.8012 | 0.5372 |
| taurodeoxycholate | 12261 | 0.019 | 0.805 | 0.5378 |
| alpha-ketobutyrate | 4968 | −0.019 | 0.8053 | 0.5378 |
| urobilinogen | 32426 | −0.019 | 0.8082 | 0.5387 |
| tryptophan | 54 | −0.018 | 0.8154 | 0.5406 |
| pregnenolone sulfate | 38170 | −0.018 | 0.8208 | 0.5415 |
| leucine | 60 | 0.017 | 0.827 | 0.5445 |
| saccharin | 21151 | 0.016 | 0.8387 | 0.5478 |
| beta-tocopherol | 35702 | 0.016 | 0.8421 | 0.5479 |
| caproate (6:0) | 32489 | 0.015 | 0.8447 | 0.5485 |
| pregn steroid monosulfate | 32619 | −0.015 | 0.8468 | 0.5488 |
| arachidonate (20:4n6) | 1110 | −0.015 | 0.8509 | 0.5499 |
| phenol sulfate | 32553 | 0.015 | 0.8519 | 0.5499 |
| 5alpha-androstan-3beta,17alpha-diol | 37187 | 0.013 | 0.8706 | 0.5555 |
| disulfate | | | | |
| erythrulose | 37427 | −0.012 | 0.8761 | 0.5559 |
| serotonin (5HT) | 2342 | 0.012 | 0.8773 | 0.5559 |
| dodecanedioate (C12) | 32388 | −0.012 | 0.8808 | 0.5559 |
| 5alpha-pregnan-3beta,20alpha-diol | 37198 | 0.012 | 0.8829 | 0.5559 |
| disulfate | | | | |
| hexadecanedioate (C16) | 35678 | 0.011 | 0.8855 | 0.5559 |
| deoxycholate | 1114 | −0.011 | 0.8893 | 0.5559 |
| 3-hydroxy-2-ethylpropionate | 32397 | −0.011 | 0.8898 | 0.5559 |
| taurochenodeoxycholate | 18494 | 0.01 | 0.8933 | 0.5566 |
| citrulline | 2132 | −0.01 | 0.8944 | 0.5566 |
| myristate (14:0) | 1365 | −0.01 | 0.8993 | 0.5576 |
| cotinine | 553 | 0.009 | 0.9084 | 0.5611 |
| andro steroid monosulfate 1 | 32827 | −0.008 | 0.9216 | 0.564 |
| 1-palmitoleoyl-GPC (16:1) | 33230 | −0.008 | 0.9216 | 0.564 |
| N-acetylserine | 37076 | −0.007 | 0.9262 | 0.565 |
| palmitate (16:0) | 1336 | −0.007 | 0.9309 | 0.5665 |
| 2-hydroxystearate | 17945 | 0.006 | 0.9414 | 0.5691 |
| ribitol | 15772 | −0.005 | 0.9467 | 0.5708 |
| glycolithocholate sulfate | 32620 | −0.005 | 0.9514 | 0.5726 |
| N-acetylglycine | 27710 | 0.003 | 0.9721 | 0.5808 |
| xylose | 15835 | −0.002 | 0.9834 | 0.5854 |
| mannitol | 15335 | −0.001 | 0.9853 | 0.5855 |
| 2-oleoyl-GPC (18:1) | 35254 | −0.001 | 0.9935 | 0.5861 |
| [H]HWESASLLR[OH] (SEQ ID NO: 6) | 33964 | −0.279 | 0.0003 | 0.0105 |
| HWESASXX (SEQ ID NO: 1) | 32836 | −0.192 | 0.0125 | 0.0899 |
| XHWESASXXR (SEQ ID NO: 7) | 31538 | −0.19 | 0.0138 | 0.0899 |
| ADSGEGDFXAEGGGVR (SEQ ID | 33084 | −0.117 | 0.1313 | 0.2324 |
| NO: 5) | | | | |
| DSGEGDFXAEGGGVR (SEQ ID NO: 4) | 31548 | −0.14 | 0.07 | 0.1775 |
| 2-palmitoyl-GPC (16:0) | 35253 | 0 | 0.9978 | 0.5861 |

In another experiment, biomarkers of disease progression were discovered by (1) analyzing plasma samples collected from human subjects with ALS at various times after symptom onset to determine the levels of metabolites in the samples and then (2) statistically analyzing the results to determine those metabolites that were differentially present at the various time points. The plasma samples used for the analysis were collected from 40 ALS subjects at several times during the course of the disease. Samples were collected early (screening/month 0 and/or month 1), at 6 months after screening, and at 12 months after screening. After the levels of metabolites were determined, the data from the subjects was analyzed using T-tests.

Biomarkers were identified by comparing the levels of the compounds in the samples collected at month 1 to the levels of the compounds in the samples at month 12 using a T-test analysis. All patients with both the 1 month and 12 month time points were included in the analysis (37 patients total). The standard matched-pairs T-test was used to perform this analysis. As listed below in Table 15, biomarkers were discovered that were differentially present among samples from ALS subjects over the course of the disease that indicate the progression of the disease. The Table includes, for each listed biomarker and non-biomarker compound, an indication of the percentage difference in the mean level at 1 month after screening as compared to the mean level at 12 months after screening, where a positive percentage change indicates that there was an increase in the metabolite level as the disease progressed and a negative percentage change indicates that there was a decrease in the metabolite level as the disease progressed.

Table 15 includes, for each listed biomarker and non-biomarker compound, the p-value and the q-value determined in the statistical analysis of the data concerning the biomarkers. Throughout the tables, the column heading “LIB_ID” indicates the analytical platform used to measure the level of the compound. The number “61” indicates that the levels of those compounds were measured using LC-MS, and the number “50” indicates that the levels of those compounds were measured using GC-MS. “COMP_ID” refers to the identifier for that biomarker in the internal chemical library database.

TABLE 15
Biomarkers in plasma of ALS disease progression over time.

| | | | | | % Change |
|---|---|---|---|---|---|
| | | | | | with disease |
| Biochemical Name | CompID | LIB_ID | p-value | q-value | progression |
| 3-indolepropionate | 8300 | 61 | 0.0286 | 0.1619 | −21% |
| gamma-glutamylphenylalanine | 13214 | 61 | <0.0001 | 0.0022 | −22% |
| alpha-hydroxyisovalerate | 20950 | 50 | 0.0438 | 0.1945 | −13% |
| erythronic acid | 17028 | 50 | 0.0026 | 0.0435 | −15% |
| glutamyl-valine | 11053 | 61 | 0.0028 | 0.0435 | −17% |
| cysteine | 16071 | 50 | 0.0136 | 0.0987 | −14% |
| pro-leu | 13018 | 61 | 0.022 | 0.1335 | −20% |
| stearamide | 19377 | 50 | 0.0477 | 0.1953 | −15% |
| hippuric acid | 16848 | 50 | 0.0517 | 0.1981 | −12% |
| 3-carboxy-4-Methyl-5-propyl-2 | 14837 | 61 | 0.0712 | 0.2397 | 43% |
| furanpropanoic acid | | | | | |
| erythrose | 18384 | 50 | 0.1652 | 0.3699 | −13% |
| propionylcarnitine | 9130 | 61 | 0.2034 | 0.4255 | 12% |
| 3-indoxyl sulfate | 5809 | 61 | 0.2685 | 0.5024 | −11% |
| glutamate | 12751 | 50 | <0.0001 | 1.00E−04 | −19% |
| proline | 12650 | 50 | 4.00E−04 | 0.0172 | −14% |
| erythrose | 18384 | 50 | 0.2914 | 0.5218 | −21% |
| L-asparagine | 16665 | 50 | 0.3352 | 0.5511 | 8% |
| pseudouridine | 16865 | 50 | 0.4516 | 0.61 | 4% |
| palmitoylsphingomylein | 21011 | 50 | 0.5303 | 0.6438 | −3% |
| erythrose | 8677 | 61 | 0.6983 | 0.7038 | 3% |
| stearoylsphingomyelin | 21012 | 50 | 0.7108 | 0.7076 | −3% |
| trans-hydroxyproline | 12673 | 50 | 0.7211 | 0.7104 | 1% |
| choline | 5702 | 61 | 0.749 | 0.7182 | 7% |
| octanoic acid (caprylate (8:0)) | 12609 | 50 | 0.7649 | 0.7211 | 2% |
| acetyl phosphate | 12604 | 50 | 0.7884 | 0.7229 | −1% |
| 2-amino butyrate | 12645 | 50 | 0.7901 | 0.7229 | −2% |
| p-cresol sulfate | 6362 | 61 | 0.8124 | 0.7266 | 2% |
| isovaleryl-, valeryl- and/or 2- | 9491 | | 0.9112 | 0.7635 | 1% |
| methylbutytl-carnitine | | | | | |
| pseudouridine | 20194 | 61 | 0.9393 | 0.766 | −1% |
| octamethyltetrasiloxane | 12559 | 50 | 0.9725 | 0.7739 | 2% |
| HWESASXXR (SEQ ID NO: 8) | 6144 | 61 | 0.4933 | 0.6359 | 9% |
| DSGEGDFLAEGGGVR (SEQ | 6208 | 61 | 0.7149 | 0.7088 | −15% |
| ID NO: 3) | | | | | |

### Example 8

### Biomarkers in CSF that Distinguish ALS from Healthy Subjects

In another example, biomarkers were discovered by (1) analyzing CSF samples from different groups of human subjects to determine the levels of metabolites in the samples and then (2) statistically analyzing the results to determine those metabolites that are differentially present in the two groups.

The CSF samples used for the analysis were from 99 ALS subjects (14 FALS subjects and 85 SALS subjects) and 36 control subjects not diagnosed with ALS. After the levels of metabolites were determined, the data was analyzed using univariate T-tests (i.e., Welch's T-test). As listed below in Table 16, biomarkers were discovered that were differentially present between samples from ALS subjects and Control subjects not diagnosed with ALS.

Table 16 includes, for each listed biomarker and non-biomarker compound, an indication of the percentage difference in the ALS mean as compared to the control mean (a “+” value indicating a higher mean in ALS samples as compared to the control samples and a “−” value indicating a lower mean in ALS samples as compared to the control samples), and the p-value and the q-value determined in the statistical analysis of the data concerning the biomarkers. CompID refers to the identifier for that biomarker in the internal chemical library database.

TABLE 16
ALS Biomarkers from CSF samples - T-test Analysis of ALS vs.
Healthy Controls

| | % Change in | | | |
|---|---|---|---|---|
| Compound | ALS | p-value | q-value | CompID |
| acetylcarnitine | 63% | 4.55E−06 | 0.0003651 | 5697 |
| isovaleryl-, valeryl- and/or 2- | 43% | 7.00E−05 | 0.0022041 | 9491 |
| methylbutytl-carnitine | | | | |
| pro-leu | 88% | 0.0001245 | 0.0024996 | 13018 |
| (s)-2-hydroxybutyric acid | 29% | 0.0012909 | 0.0103692 | 5711 |
| glutamyl-valine | 56% | 0.0029525 | 0.0165572 | 11053 |
| propionylcarnitine | 47% | 0.0326778 | 0.073937 | 9130 |
| erythrose | 14% | 0.1452021 | 0.1704341 | 8677 |
| alpha-4-dihydroxybenzenepropanoic | −21% | 0.2464745 | 0.2230964 | 6415 |
| acid | | | | |
| 1-methylguanosine | 11% | 0.2470386 | 0.2230964 | 9458 |
| choline | 8% | 0.3178316 | 0.2554132 | 5702 |
| gamma-glutamylphenylalanine | 5% | 0.4944613 | 0.3225891 | 13214 |
| L-alpha-glycerophosphorylcholine | 11% | 0.5534239 | 0.3374168 | 5563 |
| 4-Guanidinobutanoic acid | 11% | 0.6500879 | 0.3614211 | 7670 |
| n-acetyl-L-aspartic acid | −9% | 0.7090126 | 0.3734411 | 7359 |
| 4-methyl-2-oxopentanoate | −2% | 0.8983403 | 0.4392748 | 5808 |

### Example 9

### Biomarkers in CSF for Differentiating ALS from Other Neurological Diseases

Metabolomic analysis was carried out on CSF samples to identify biomarkers that were useful to distinguish ALS patients from patients with symptom mimic diseases, that is, neurological diseases that cause symptoms that appear clinically similar to ALS (e.g., multi-focal motor neuropathy, spinal muscular atrophy, Kennedy's disease, multiple sclerosis). The CSF samples used for the analysis were from 63 ALS subjects, and 30 symptom mimic disease patients (subjects with diseases that cause symptoms that appear clinically similar to ALS). After the levels of metabolites were determined, the data were analyzed using T-tests to identify biomarkers that differed between the ALS patients and the symptom mimic disease patients. The biomarkers are listed in Table 17.

Table 17 includes, for each biomarker, an indication of the percentage difference in the ALS mean as compared to the symptom mimic disease mean (positive values represent an increase in ALS, and negative values represent a decrease in ALS), and the p-value and the q-value, determined in the statistical analysis of the data concerning the biomarkers. The heading Comp ID refers to the identifier for that biomarker in the internal chemical library database.

TABLE 17
ALS Biomarkers from CSF samples that distinguish ALS patients
from Symptom Mimic Disease patients.

| | | ALS/ | | |
|---|---|---|---|---|
| | | Symptom Mimic Disease | | |
| | | % | | |
| | COMP | Change | | |
| BIOCHEMICAL NAME | ID | in ALS | p-value | q-value |
| 5-oxoproline | 1494 | 13% | 0.0033 | 0.761 |
| N-acetyl-beta-alanine | 37432 | −19% | 0.0117 | 0.761 |
| 1,5-anhydroglucitol (1,5-AG) | 20675 | 24% | 0.0124 | 0.761 |
| threitol | 35854 | −25% | 0.0135 | 0.761 |
| hypoxanthine | 3127 | −23% | 0.0181 | 0.761 |
| xylose | 15835 | −45% | 0.0231 | 0.761 |
| 5-hydroxyindoleacetate | 437 | 26% | 0.0387 | 0.799 |
| kynurenine | 15140 | 24% | 0.0394 | 0.799 |
| homocarnosine | 1633 | −43% | 0.0395 | 0.799 |
| histidine | 59 | 9% | 0.0429 | 0.799 |
| gluconate | 587 | 15% | 0.0469 | 0.799 |
| cortisol | 1712 | 15% | 0.0479 | 0.799 |
| lactate | 527 | 6% | 0.0516 | 0.799 |
| beta-hydroxyisovalerate | 12129 | −15% | 0.0875 | 0.9694 |
| ornithine | 35832 | 10% | 0.0965 | 0.9694 |
| N-formylmethionine | 2829 | −15% | 0.0966 | 0.9694 |
| citrate | 1564 | 9% | 0.1014 | 0.9694 |
| cotinine | 553 | −28% | 0.1195 | 0.9694 |
| glycine | 32338 | 15% | 0.1222 | 0.9694 |
| alpha-hydroxyisovalerate | 33937 | −19% | 0.1377 | 0.9694 |
| phenylalanine | 64 | 7% | 0.1381 | 0.9694 |
| theophylline | 18394 | −22% | 0.1391 | 0.9694 |
| 5-methylthioadenosine (MTA) | 1419 | −9% | 0.1407 | 0.9694 |
| theobromine | 18392 | −19% | 0.1408 | 0.9694 |
| 3-hydroxybutyrate (BHBA) | 542 | 14% | 0.1459 | 0.9694 |
| fucose | 15821 | 21% | 0.1496 | 0.9694 |
| 1,3-dihydroxyacetone | 35981 | −30% | 0.1608 | 0.9694 |
| choline | 15506 | 7% | 0.1629 | 0.9694 |
| betaine | 3141 | 6% | 0.1646 | 0.9694 |
| pro-hydroxy-pro | 35127 | 40% | 0.1715 | 0.9694 |
| serine | 32315 | 7% | 0.1729 | 0.9694 |
| 7-alpha-hydroxy-3-oxo-4- | 36776 | 6% | 0.1804 | 0.9694 |
| cholestenoate (7-Hoca) | | | | |
| fructose | 577 | −47% | 0.1823 | 0.9694 |
| dimethylarginine (SDMA + | 36808 | 11% | 0.1824 | 0.9694 |
| ADMA) | | | | |
| alpha-tocopherol | 1561 | −12% | 0.1833 | 0.9694 |
| acetylcarnitine | 32198 | 12% | 0.1893 | 0.9694 |
| alanine | 32339 | 6% | 0.1938 | 0.9694 |
| 3-hydroxy-2-ethylpropionate | 32397 | −12% | 0.2095 | 0.9694 |
| N-acetylhistidine | 33946 | −9% | 0.2119 | 0.9694 |
| 3-methyl-2-oxovalerate | 15676 | −11% | 0.2175 | 0.9694 |
| 4-acetamidobutanoate | 1558 | −6% | 0.2175 | 0.9694 |
| pseudouridine | 33442 | 6% | 0.221 | 0.9694 |
| ribulose | 35855 | −16% | 0.2276 | 0.9694 |
| glutamine | 53 | 5% | 0.2278 | 0.9694 |
| pantothenate | 1508 | 12% | 0.2284 | 0.9694 |
| catechol sulfate | 35320 | −28% | 0.2312 | 0.9694 |
| deoxycarnitine | 36747 | 14% | 0.2336 | 0.9694 |
| 3-ureidopropionate | 3155 | 36% | 0.2339 | 0.9694 |
| 5,6-dihydrouracil | 1559 | 10% | 0.2537 | 0.9694 |
| 3-methyl-2-oxobutyrate | 21047 | −6% | 0.2564 | 0.9694 |
| 4-methyl-2-oxopentanoate | 22116 | −9% | 0.2686 | 0.9694 |
| stachydrine | 34384 | 58% | 0.2737 | 0.9694 |
| N-acetylmethionine | 1589 | −9% | 0.275 | 0.9694 |
| carnitine | 15500 | 6% | 0.2851 | 0.9694 |
| isovalerate | 34732 | −8% | 0.3179 | 0.9694 |
| cortisone | 1769 | 9% | 0.3205 | 0.9694 |
| tryptophan betaine | 37097 | −19% | 0.33 | 0.9694 |
| adenosine | 555 | −5% | 0.3343 | 0.9694 |
| caprylate (8:0) | 32492 | −5% | 0.3347 | 0.9694 |
| butyrylcarnitine | 32412 | 6% | 0.3426 | 0.9694 |
| phenylacetylglutamine | 35126 | −18% | 0.3443 | 0.9694 |
| N-acetylglycine | 27710 | 10% | 0.3562 | 0.9694 |
| 3-methylhistidine | 15677 | −43% | 0.367 | 0.9694 |
| urate | 1604 | −9% | 0.3889 | 0.9694 |
| N4-acetylcytidine | 35130 | 6% | 0.3895 | 0.9694 |
| isobutyrylcarnitine | 33441 | 9% | 0.4003 | 0.9694 |
| alpha-ketobutyrate | 4968 | −12% | 0.4097 | 0.9694 |
| sorbitol | 15053 | −16% | 0.4167 | 0.9694 |
| 5-methyluridine (ribothymidine) | 35136 | 5% | 0.418 | 0.9694 |
| N-acetylaspartate (NAA) | 22185 | −8% | 0.426 | 0.9694 |
| gamma-glutamylisoleucine | 34456 | 6% | 0.4313 | 0.9694 |
| hippurate | 15753 | −19% | 0.4367 | 0.9694 |
| erythritol | 20699 | −43% | 0.4382 | 0.9694 |
| 3-indoxyl sulfate | 27672 | 7% | 0.4434 | 0.9694 |
| gamma-glutamylvaline | 32393 | 7% | 0.4488 | 0.9694 |
| succinate | 1437 | 12% | 0.4582 | 0.9694 |
| 3-carboxy-4-methyl-5-propyl-2- | 31787 | −59% | 0.459 | 0.9694 |
| furanpropanoate (CMPF) | | | | |
| malate | 1303 | −900% | 0.468 | 0.9694 |
| isovalerylcarnitine | 34407 | 5% | 0.4786 | 0.9694 |
| gamma-glutamyltyrosine | 2734 | −11% | 0.4788 | 0.9694 |
| dipropylene glycol | 40176 | −11% | 0.4807 | 0.9694 |
| N-acetylvaline | 1591 | −6% | 0.4826 | 0.9694 |
| mannitol | 15335 | −22% | 0.489 | 0.9694 |
| 2-aminobutyrate | 32309 | 5% | 0.4918 | 0.9694 |
| galactitol (dulcitol) | 1117 | −12% | 0.5136 | 0.9694 |
| 1-stearoylglycerophosphocholine | 33961 | −5% | 0.5232 | 0.9694 |
| N-acetyl-aspartyl-glutamate | 35665 | −6% | 0.5417 | 0.9708 |
| (NAAG) | | | | |
| arabonate | 37516 | 6% | 0.5436 | 0.9708 |
| pyruvate | 599 | 5% | 0.5826 | 0.9797 |
| gamma-glutamylphenylalanine | 33422 | 5% | 0.5836 | 0.9797 |
| bilirubin (E,E) | 32586 | −41% | 0.5845 | 0.9797 |
| DSGEGDFXAEGGGVR | 31548 | −96% | 0.5923 | 0.9797 |
| (SEQ ID NO: 4) | | | | |
| arachidonate (20:4n6) | 1110 | −43% | 0.5991 | 0.9847 |
| phenol sulfate | 32553 | −23% | 0.6035 | 0.9858 |
| undecanoate (11:0) | 12067 | −6% | 0.6104 | 0.991 |
| homostachydrine | 33009 | 24% | 0.6146 | 0.9911 |
| hydroxyisovaleroyl carnitine | 35433 | −6% | 0.6262 | 0.9921 |
| paraxanthine | 18254 | −6% | 0.6509 | 1 |
| 1,2-propanediol | 38002 | −9% | 0.6576 | 1 |
| 1,6-anhydroglucose | 21049 | −25% | 0.7338 | 1 |
| 1-palmitoylglycerophosphocholine | 33955 | −10% | 0.7495 | 1 |
| 4-androsten-3beta,17beta-diol | 37202 | −18% | 0.7574 | 1 |
| disulfate 1 | | | | |
| lidocaine | 35661 | −426% | 0.7581 | 1 |
| pipecolate | 1444 | −6% | 0.7647 | 1 |
| hydroxycotinine | 38661 | 9% | 0.7706 | 1 |
| dehydroisoandrosterone sulfate | 32425 | −100% | 0.8459 | 1 |
| (DHEA-S) | | | | |
| quinate | 18335 | −12% | 0.8629 | 1 |
| heme | 32593 | 37% | 0.8801 | 1 |
| glycerate | 1572 | 7% | 0.9194 | 1 |
| N-acetylornithine | 15630 | −16% | 0.9195 | 1 |
| proline | 1898 | −12% | 0.9575 | 1 |

### Example 10

### ALS Biomarkers that Distinguish ALS from Non-ALS MND in CSF

In another example, biomarkers were discovered by (1) analyzing CSF samples from different groups of human subjects to determine the levels of metabolites in the samples and then (2) statistically analyzing the results to determine those metabolites that were differentially present in the two groups.

Metabolomic analysis was carried out on CSF samples to identify biomarkers that were useful to distinguish ALS patients from patients with non-ALS motor neuron disease (non-ALS MND) (i.e., patients diagnosed with either upper motor neuron disease (UMD) or lower motor neuron disease (LMD)). The CSF samples used for the analysis were from 63 patients with ALS and 13 patients with non-ALS MND. After the levels of metabolites were determined, the data were analyzed using univariate T-tests (i.e., Welch's T-test) as described in the General Methods section. As listed below in Table 18, biomarkers were discovered that were differentially present between samples from ALS patients and non-ALS MND patients.

Table 18 includes, for each biomarker, an indication of the percentage difference in the ALS mean as compared to the non-ALS MND mean (positive values represent an increase in ALS, and negative values represent a decrease in ALS) and the p-value determined in the statistical analysis of the data concerning the biomarkers. CompID refers to the identifier for that biomarker in the internal chemical library database.

TABLE 18
ALS Biomarkers from CSF samples that distinguish ALS from non-
ALS MND.

| | | ALS/non-ALS | |
|---|---|---|---|
| | | MND | |
| | | % | |
| | | Change | |
| Biochemical Name | CompID | in ALS | p-value |
| tryptophan betaine | 37097 | −69% | 0.1434 |
| quinate | 18335 | 154% | 0.0234 |
| 2-methylbutyroylcarnitine | 35431 | 15% | 0.0496 |
| tryptophan | 54 | 13% | 0.0513 |
| mannose | 584 | 12% | 0.0861 |
| caproate (6:0) | 32489 | −14% | 0.1013 |
| threonine | 32292 | 15% | 0.1025 |
| caprylate (8:0) | 32492 | −15% | 0.103 |
| N1-methyladenosine | 15650 | 12% | 0.118 |
| N-acetyl-aspartyl-glutamate (NAAG) | 35665 | −27% | 0.1198 |
| hippurate | 15753 | 36% | 0.1283 |
| p-cresol sulfate | 36103 | 38% | 0.134 |
| ribulose | 35855 | −23% | 0.1363 |
| histidine | 59 | 12% | 0.1366 |
| phenylacetylglutamine | 35126 | 16% | 0.1439 |
| cyclo(leu-pro) | 37104 | 49% | 0.148 |
| malate | 1303 | −285% | 0.1548 |
| catechol sulfate | 35320 | 30% | 0.1628 |
| threonate | 27738 | −19% | 0.1634 |
| butyrylcarnitine | 32412 | 26% | 0.1648 |
| propionylcarnitine | 32452 | 11% | 0.1675 |
| bilirubin (E,E) | 32586 | 30% | 0.1715 |
| phenol sulfate | 32553 | 50% | 0.1751 |
| 2-methylcitrate | 37494 | −15% | 0.1796 |
| acetylcarnitine | 32198 | 13% | 0.1894 |
| 1,6-anhydroglucose | 21049 | −108% | 0.1965 |
| gamma-glutamylvaline | 32393 | −16% | 0.2143 |
| ribitol | 15772 | −11% | 0.2262 |
| N6-carbamoylthreonyladenosine | 35157 | −9% | 0.2272 |
| arabitol | 15964 | −12% | 0.2309 |
| ornithine | 35832 | 6% | 0.2376 |
| creatine | 27718 | 5% | 0.2607 |
| 1-palmitoylglycerophosphocholine | 33955 | 136% | 0.2718 |
| serine | 32315 | 7% | 0.2764 |
| homostachydrine | 33009 | 36% | 0.2832 |
| pro-hydroxy-pro | 35127 | 32% | 0.2843 |
| erythronate | 33477 | −9% | 0.2851 |
| 3-indoxyl sulfate | 27672 | 21% | 0.2915 |
| 1,2-propanediol | 38002 | −43% | 0.3112 |
| 1,3-dihydroxyacetone | 35981 | −18% | 0.3196 |
| N-acetylvaline | 1591 | −10% | 0.3202 |
| 7-alpha-hydroxy-3-oxo-4- | 36776 | 15% | 0.321 |
| cholestenoate (7-Hoca) | | | |
| galactitol (dulcitol) | 1117 | −18% | 0.3347 |
| heme | 32593 | 128% | 0.3423 |
| 1,5-anhydroglucitol (1,5-AG) | 20675 | −11% | 0.3478 |
| xanthine | 3147 | 8% | 0.348 |
| N-acetylneuraminate | 1592 | −14% | 0.3493 |
| threitol | 35854 | −8% | 0.3494 |
| succinylcarnitine | 37058 | −10% | 0.3606 |
| erythritol | 20699 | −11% | 0.3684 |
| proline | 1898 | 9% | 0.3732 |
| arabinose | 575 | −6% | 0.3759 |
| succinate | 1437 | 8% | 0.3768 |
| 5-methylthioadenosine (MTA) | 1419 | −5% | 0.3841 |
| 4-androsten-3beta,17beta-diol | 37202 | 16% | 0.3908 |
| disulfate 1 | | | |
| gamma-glutamylisoleucine | 34456 | −9% | 0.3909 |
| C-glycosyltryptophan | 32675 | −5% | 0.4003 |
| carnitine | 15500 | 6% | 0.4016 |
| 5-oxoproline | 1494 | 5% | 0.406 |
| citrate | 1564 | −6% | 0.4061 |
| choline | 15506 | 6% | 0.4223 |
| valine | 1649 | 5% | 0.43 |
| heptanoate (7:0) | 1644 | −12% | 0.434 |
| methylglutaroylcarnitine | 37060 | 11% | 0.4359 |
| N1-methylguanosine | 31609 | 6% | 0.4391 |
| adenosine | 555 | 30% | 0.4404 |
| paraxanthine | 18254 | 44% | 0.4463 |
| hydroxycotinine | 38661 | 14% | 0.4516 |
| alanine | 32339 | 6% | 0.4608 |
| pyruvate | 599 | 11% | 0.4633 |
| N-acetylglucosamine | 15095 | −15% | 0.4682 |
| dehydroisoandrosterone sulfate | 32425 | 32% | 0.4903 |
| (DHEA-S) | | | |
| kynurenine | 15140 | −9% | 0.4918 |
| xylonate | 35638 | −9% | 0.5009 |
| fructose | 577 | −19% | 0.501 |
| 3-(4-hydroxyphenyl)lactate | 32197 | 6% | 0.5024 |
| theophylline | 18394 | 17% | 0.5069 |
| betaine | 3141 | 5% | 0.5204 |
| glutaroyl carnitine | 35439 | 7% | 0.5219 |
| ascorbate (Vitamin C) | 1640 | −6% | 0.5391 |
| homocarnosine | 1633 | 15% | 0.5548 |
| gamma-glutamylleucine | 18369 | 7% | 0.556 |
| caffeine | 569 | 44% | 0.5628 |
| 5,6-dihydrouracil | 1559 | −5% | 0.5654 |
| 3-methyl-2-oxovalerate | 15676 | 5% | 0.581 |
| dipropylene glycol | 40176 | −23% | 0.5838 |
| N-acetylhistidine | 33946 | −6% | 0.59 |
| arachidonate (20:4n6) | 1110 | 13% | 0.6132 |
| 3-methylhistidine | 15677 | −16% | 0.6192 |
| 2-hydroxybutyrate (AHB) | 21044 | 5% | 0.6226 |
| cortisol | 1712 | 7% | 0.6244 |
| alpha-ketobutyrate | 4968 | −11% | 0.6336 |
| isobutyrylcarnitine | 33441 | 5% | 0.6393 |
| cotinine | 553 | 93% | 0.6476 |
| lidocaine | 35661 | 165% | 0.6572 |
| deoxycarnitine | 36747 | 6% | 0.6734 |
| sorbitol | 15053 | −12% | 0.6757 |
| 3-hydroxybutyrate (BHBA) | 542 | 10% | 0.6869 |
| N-acetylornithine | 15630 | −14% | 0.6875 |
| 2-aminobutyrate | 32309 | 5% | 0.7011 |
| DSGEGDFXAEGGGVR (SEQ ID | 31548 | 61% | 0.7201 |
| NO: 4) | | | |
| gluconate | 587 | 8% | 0.7291 |
| 3-carboxy-4-methyl-5-propyl-2- | 31787 | −5% | 0.7314 |
| furanpropanoate (CMPF) | | | |
| N-acetylmethionine | 1589 | 5% | 0.7719 |
| pipecolate | 1444 | −10% | 0.778 |
| mannitol | 15335 | −6% | 0.8726 |
| 1-stearoylglycerophosphocholine | 33961 | 45% | 0.8728 |
| isovalerate | 34732 | 16% | 0.904 |
| 5-hydroxyindoleacetate | 437 | 6% | 0.9349 |
| glycine | 32338 | 7% | 0.9472 |
| 3-hydroxy-2-ethylpropionate | 32397 | 6% | 0.9495 |

### Example 11

### Biomarkers for Disease Progression, CSF

To identify biomarkers of disease progression, CSF samples collected from 63 ALS subjects with ALSFRS-R scores ranging from 20 (most severe) to 47 (least severe) were analyzed metabolomically. After the levels of metabolites were determined, biomarkers of disease progression were identified using correlation analysis. The correlation analysis was performed between ALSFRS-R score, which had values ranging from 20 to 47, and the log transformed value of the metabolite intensity. Since higher ALSFRS-R scores indicate less severe disease and lower ALSFRS-R scores indicate increased disease severity, a positive correlation indicates higher biomarker levels were associated with higher scores and less severe disease while a negative correlation indicates higher biomarker levels were associated with lower scores and more severe disease. That is, as disease severity increases (i.e., disease progresses), the levels of biomarkers that are positively correlated will decrease and the levels of biomarkers that are negatively correlated will increase.

As listed below in Table 19, biomarkers were identified that were differentially present among samples from ALS subjects over the course of the disease that indicate the progression of the disease. Table 19 includes, for each listed biomarker and non-biomarker compound, the correlation value, the p-value and the q-value determined in the statistical analysis of the data concerning the biomarkers. In Table 19, the column “CompID” refers to the identifier for that biomarker in the internal chemical library database.

TABLE 19
CSF Biomarkers of ALS Disease Progression.

| | | | Corelation | Correlation |
|---|---|---|---|---|
| Biochemical Name | CompID | Correlation | P-value | Q-value |
| beta-hydroxyisovalerate | 12129 | 0.2786 | 0.0311 | 0.6463 |
| methionine | 32320 | −0.4128 | 0.001 | 0.1302 |
| pseudouridine | 33442 | −0.3783 | 0.0029 | 0.2271 |
| fucose | 15821 | −0.3697 | 0.0036 | 0.2271 |
| pyruvate | 599 | 0.3374 | 0.0084 | 0.3288 |
| succinate | 1437 | −0.3349 | 0.0089 | 0.3288 |
| mannose | 584 | −0.3321 | 0.0095 | 0.3288 |
| gamma-glutamylleucine | 18369 | 0.2955 | 0.0219 | 0.5523 |
| citrate | 1564 | −0.2592 | 0.0455 | 0.7356 |
| threonate | 27738 | −0.2586 | 0.0461 | 0.7356 |
| fructose | 577 | −0.2418 | 0.0627 | 0.7356 |
| pro-hydroxy-pro | 35127 | −0.2403 | 0.0644 | 0.7356 |
| sorbitol | 15053 | −0.2385 | 0.0664 | 0.7356 |
| glutaroyl carnitine | 35439 | 0.2337 | 0.0723 | 0.7356 |
| tiglyl carnitine | 35428 | 0.2269 | 0.0812 | 0.7356 |
| glucose | 20488 | −0.2263 | 0.0821 | 0.7356 |
| N-acetylglycine | 27710 | 0.224 | 0.0853 | 0.7356 |
| xylose | 15835 | −0.2188 | 0.093 | 0.7463 |
| glycerol | 15122 | −0.2186 | 0.0934 | 0.7463 |
| mannitol | 15335 | −0.2113 | 0.1051 | 0.7463 |
| phenylalanine | 64 | −0.2107 | 0.1061 | 0.7463 |
| serine | 32315 | 0.2089 | 0.1091 | 0.7463 |
| caffeine | 569 | 0.2009 | 0.1238 | 0.7707 |
| adenosine | 555 | −0.1973 | 0.1309 | 0.7949 |
| theophylline | 18394 | 0.1956 | 0.1343 | 0.7962 |
| glycerate | 1572 | −0.1896 | 0.1469 | 0.8143 |
| 4-methyl-2-oxopentanoate | 22116 | 0.1894 | 0.1472 | 0.8143 |
| threitol | 35854 | −0.1801 | 0.1684 | 0.8414 |
| 4-androsten-3beta,17beta-diol disulfate 1 | 37202 | 0.1788 | 0.1718 | 0.8414 |
| tyrosine | 1299 | −0.1783 | 0.1729 | 0.8414 |
| N1-methylguanosine | 31609 | −0.1766 | 0.177 | 0.8414 |
| 1,5-anhydroglucitol (1,5-AG) | 20675 | −0.1734 | 0.1852 | 0.8542 |
| isoleucine | 1125 | −0.1709 | 0.1917 | 0.868 |
| 3-(4-hydroxyphenyl)lactate | 32197 | −0.1619 | 0.2164 | 0.878 |
| heme | 32593 | −0.1611 | 0.2188 | 0.878 |
| valine | 1649 | −0.1594 | 0.2237 | 0.878 |
| betaine | 3141 | −0.1589 | 0.2253 | 0.878 |
| isovalerylcarnitine | 34407 | 0.1553 | 0.2362 | 0.878 |
| urate | 1604 | −0.1551 | 0.2368 | 0.878 |
| cyclo(leu-pro) | 37104 | 0.1526 | 0.2444 | 0.878 |
| N-acetylornithine | 15630 | −0.1526 | 0.2445 | 0.878 |
| 2-methylcitrate | 37494 | −0.1519 | 0.2466 | 0.878 |
| N4-acetylcytidine | 35130 | −0.1492 | 0.2552 | 0.878 |
| phenol sulfate | 32553 | −0.1489 | 0.2561 | 0.878 |
| glycerol 3-phosphate (G3P) | 15365 | 0.1437 | 0.2732 | 0.878 |
| creatine | 27718 | −0.1426 | 0.277 | 0.878 |
| N-acetyl-aspartyl-glutamate (NAAG) | 35665 | −0.1415 | 0.2809 | 0.878 |
| 3-methylhistidine | 15677 | −0.1403 | 0.2851 | 0.878 |
| succinylcarnitine | 37058 | −0.1373 | 0.2954 | 0.878 |
| N1-methyladenosine | 15650 | 0.1369 | 0.2969 | 0.878 |
| 5-oxoproline | 1494 | −0.1362 | 0.2994 | 0.878 |
| acetylcarnitine | 32198 | −0.1355 | 0.3019 | 0.878 |
| alanine | 32339 | −0.1346 | 0.3053 | 0.878 |
| gluconate | 587 | −0.1338 | 0.3081 | 0.878 |
| 5,6-dihydrouracil | 1559 | −0.1333 | 0.31 | 0.878 |
| dipropylene glycol | 40176 | −0.1319 | 0.3153 | 0.878 |
| paraxanthine | 18254 | 0.1313 | 0.3174 | 0.878 |
| carnitine | 15500 | −0.128 | 0.3298 | 0.9023 |
| 1,2-propanediol | 38002 | −0.1269 | 0.3339 | 0.9038 |
| stachydrine | 34384 | −0.1253 | 0.3402 | 0.9092 |
| 3-carboxy-4-methyl-5-propyl-2- | 31787 | 0.1245 | 0.3432 | 0.9092 |
| furanpropanoate (CMPF) | | | | |
| 1,6-anhydroglucose | 21049 | −0.123 | 0.3491 | 0.9149 |
| 1-palmitoylglycerophosphocholine | 33955 | −0.1203 | 0.3598 | 0.9241 |
| ascorbate (Vitamin C) | 1640 | 0.118 | 0.3694 | 0.9241 |
| 3-hydroxybutyrate (BHBA) | 542 | −0.1178 | 0.37 | 0.9241 |
| phenylacetylglutamine | 35126 | −0.1163 | 0.3761 | 0.9241 |
| 2-methylbutyroylcarnitine | 35431 | −0.1163 | 0.3764 | 0.9241 |
| arachidonate (20:4n6) | 1110 | −0.1151 | 0.3814 | 0.9241 |
| tryptophan betaine | 37097 | 0.1103 | 0.4013 | 0.9356 |
| 2-aminobutyrate | 32309 | −0.1102 | 0.4021 | 0.9356 |
| xanthine | 3147 | 0.1089 | 0.4077 | 0.94 |
| N-acetylserine | 37076 | 0.1079 | 0.4119 | 0.9409 |
| 3-dehydrocarnitine | 32654 | −0.1055 | 0.4224 | 0.9562 |
| 3-methyl-2-oxovalerate | 15676 | −0.103 | 0.4335 | 0.9724 |
| pipecolate | 1444 | −0.0983 | 0.4549 | 0.9832 |
| cortisone | 1769 | −0.0981 | 0.4559 | 0.9832 |
| cortisol | 1712 | −0.098 | 0.4563 | 0.9832 |
| urea | 1670 | 0.0968 | 0.4619 | 0.9832 |
| ornithine | 35832 | 0.0966 | 0.4628 | 0.9832 |
| N-acetylthreonine | 33939 | 0.0956 | 0.4676 | 0.9832 |
| leucine | 60 | −0.0919 | 0.4851 | 0.9832 |
| ribulose | 35855 | 0.0909 | 0.4899 | 0.9832 |
| cotinine | 553 | 0.0907 | 0.4906 | 0.9832 |
| hydroxycotinine | 38661 | 0.0875 | 0.506 | 0.9832 |
| N-acetylaspartate (NAA) | 22185 | 0.0871 | 0.5083 | 0.9832 |
| myo-inositol | 19934 | −0.087 | 0.5086 | 0.9832 |
| N-acetylneuraminate | 1592 | 0.0868 | 0.5095 | 0.9832 |
| gamma-glutamyltyrosine | 2734 | −0.0852 | 0.5173 | 0.9832 |
| glycine | 32338 | −0.0833 | 0.5267 | 0.9861 |
| cytidine | 514 | 0.0797 | 0.5451 | 0.9962 |
| hydroxyisovaleroyl carnitine | 35433 | 0.0791 | 0.5481 | 0.9962 |
| scyllo-inositol | 32379 | 0.0784 | 0.5513 | 0.9962 |
| glutamine | 53 | −0.0784 | 0.5516 | 0.9962 |
| malate | 1303 | 0.0773 | 0.5571 | 0.9962 |
| asparagine | 34283 | −0.0773 | 0.5572 | 0.9962 |
| glycolate (hydroxyacetate) | 15737 | −0.0758 | 0.565 | 0.9962 |
| butyrylcarnitine | 32412 | 0.0756 | 0.5661 | 0.9962 |
| dimethylarginine (SDMA + ADMA) | 36808 | −0.0749 | 0.5694 | 0.9962 |
| caprylate (8:0) | 32492 | −0.0741 | 0.5736 | 0.9962 |
| ribitol | 15772 | −0.0725 | 0.5818 | 0.9962 |
| N-acetylvaline | 1591 | −0.0722 | 0.5838 | 0.9962 |
| gamma-glutamylphenylalanine | 33422 | 0.0714 | 0.5876 | 0.9962 |
| lactate | 527 | 0.0685 | 0.6032 | 0.9982 |
| 3-hydroxyisobutyrate | 1549 | 0.0666 | 0.6131 | 0.9982 |
| quinate | 18335 | 0.0654 | 0.6196 | 0.9982 |
| proline | 1898 | −0.0643 | 0.6254 | 0.9982 |
| N-acetylglucosamine | 15095 | −0.0642 | 0.626 | 0.9982 |
| 1-stearoylglycerophosphocholine | 33961 | 0.0635 | 0.63 | 0.9982 |
| methylglutaroylcarnitine | 37060 | −0.0627 | 0.6341 | 0.9982 |
| hippurate | 15753 | −0.0603 | 0.6474 | 0.9982 |
| isobutyrylcarnitine | 33441 | 0.0596 | 0.6512 | 0.9982 |
| galactitol (dulcitol) | 1117 | 0.0576 | 0.6619 | 0.9982 |
| N-acetylmethionine | 1589 | 0.0571 | 0.6645 | 0.9982 |
| p-cresol sulfate | 36103 | 0.0554 | 0.6742 | 0.9982 |
| 5-hydroxyindoleacetate | 437 | −0.0551 | 0.6757 | 0.9982 |
| arginine | 37016 | 0.0545 | 0.679 | 0.9982 |
| 7-alpha-hydroxy-3-oxo-4-cholestenoate | 36776 | −0.0513 | 0.6971 | 0.9982 |
| (7-Hoca) | | | | |
| propionylcarnitine | 32452 | −0.0477 | 0.7171 | 0.9982 |
| uridine | 606 | 0.0472 | 0.7204 | 0.9982 |
| 5-methyluridine (ribothymidine) | 35136 | −0.0471 | 0.7208 | 0.9982 |
| 5-methylthioadenosine (MTA) | 1419 | −0.0467 | 0.7229 | 0.9982 |
| caproate (6:0) | 32489 | −0.0467 | 0.7232 | 0.9982 |
| choline | 15506 | 0.0461 | 0.7262 | 0.9982 |
| xylonate | 35638 | −0.0454 | 0.7305 | 0.9982 |
| isovalerate | 34732 | −0.045 | 0.7327 | 0.9982 |
| kynurenine | 15140 | −0.0441 | 0.7381 | 0.9982 |
| alpha-tocopherol | 1561 | 0.0429 | 0.7449 | 0.9982 |
| creatinine | 513 | 0.0412 | 0.7548 | 0.9982 |
| gamma-glutamylisoleucine | 34456 | −0.0402 | 0.7603 | 0.9982 |
| homocarnosine | 1633 | 0.0391 | 0.7665 | 0.9982 |
| histidine | 59 | 0.0389 | 0.7681 | 0.9982 |
| 1,3-dihydroxyacetone | 35981 | 0.0377 | 0.775 | 0.9982 |
| theobromine | 18392 | 0.0343 | 0.7945 | 0.9982 |
| 2-hydroxybutyrate (AHB) | 21044 | −0.0339 | 0.797 | 0.9982 |
| DSGEGDFXAEGGGVR (SEQ ID NO: 4) | 31548 | 0.0332 | 0.8012 | 0.9982 |
| heptanoate (7:0) | 1644 | 0.032 | 0.8081 | 0.9982 |
| arabonate | 37516 | −0.0314 | 0.812 | 0.9982 |
| inosine | 1123 | 0.0309 | 0.8145 | 0.9982 |
| 3-ureidopropionate | 3155 | 0.0309 | 0.8148 | 0.9982 |
| N-formylmethionine | 2829 | −0.03 | 0.82 | 0.9982 |
| 3-methyl-2-oxobutyrate | 21047 | 0.0294 | 0.8237 | 0.9982 |
| hypoxanthine | 3127 | 0.0291 | 0.8255 | 0.9982 |
| N-acetylalanine | 1585 | 0.0272 | 0.8366 | 0.9982 |
| alpha-ketobutyrate | 4968 | 0.0269 | 0.8386 | 0.9982 |
| undecanoate (11:0) | 12067 | −0.0247 | 0.8516 | 0.9982 |
| erythronate | 33477 | 0.0239 | 0.8559 | 0.9982 |
| lysine | 35836 | 0.0222 | 0.8662 | 0.9982 |
| alpha-hydroxyisovalerate | 33937 | 0.0175 | 0.8943 | 0.9982 |
| arabinose | 575 | −0.0161 | 0.9025 | 0.9982 |
| N-acetylhistidine | 33946 | 0.015 | 0.9092 | 0.9982 |
| bilirubin (E,E) | 32586 | 0.0132 | 0.9205 | 0.9982 |
| tryptophan | 54 | −0.0128 | 0.9224 | 0.9982 |
| deoxycarnitine | 36747 | 0.012 | 0.9273 | 0.9982 |
| dehydroisoandrosterone sulfate (DHEA-S) | 32425 | −0.0115 | 0.9307 | 0.9982 |
| erythritol | 20699 | −0.0101 | 0.939 | 0.9982 |
| C-glycosyltryptophan | 32675 | −0.0094 | 0.9433 | 0.9982 |
| N6-carbamoylthreonyladenosine | 35157 | −0.0087 | 0.9475 | 0.9982 |
| 3-hydroxy-2-ethylpropionate | 32397 | −0.0068 | 0.9587 | 0.9982 |
| pantothenate | 1508 | 0.0048 | 0.9709 | 0.9982 |
| 4-acetamidobutanoate | 1558 | −0.0043 | 0.9738 | 0.9982 |
| 3-indoxyl sulfate | 27672 | −0.0042 | 0.9744 | 0.9982 |
| catechol sulfate | 35320 | −0.0041 | 0.9753 | 0.9982 |
| threonine | 32292 | −0.0037 | 0.9779 | 0.9982 |
| homostachydrine | 33009 | 0.0033 | 0.9801 | 0.9982 |
| N-acetyl-beta-alanine | 37432 | −0.0018 | 0.9893 | 0.9982 |
| gamma-glutamylvaline | 32393 | 0.0016 | 0.9905 | 0.9982 |
| arabitol | 15964 | −0.0005 | 0.9968 | 0.9982 |

### Example 12

### Identification of Drug Targets and Drug Screens Using Said Targets

To identify drug targets for ALS, plasma samples from 172 ALS subjects and 50 healthy control subjects not diagnosed with ALS were analyzed to determine the levels of metabolites in the samples, then the results were statistically analyzed using univariate T-tests (i.e., Welch's T-test) to determine those metabolites that were differentially present in the two groups, and then the metabolic pathways of the differentially present metabolites were analyzed in a biological context to identify associated metabolites, enzymes and/or proteins. The metabolites, enzymes and/or proteins associated with the differentially present metabolites represent drug targets for ALS. The levels of metabolites that are aberrant (higher or lower) in ALS subjects relative to healthy control subjects can be modulated to bring them into the normal range, which can be therapeutic. Such metabolites or enzymes involved in the associated metabolic pathways and proteins involved in their transport within and between cells can provide targets for therapeutic agents.

For example, plasma levels of tryptophan-betaine were found to be lower in ALS subjects, indicating that the circulating levels of this biomarker were lower in the ALS patients. Additonally, higher levels of tryptophan-betaine were correlated with higher ALSFRS-R scores (i.e. higher function in the patient), which indicated that as tryptophan-betaine levels decrease, ALS progresses (gets worse). Thus, modulation of tryptophan-betaine levels in plasma provides a target for a therapeutic agent (drug). For example, said agent may modulate tryptophan-betaine plasma levels by increasing the biosynthesis of tryptophan-betaine.

Without being bound by theory, it is believed that tryptophan-betaine may compete with carnitine or other quaternary amines for transporter uptake, indicating that such transporters (for example, OCTN2, a polyspecific quaternary amine transporter) are drug targets. An agent may modulate plasma tryptophan-betaine levels by affecting the uptake of the metabolite by such quaternary amine transporters.

It is desirable to identify metabolites, enzymes and/or proteins that modify the levels of tryptophan-betaine in isolated motor neurons. As tryptophan-betaine is a quaternary amine and binds to, for example, OCTN2, a quaternary amine transporter, any of the methods commonly used in the art may potentially be used to identify other quaternary amine transporters. Modification of these quaternary amine transporters, for example by genetic mutation, antibody binding, or other methods of modification commonly used in art may be used to regulate the amount of tryptophan-betaine uptake into the cell. Thus, these quaternary amine transporters represent drug targets of ALS.

The identification of biomarkers for ALS can be useful for screening therapeutic compounds. For example, tryptophan-betaine, indolepropionate or any biomarker(s) aberrant in ALS as identified in Tables 1, 5, 9, 11, 12, 16, 17, and 18 can be used in a variety of drug screening techniques.

One exemplary method of drug screening utilizes eukaryotic or prokaryotic host cells such as primary motor neurons. In this prophetic example, cells are plated in 96-well plates. Test wells are incubated in the presence of test compounds from the NIH Clinical Collection Library (available from BioFocus DPI) at a final concentration of 50 μM. Negative control wells receive no addition or are incubated with a vehicle compound (e.g., DMSO) at a concentration equivalent to that present in some of the test compound solutions. Positive control wells are incubated in the presence of tryptophan-betaine. After incubation for 24 hours, test compound solutions are removed and metabolites are extracted from cells, and tryptophan betaine levels are measured as described in the General Methods section. Agents that lower the level of tryptophan-betaine in the cell are considered therapeutic.

Additionally, plasma levels of the biomarker indolepropionate were found to be lower in ALS subjects. Indolepropionate serves as an agonist for sphingosine-1-phosphate (S1P) and peroxisome proliferator-activated receptors (PPAR). Modification of these receptors, for example by genetic mutation, antibody binding, or other methods of modification commonly used in art may be used simulate the effect of indolepropionate by activating downstream signaling pathways. Alternatively, a drug with the property to modulate indolepropionate levels by targeting the enzymes involved in the aberrant biosynthesis, catabolism or uptake of indolepropionate may lead to therapeutic effects.

### Example 13

### Method of Treating ALS

Studies were carried out to identify metabolites for treating ALS using plasma samples from 172 ALS subjects and 50 healthy control subjects not diagnosed with ALS. After the levels of metabolites were determined, the data were analyzed using univariate T-tests (i.e., Welch's T-test) as described in the General Methods section. Metabolites aberrant (higher or lower) in ALS relative to healthy control subjects can be modulated to bring them into the normal range, which can be a treatment for ALS.

For example, the levels of the antioxidants indolepropionate and homocarnosine were found to be reduced in the plasma of ALS patients relative to healthy control subjects. Oxidative damage is implicated as a factor in the pathology of ALS (e.g., SOD1 mutation in FALS, increased ROS in animal models of ALS, glutamate excitotoxicity and ROS production, etc.). The role of antioxidants is to combat cellular damage by inhibiting oxidation reactions, thus keeping oxidants at a manageable level. The levels of indolepropionate and homocarnosine, which are neuroprotective antioxidants, were reduced in the plasma and/or CSF of ALS patients relative to healthy control subjects. When antioxidants, such as indolepropionate and/or homocarnosine, are decreased, the potential for oxidative damage and cell death is increased. Thus, increasing the plasma levels of indolepropionate and homocarnosine by administering the metabolite(s) as a drug or pro-drug represents one possible method of treating ALS.

Additionally, the biomarker metabolite tryptophan betaine was found to be decreased in plasma of ALS subjects. Thus, administering tryptophan-betaine as a drug or pro-drug represents a possible method of treating ALS.

While the invention has been described in detail and with reference to specific embodiments thereof, it will be apparent to one skilled in the art that various changes and modifications can be made without departing from the spirit and scope of the invention.

1-43. (canceled)

44. A method of determining or aiding in determining whether a subject has amyotrophic lateral sclerosis (ALS), comprising:
analyzing a biological sample from a subject to determine the level(s) of one or more biomarkers for amyotrophic lateral sclerosis in the sample, wherein the one or more biomarkers are selected from Tables 1, 5, 9, 11, 12, 16, 17, 18 and combinations thereof wherein the analysis method is mass spectrometry; and
comparing the level(s) of the one or more biomarkers in the sample to ALS-positive and/or ALS-negative reference levels of the one or more biomarkers in order to determine whether the subject has amyotrophic lateral sclerosis.

45. The method of claim 44, wherein the ALS-negative reference levels of the one or more biomarkers comprise levels of the one or more biomarkers in one or more samples from one or more subjects not having ALS and the ALS-positive reference levels of the one or more biomarkers comprise levels of the one or more biomarkers in one or more samples from one or more subjects who have been determined to have ALS.

46. The method of claim 45, wherein differential levels of the one or more biomarkers between the sample and the ALS-negative reference levels are indicative of a determination of ALS in the subject.

47. The method of claim 45, wherein differential levels of the one or more biomarkers between the sample and the ALS-positive reference levels are indicative of a determination of no ALS in the subject.

48. The method of claim 45, wherein levels of the one or more biomarkers in the sample corresponding to the ALS-positive reference levels are indicative of a determination of ALS in the subject.

49. The method of claim 45, wherein levels of the one or more biomarkers in the sample corresponding to the ALS-negative reference levels are indicative of a determination of no ALS in the subject.

50. The method of claim 44, wherein the one or more biomarkers comprise tryptophan betaine.

51. The method of claim 44, wherein the one or more biomarkers comprise indolepropionate.

52. The method of claim 44, wherein the one or more biomarkers comprise indolepropionate and/or tryptophan-betaine.

53. The method of claim 44, wherein the biological sample is cerebral spinal fluid and the one or more biomarkers are selected from Tables 16, 17, 18 and combinations thereof.

54. The method of claim 44, wherein the biological sample is blood plasma and the one or more biomarkers are selected from Tables 1, 5, 9, 11, 12 and combinations thereof.

55. The method of claim 44, wherein an ALS Probability Score is determined using the determined level(s) of the one or more biomarkers for amyotrophic lateral sclerosis in the sample and is used to determine whether the subject has amyotrophic lateral sclerosis.

56. The method of claim 44, wherein the determined level(s) of the one or more biomarkers for amyotrophic lateral sclerosis are used in a mathematical model in order to determine whether the subject has amyotrophic lateral sclerosis.

57. The method of claim 44, wherein determining whether a subject has ALS comprises distinguishing whether the subject has ALS or has a symptom mimic disease, and wherein the one or more biomarkers are selected from Tables 5, 9, 17 and combinations thereof.

58. A method of identifying subjects for clinical trials and/or treatment based on a diagnosis of ALS in the subjects, comprising;
analyzing a biological sample from a subject to determine the level(s) of one or more biomarkers selected from Tables 1, 5, 9, 11, 12, 16, 17, 18 and combinations thereof;
determining the level of the one or more biomarkers; and
comparing the level(s) of the one or more biomarkers in the sample to ALS-positive and/or ALS-negative reference levels of the one or more biomarkers in order to identify subjects for clinical trials and/or treatment based on assessment of ALS diagnosis.

59. A method of monitoring progression/regression of amyotrophic lateral sclerosis (ALS) in a subject comprising:
analyzing a first biological sample from a subject to determine the level(s) of one or more biomarkers for amyotrophic lateral sclerosis in the sample, wherein the first sample is obtained from the subject at a first time point and the one or more biomarkers are selected from Tables 14, 15, 19 and combinations thereof;
analyzing a second biological sample from a subject to determine the level(s) of the one or more biomarkers, wherein the second sample is obtained from the subject at a second time point; and
comparing the level(s) of one or more biomarkers in the first sample to the level(s) of the one or more biomarkers in the second sample in order to monitor the progression/regression of ALS in the subject.

60. The method of claim 59, wherein the method further comprises comparing the level(s) of one or more biomarkers in the first sample, the level(s) of one or more biomarkers in the second sample, and/or the results of the comparison of the level(s) of the one or more biomarkers in the first and second samples to ALS-positive reference levels, ALS-negative reference levels, ALS-progression-positive reference levels, and/or ALS-regression-positive reference levels of the one or more biomarkers.

61. The method of claim 59, wherein an ALS Status Score is determined using the determined level(s) of the one or more biomarkers for amyotrophic lateral sclerosis in the first sample and the second sample and is used to monitor the progression/regression of ALS in the subject.

62. The method of claim 59, wherein the determined level(s) of the one or more biomarkers for amyotrophic lateral sclerosis in the first sample and the second sample are used in a mathematical model in order to monitor the progression/regression of ALS in the subject.

63. The method of claim 59, wherein said first biological sample is obtained from the subject prior to a therapeutic intervention and said second biological sample is obtained from said subject after therapeutic intervention.

64. The method of claim 63, wherein the therapeutic intervention is the administration of a composition.


SEQUENCE LISTING (8 sequences)

SEQ ID NO: 1 - protein, 8 aa, Homo sapiens
  MOD_RES (7)..(8): Any amino acid
HWESASXX

SEQ ID NO: 2 - protein, 5 aa, Homo sapiens
  MOD_RES (2)..(2): Any amino acid
HXGXA

SEQ ID NO: 3 - protein, 15 aa, Homo sapiens
DSGEGDFLAEGGGVR

SEQ ID NO: 4 - protein, 15 aa, Homo sapiens
  MOD_RES (8)..(8): Any amino acid
DSGEGDFXAEGGGVR

SEQ ID NO: 5 - protein, 16 aa, Homo sapiens
  MOD_RES (9)..(9): Any amino acid
ADSGEGDFXAEGGGVR

SEQ ID NO: 6 - protein, 9 aa, Homo sapiens
HWESASLLR

SEQ ID NO: 7 - protein, 10 aa, Homo sapiens
  MOD_RES (1)..(1): Any amino acid
XHWESASXXR

SEQ ID NO: 8 - protein, 9 aa, Homo sapiens
  MOD_RES (7)..(8): Any amino acid
HWESASXXR